(19) United States
(12) Patent Application Publication
(10) Pub. No.: US 2026/0066961 A1
(43) Pub. Date: Mar. 5, 2026

(54) UPLINK TRANSMISSION

(71) Applicant: Samsung Electronics Co., Ltd., Suwon-si (KR)

(72) Inventors: Md. Saifur Rahman, Plano, TX (US); Eko Onggosanusi, Coppell, TX (US); Gilwon Lee, Prosper, TX (US)

(21) Appl. No.: 19/298,048

(22) Filed: Aug. 12, 2025

Related U.S. Application Data
(60) Provisional application No. 63/690,645, filed on Sep. 4, 2024.
(60) Provisional application No. 63/721,193, filed on Nov. 15, 2024.

(51) Int. Cl. H04B 7/0456

(52) U.S. Cl. CPC H04B 7/0456

(57) ABSTRACT

Apparatuses and methods for uplink (UL) transmission. A method performed by a user equipment (UE) includes receiving a transmit precoding matrix indicator (TPMI) for a transmission of a physical uplink shared channel (PUSCH) and transmitting the PUSCH based on the TPMI. The TPMI indicates a precoding matrix from a codebook for P antenna ports. The codebook includes precoding matrices constructed based on at least one column of a matrix

$${W}_{n} = I - 2 {u}_{n} {u}_{n}^{H} ,$$

where l is an identity matrix, uₙ is a n×1 vector, n≤P, and

$${u}_{n}^{H}$$

is a Hermitian transpose of the vector uₙ.

### CROSS-REFERENCE TO RELATED AND CLAIM OF PRIORITY

The present application claims priority under 35 U.S.C. § 119(e) to U.S. Provisional Patent Application No. 63/690,645 filed on Sep. 4, 2024 and U.S. Provisional Patent Application No. 63/721,193 filed on Nov. 15, 2024, which are hereby incorporated by reference in their entirety.

### TECHNICAL FIELD

The present disclosure relates generally to wireless communication systems and, more specifically, the present disclosure is related to apparatuses and methods for uplink (UL) transmission.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to UL transmission.

In one embodiment, a user equipment (UE) is provided. The UE includes a processor and a transceiver operably connected to the processor. The transceiver is configured to receive a transmit precoding matrix indicator (TPMI) for a transmission of a physical uplink shared channel (PUSCH) and transmit the PUSCH based on the TPMI. The TPMI indicates a precoding matrix from a codebook for P antenna ports. The codebook includes precoding matrices constructed based on at least one column of a matrix

$${W}_{n} = I - 2 {u}_{n} {u}_{n}^{H} ,$$

where l is an identity matrix, uₙ is a n×1 vector, n≤P, and

$${u}_{n}^{H}$$

is a Hermitian transpose of the vector uₙ.

In another embodiment, a base station (BS) is provided. The BS includes a processor and a transceiver operably connected to the processor. The transceiver is configured to transmit a TPMI for a PUSCH and receive the PUSCH based on the TPMI. The TPMI indicates a precoding matrix from a codebook for P antenna ports. The codebook includes precoding matrices constructed based on at least one column of a matrix

$${W}_{n} = I - 2 {u}_{n} {u}_{n}^{H} ,$$

where l is an identity matrix, uₙ is a n×1 vector, n≤P, and

$${u}_{n}^{H}$$

is a Hermitian transpose of the vector uₙ.

In yet another embodiment, a method performed by a UE is provided. The method includes receiving a TPMI for a transmission of a PUSCH and transmitting the PUSCH based on the TPMI. The TPMI indicates a precoding matrix from a codebook for P antenna ports. The codebook includes precoding matrices constructed based on at least one column of a matrix

$${W}_{n} = I - 2 {u}_{n} {u}_{n}^{H} ,$$

where l is an identity matrix, uₙ is a n×1 vector, n≤P, and

$${u}_{n}^{H}$$

is a Hermitian transpose of the vector uₙ.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIG. 5 illustrates an example of a transmitter structure for beamforming according to embodiments of the present disclosure;

FIG. 6 illustrates example antenna port layouts according to embodiments of the present disclosure;

FIG. 7 illustrates example radio access network (RAN) configurations according to embodiments of the present disclosure;

FIG. 8 illustrates example functional split points/options according to embodiments of the present disclosure;

FIG. 9 illustrates example antenna port layouts according to embodiments of the present disclosure;

FIG. 10 illustrates example antenna port layouts according to embodiments of the present disclosure;

FIG. 11 illustrates a flowdiagram of an example procedure for measuring/estimating UL/DL channel(s) according to embodiments of the present disclosure; and

FIG. 12 illustrates an example method performed by a UE in a wireless communication system according to embodiments of the present disclosure.

### DETAILED DESCRIPTION

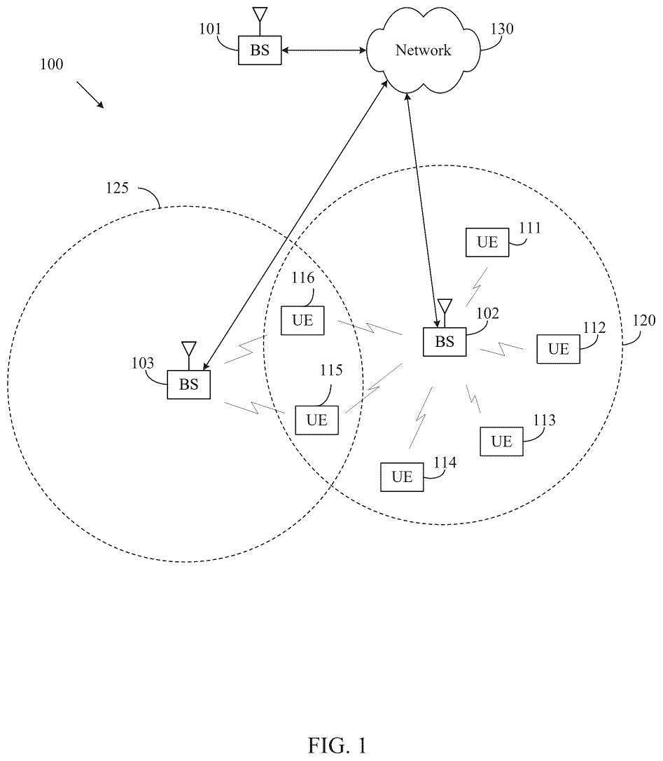

FIGS. 1-12 discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [REF 1] 3GPP TS 36.211 v17.1.0, “E-UTRA, Physical channels and modulation;” [REF 2] 3GPP TS 36.212 v17.1.0, “E-UTRA, Multiplexing and Channel coding;” [REF 3] 3GPP TS 36.213 v17.1.0, “E-UTRA, Physical Layer Procedures;” [REF 4]3GPP TS 36.321 v17.1.0, “E-UTRA, Medium Access Control (MAC) protocol specification;” [REF 5] 3GPP TS 36.331 v17.1.0, “E-UTRA, Radio Resource Control (RRC) Protocol Specification;” [REF 6] 3GPP TS 38.211 v17.1.0, “NR, Physical channels and modulation;” [REF 7] 3GPP TS 38.212 v17.1.0, “NR, Multiplexing and Channel coding;” [REF 8] 3GPP TS 38.213 v17.1.0, “NR, Physical Layer Procedures for Control;” [REF 9] 3GPP TS 38.214 v17.1.0, “NR, Physical Layer Procedures for Data;” [REF 10] 3GPP TS 38.215 v17.1.0, “NR, Physical Layer Measurements;” [REF 11] 3GPP TS 38.321 v17.1.0, “NR, Medium Access Control (MAC) protocol specification;” and [REF 12] 3GPP TS 38.331 v17.1.0, “NR, Radio Resource Control (RRC) Protocol Specification;” [REF 13] 3GPP TS 38.331 v18.1.0, “NR, Radio Resource Control (RRC) Protocol Specification;” [REF 14] 3GPP TS 38.212 v18.1.0, “NR, Multiplexing and Channel coding;” [REF 15] 3GPP TS 38.213 v18.1.0, “NR, Physical Layer Procedures for Control;” [REF 16] 3GPP TS 38.214 v18.1.0, “NR, Physical Layer Procedures for Data;” [REF 17] 3GPP TS 38.211 v18.1.0, “NR, Physical channels and modulation;” [REF 18] O-RAN.WG4.CONF.0-R003-v09.00, “O-RAN Working Group 4 (Fronthaul Working Group) Conformance Test Specification;” [REF 19] O-RAN.WG4.CUS.0-R003-v13.00, “O-RAN Working Group 4 (Open Fronthaul Interfaces WG)—Control, User and Synchronization Plane Specification; and [REF 20] 3GPP TS 38.321 v18.1.0, “NR, Medium Access Control (MAC) protocol specification.”

FIGS. 1-6 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of the present disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for performing UL transmission. In certain embodiments, one or more of the BSs 101-103 include circuitry, programing, or a combination thereof to support UL transmission.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

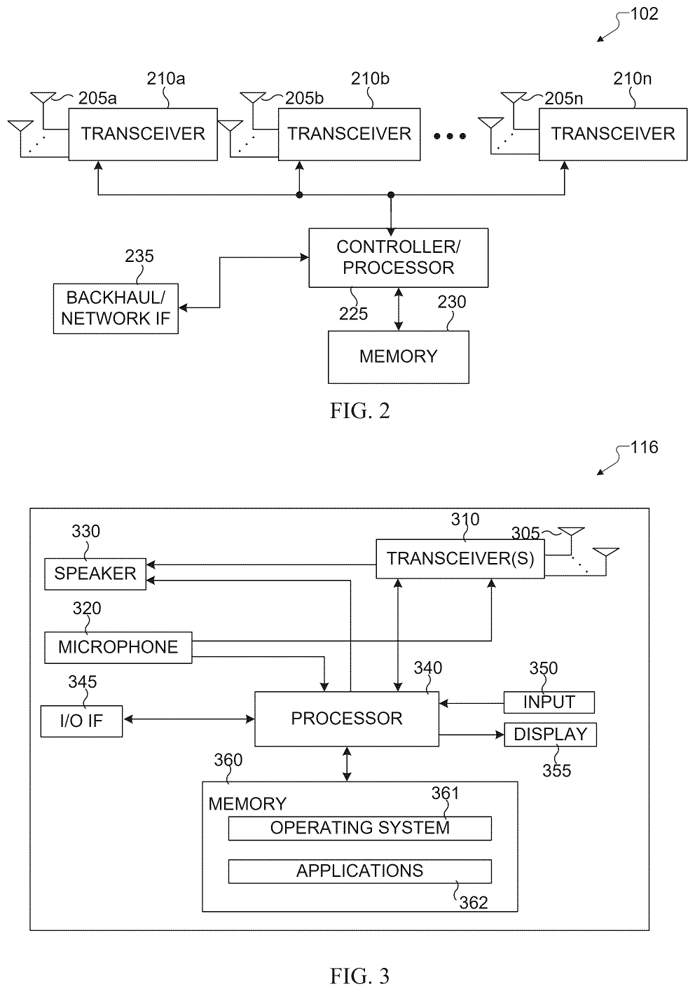

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of the present disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for UL transmission. Any of a wide variety of other functions could be supported in the gNB 102 by the controller/processor 225.

The controller/processor 225 is also capable of executing programs and other processes resident in the memory 230, such as processes to support UL transmission. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of the present disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for UL transmission as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

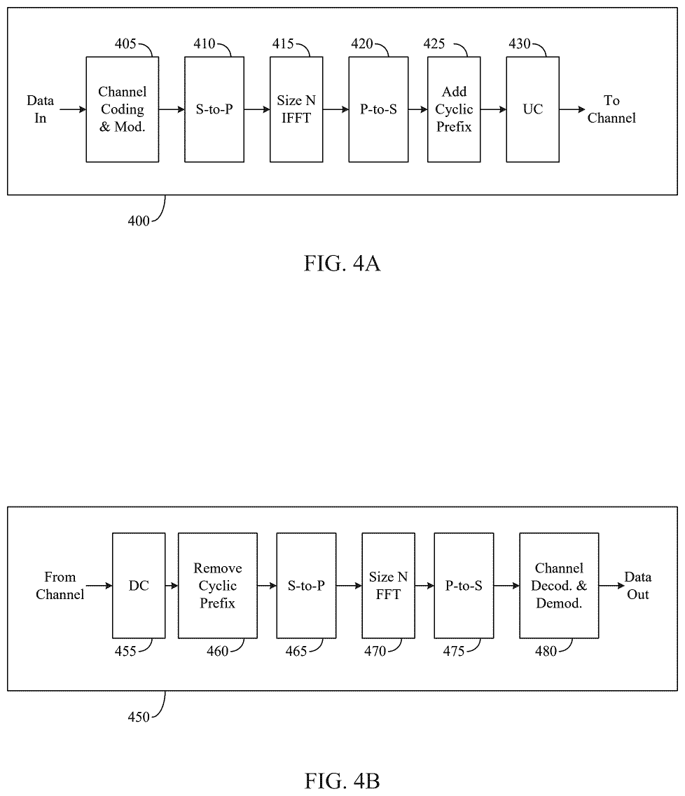

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 is configured for UL transmission as described in embodiments of the present disclosure. In some embodiments, the receive path 450 is configured for UL transmission as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB and the UE. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of the present disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

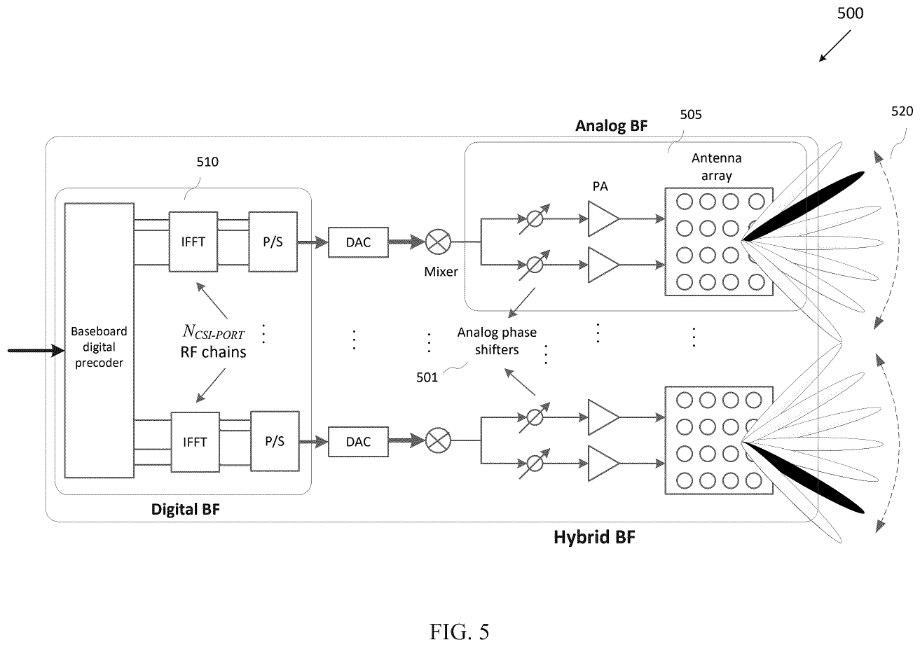

FIG. 5 illustrates an example of a transmitter structure 500 for beamforming according to embodiments of the present disclosure. In certain embodiments, one or more of gNB 102 or UE 116 includes the transmitter structure 500. For example, one or more of antenna 205 and its associated systems or antenna 305 and its associated systems can be included in transmitter structure 500. This example is for illustration only and other embodiments can be used without departing from the scope of the present disclosure.

Accordingly, embodiments of the present disclosure recognize that Rel-14 LTE and Rel-15 NR support up to 32 channel state information reference signal (CSI-RS) antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 5. Then, one CSI-RS port can be mapped onto a large number of antenna elements that can be controlled by a bank of analog phase shifters 501. One CSI-RS port can then correspond to one sub-array which produces a narrow analog beam through analog beamforming 505. This analog beam can be configured to sweep across a wider range of angles 520 by varying the phase shifter bank across symbols or slots/subframes. The number of sub-arrays (equal to the number of RF chains) is the same as the number of CSI-RS ports NCS-PORT. A digital beamforming unit 510 performs a linear combination across NCSI-PORT analog beams to further increase a precoding gain. While analog beams are wideband (hence not frequency-selective), digital precoding can be varied across frequency sub-bands or resource blocks. Receiver operation can be conceived analogously.

Since the transmitter structure 500 of FIG. 5 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 5 is also applicable to higher frequency bands such as >52.6 GHz (also termed frequency range 4 or FR4). In this case, the system can employ only analog beams. Due to the O2 absorption loss around 60 GHz frequency (˜10 dB additional loss per 100 m distance), a larger number and narrower analog beams (hence a larger number of radiators in the array) are essential to compensate for the additional path loss.

The present disclosure relates generally to wireless communication systems and, more specifically, to UL transmission based on a codebook.

In NR, two transmission schemes are supported for physical uplink shared channel (PUSCH): codebook based transmission and non-codebook based transmission. The UE (e.g., the UE 116) is configured with codebook based transmission when the higher layer parameter txConfig in pusch-Config is set to ‘codebook’, the UE is configured non-codebook based transmission when the higher layer parameter txConfig is set to ‘nonCodebook’.

According to Section 6.1.1.1 [REF 9], the following is supported for codebook based UL transmission.

For codebook based transmission, PUSCH can be scheduled by downlink control information (DCI) format 0_0, DCI format 0_1, DCI format 0_2 or semi-statically configured to operate according to Clause 6.1.2.3 [REF 9]. If this PUSCH is scheduled by DCI format 0_1, DCI format 0_2, or semi-statically configured to operate according to Clause 6.1.2.3 [REF 9], the UE determines its PUSCH transmission precoder based on sounding reference signal (SRS) resource indicator, transmit precoding matrix indicator (TPMI) and the transmission rank, where the SRI, TPMI and the transmission rank are given by DCI fields of SRS resource indicator and Precoding information and number of layers in clause 7.3.1.1.2 and 7.3.1.1.3 of [REF 5] for DCI format 0_1 and 0_2 or given by srs-ResourceIndicator and precodingAndNumberOfLayers according to clause 6.1.2.3. The SRS-ResourceSet(s) applicable for PUSCH scheduled by DCI format 0_1 and DCI format 0_2 are defined by the entries of the higher layer parameter srs-ResourceSetToAddModList and srs-ResourceSetToAddModListDCI-0-2 in SRS-config, respectively. Only one SRS resource set can be configured in srs-ResourceSetToAddModList with higher layer parameter usage in SRS-ResourceSet set to ‘codebook’, and only one SRS resource set can be configured in srs-ResourceSetToAddModListDCI-0-2 with higher layer parameter usage in SRS-ResourceSet set to ‘codebook’. The TPMI is used to indicate the precoder to be applied over the layers {0 . . . v−1} and that corresponds to the SRS resource selected by the SRI when multiple SRS resources are configured, or if a single SRS resource is configured TPMI is used to indicate the precoder to be applied over the layers {0 . . . v−1} and that corresponds to the SRS resource. The transmission precoder is selected from the uplink codebook that has a number of antenna ports equal to higher layer parameter nrofSRS-Ports in SRS-Config, as defined in Clause 6.3.1.5 of [4, TS 38.211]. When the UE is configured with the higher layer parameter xConfig set to ‘codebook’, the UE is configured with at least one SRS resource. The indicated SRI in slot n is associated with the most recent transmission of SRS resource identified by the SRI, where the SRS resource is prior to the physical downlink control channel (PDCCH) carrying the SRI.

For codebook based transmission, the UE determines its codebook subsets based on TPMI and upon the reception of higher layer parameter codebookSubset in pusch-Config for PUSCH associated with DCI format 0_1 and codebookSubsetDCI-0-2 in pusch-Config for PUSCH associated with DCI format 0_2 which may be configured with ‘fullyAndPartialAndNonCoherent’ or ‘partialAndNonCoherent’, or ‘nonCoherent’ depending on the UE capability. When higher layer parameter ul-FullPowerTransmission is set to ‘fullpowerMode2’ and the higher layer parameter codebookSubset or the higher layer parameter codebookSubsetForDCI-Format0-2 is set to ‘partialAndNonCoherent’, and when the SRS-resourceSet with usage set to “codebook” includes at least one SRS resource with 4 ports and one SRS resource with 2 ports, the codebookSubset associated with the 2-port SRS resource is ‘nonCoherent’. The maximum transmission rank may be configured by the higher layer parameter maxRank in pusch-Config for PUSCH scheduled with DCI format 0_1 and maxRank-ForDCIFormat0_2 for PUSCH scheduled with DCI format 0_2.

A UE reporting its UE capability of ‘partialAndNonCoherent’ transmission shall not expect to be configured by either codebookSubset or codebookSubsetForDCI-Format0-2 with ‘fullyAndPartialAndNonCoherent’.

A UE reporting its UE capability of ‘nonCoherent’ transmission shall not expect to be configured by either codebookSubset or codebookSubsetForDCI-Format0-2 with ‘fullyAndPartialAndNonCoherent’ or with ‘partialAndNonCoherent’.

A UE shall not expect to be configured with the higher layer parameter codebookSubset or the higher layer parameter codebookSubsetForDCI-Format0-2 set to ‘partialAndNonCoherent’ when higher layer parameter nrofSRS-Ports in an SRS-ResourceSet with usage set to ‘codebook’ indicates that the maximum number of the configured SRS antenna ports in the SRS-ResourceSet is two.

For codebook based transmission, only one SRS resource can be indicated based on the SRI from within the SRS resource set. Except when higher layer parameter ul-FullPowerTransmission is set to ‘fullpowerMode2’, the maximum number of configured SRS resources for codebook based transmission is 2. If aperiodic SRS is configured for a UE, the SRS request field in DCI triggers the transmission of aperiodic SRS resources.

A UE shall not expect to be configured with higher layer parameter ul-FullPowerTransmission set to ‘fullpowerMode1’ to ‘fullAndPartialAndNonCoherent’ simultaneously.

The UE shall transmit PUSCH using the same antenna port(s) as the SRS port(s) in the SRS resource indicated by the DCI format 0_1 or 0_2 or by configuredGrantConfig according to clause 6.1.2.3.

The demodulation reference signal (DM-RS) antenna ports {\tilde{p}₀, . . . , \tilde{p}ᵥ₋₁} in Clause 6.4.1.1.3 of [4, TS38.211] are determined according to the ordering of DM-RS port(s) given by Tables 7.3.1.1.2-6 to 7.3.1.1.2-23 in Clause 7.3.1.1.2 of [5, TS 38.212].

Except when higher layer parameter ul-FullPowerTransmission is set to ‘fullpowerMode2’, when multiple SRS resources are configured by SRS-ResourceSet with usage set to ‘codebook’, the UE shall expect that higher layer parameters nrofSRS-Ports in SRS-Resource in SRS-ResourceSet shall be configured with the same value for these SRS resources.

In the rest of the disclosure, ‘fullAndPartialAndNonCoherent’, ‘partialAndNonCoherent’, and ‘Non-Coherent’ are referred to codebookSubsets depending on three coherence type/capability, where the term ‘coherence’ implies all or a subset of antenna ports at the UE that can be used to transmit a layer coherently. In particular,
the term ‘full-coherence’ (FC) implies antenna ports at the UE that can be used to transmit a layer coherently.
the term ‘partial-coherence’ (PC) implies a subset (at least two but less than all) of antenna ports at the UE that can be used to transmit a layer coherently.
the term ‘non-coherence’ (NC) implies only one antenna port at the UE that can be used to transmit a layer.

When the UE is configured with codebookSubset=‘fullAndPartialAndNonCoherent’, the UL codebook includes three types (FC, PC, NC) of precoding matrices; when the UE is configured with codebookSubset=‘partialAndNonCoherent’, the UL codebook includes two types (PC, NC) of precoding matrices; and when the UE is configured with codebookSubset=‘nonCoherent’, the UL codebook includes only one type (NC) of precoding matrices.

According to Section 6.3.1.5 of REF 7, for non-codebook-based UL transmission, the precoding matrix W equals the identity matrix. For codebook-based UL transmission, the precoding matrix W is given by W=1 for single-layer transmission on a single antenna port, otherwise by Table 1 to Table 6, which are provided herein.

The rank (or number of layers) and the corresponding precoding matrix W are indicated to the UE using transmission rank indicator (TRI) and TPMI, respectively. In one example, this indication is joint via a field ‘Precoding information and number of layers’ in DCI, e.g., using DCI format 0_1. In another example, this indication is via higher layer RRC signaling. In one example, the mapping between a field ‘Precoding information and number of layers’ and TRI/TPMI is according to Section 7.3.1.1.2 of [REF 10].

TABLE 1
Precoding matrix W for single-layer transmission using two antenna ports.

| TPMI | W | | | | | | | |
|---|---|---|---|---|---|---|---|---|
| index | (ordered from left to right in increasing order of TPMI index) | | | | | | | |
| 0-5 | $\frac{1}{\sqrt{2}} [ \begin{matrix}1 \\ 0\end{matrix} ]$ | $\frac{1}{\sqrt{2}} [ \begin{matrix}0 \\ 1\end{matrix} ]$ | $\frac{1}{\sqrt{2}} [ \begin{matrix}1 \\ 1\end{matrix} ]$ | $\frac{1}{\sqrt{2}} [ \begin{matrix}1 \\ - 1\end{matrix} ]$ | $\frac{1}{\sqrt{2}} [ \begin{matrix}1 \\ j\end{matrix} ]$ | $\frac{1}{\sqrt{2}} [ \begin{matrix}1 \\ - j\end{matrix} ]$ | — | — |

TABLE 2
Precoding matrix W for single-layer transmission using four antenna ports with transform
precoding disabled.

| TPMI | W | | | | | | | |
|---|---|---|---|---|---|---|---|---|
| index | (ordered from left to right in increasing order of TPMI index) | | | | | | | |
| 0-7 | $\frac{1}{2} [ \begin{matrix}1 \\ 0 \\ 0 \\ 0\end{matrix} ]$ | $\frac{1}{2} [ \begin{matrix}0 \\ 1 \\ 0 \\ 0\end{matrix} ]$ | $\frac{1}{2} [ \begin{matrix}0 \\ 0 \\ 1 \\ 0\end{matrix} ]$ | $\frac{1}{2} [ \begin{matrix}0 \\ 0 \\ 0 \\ 1\end{matrix} ]$ | $\frac{1}{2} [ \begin{matrix}1 \\ 0 \\ 1 \\ 0\end{matrix} ]$ | $\frac{1}{2} [ \begin{matrix}1 \\ 0 \\ - 1 \\ 0\end{matrix} ]$ | $\frac{1}{2} [ \begin{matrix}1 \\ 0 \\ j \\ 0\end{matrix} ]$ | $\frac{1}{2} [ \begin{matrix}1 \\ 0 \\ - j \\ 0\end{matrix} ]$ |
| 8-15 | $\frac{1}{2} [ \begin{matrix}0 \\ 1 \\ 0 \\ 1\end{matrix} ]$ | $\frac{1}{2} [ \begin{matrix}0 \\ 1 \\ 0 \\ - 1\end{matrix} ]$ | $\frac{1}{2} [ \begin{matrix}0 \\ 1 \\ 0 \\ j\end{matrix} ]$ | $\frac{1}{2} [ \begin{matrix}0 \\ 1 \\ 0 \\ - j\end{matrix} ]$ | $\frac{1}{2} [ \begin{matrix}1 \\ 1 \\ 1 \\ 1\end{matrix} ]$ | $\frac{1}{2} [ \begin{matrix}1 \\ 1 \\ j \\ j\end{matrix} ]$ | $\frac{1}{2} [ \begin{matrix}1 \\ 1 \\ - 1 \\ - 1\end{matrix} ]$ | $\frac{1}{2} [ \begin{matrix}1 \\ 1 \\ - j \\ - j\end{matrix} ]$ |
| 16-23 | $\frac{1}{2} [ \begin{matrix}1 \\ j \\ 1 \\ j\end{matrix} ]$ | $\frac{1}{2} [ \begin{matrix}1 \\ j \\ j \\ - 1\end{matrix} ]$ | $\frac{1}{2} [ \begin{matrix}1 \\ j \\ - 1 \\ - j\end{matrix} ]$ | $\frac{1}{2} [ \begin{matrix}1 \\ j \\ - j \\ 1\end{matrix} ]$ | $\frac{1}{2} [ \begin{matrix}1 \\ - 1 \\ 1 \\ - 1\end{matrix} ]$ | $\frac{1}{2} [ \begin{matrix}1 \\ - 1 \\ j \\ - j\end{matrix} ]$ | $\frac{1}{2} [ \begin{matrix}1 \\ - 1 \\ - 1 \\ 1\end{matrix} ]$ | $\frac{1}{2} [ \begin{matrix}1 \\ - 1 \\ - j \\ j\end{matrix} ]$ |
| 24-27 | $\frac{1}{2} [ \begin{matrix}1 \\ - j \\ 1 \\ - j\end{matrix} ]$ | $\frac{1}{2} [ \begin{matrix}1 \\ - j \\ j \\ 1\end{matrix} ]$ | $\frac{1}{2} [ \begin{matrix}1 \\ - j \\ - 1 \\ j\end{matrix} ]$ | $\frac{1}{2} [ \begin{matrix}1 \\ - j \\ - j \\ - 1\end{matrix} ]$ | — | — | — | — |

TABLE 3
Precoding matrix W for two-layer transmission using two antenna ports with transform
precoding disabled.

| TPMI | W | | |
|---|---|---|---|
| index | (ordered from left to right in increasing order of TPMI index) | | |
| 0-2 | $\frac{1}{\sqrt{2}} [ \begin{matrix}1 & 0 \\ 0 & 1\end{matrix} ]$ | $\frac{1}{2} [ \begin{matrix}1 & 1 \\ 1 & - 1\end{matrix} ]$ | $\frac{1}{2} [ \begin{matrix}1 & 1 \\ j & - j\end{matrix} ]$ |

TABLE 4
Precoding matrix W for two-layer transmission using four antenna ports with transform
precoding disabled.

| TPMI | W | | | |
|---|---|---|---|---|
| index | (ordered from left to right in increasing order of TPMI index) | | | |
| 0-3 | $\frac{1}{2} [ \begin{matrix}1 & 0 \\ 0 & 1 \\ 0 & 0 \\ 0 & 0\end{matrix} ]$ | $\frac{1}{2} [ \begin{matrix}1 & 0 \\ 0 & 0 \\ 0 & 1 \\ 0 & 0\end{matrix} ]$ | $\frac{1}{2} [ \begin{matrix}1 & 0 \\ 0 & 0 \\ 0 & 0 \\ 0 & 1\end{matrix} ]$ | $\frac{1}{2} [ \begin{matrix}0 & 0 \\ 1 & 0 \\ 0 & 1 \\ 0 & 0\end{matrix} ]$ |
| 4-7 | $\frac{1}{2} [ \begin{matrix}0 & 0 \\ 1 & 0 \\ 0 & 0 \\ 0 & 1\end{matrix} ]$ | $\frac{1}{2} [ \begin{matrix}0 & 0 \\ 0 & 0 \\ 1 & 0 \\ 0 & 1\end{matrix} ]$ | $\frac{1}{2} [ \begin{matrix}1 & 0 \\ 0 & 1 \\ 1 & 0 \\ 0 & - j\end{matrix} ]$ | $\frac{1}{2} [ \begin{matrix}1 & 0 \\ 0 & 1 \\ 1 & 0 \\ 0 & j\end{matrix} ]$ |
| 8-11 | $\frac{1}{2} [ \begin{matrix}1 & 0 \\ 0 & 1 \\ - j & 0 \\ 0 & 1\end{matrix} ]$ | $\frac{1}{2} [ \begin{matrix}1 & 0 \\ 0 & 1 \\ - j & 0 \\ 0 & - 1\end{matrix} ]$ | $\frac{1}{2} [ \begin{matrix}1 & 0 \\ 0 & 1 \\ - 1 & 0 \\ 0 & - j\end{matrix} ]$ | $\frac{1}{2} [ \begin{matrix}1 & 0 \\ 0 & 1 \\ - 1 & 0 \\ 0 & j\end{matrix} ]$ |
| 12-15 | $\frac{1}{2} [ \begin{matrix}1 & 0 \\ 0 & 1 \\ j & 0 \\ 0 & 1\end{matrix} ]$ | $\frac{1}{2} [ \begin{matrix}1 & 0 \\ 0 & 1 \\ j & 0 \\ 0 & - 1\end{matrix} ]$ | $\frac{1}{2 \sqrt{2}} [ \begin{matrix}1 & 1 \\ 1 & 1 \\ 1 & - 1 \\ 1 & - 1\end{matrix} ]$ | $\frac{1}{2 \sqrt{2}} [ \begin{matrix}1 & 1 \\ 1 & 1 \\ j & - j \\ j & - j\end{matrix} ]$ |
| 16-19 | $\frac{1}{2 \sqrt{2}} [ \begin{matrix}1 & 1 \\ j & j \\ 1 & - 1 \\ j & - j\end{matrix} ]$ | $\frac{1}{2 \sqrt{2}} [ \begin{matrix}1 & 1 \\ j & j \\ j & - j \\ - 1 & 1\end{matrix} ]$ | $\frac{1}{2 \sqrt{2}} [ \begin{matrix}1 & 1 \\ - 1 & - 1 \\ 1 & - 1 \\ - 1 & 1\end{matrix} ]$ | $\frac{1}{2 \sqrt{2}} [ \begin{matrix}1 & 1 \\ - 1 & - 1 \\ j & - j \\ - j & j\end{matrix} ]$ |
| 20-21 | $\frac{1}{2 \sqrt{2}} [ \begin{matrix}1 & 1 \\ - j & - j \\ 1 & - 1 \\ - j & j\end{matrix} ]$ | $\frac{1}{2 \sqrt{2}} [ \begin{matrix}1 & 1 \\ - j & - j \\ j & - j \\ 1 & - 1\end{matrix} ]$ | — | — |

TABLE 5
Precoding matrix W for three-layer transmission using four antenna ports with transform
precoding disabled.

| TPMI | W | | | |
|---|---|---|---|---|
| index | (ordered from left to right in increasing order of TPMI index) | | | |
| 0-3 | $\frac{1}{2} [ \begin{matrix}1 & 0 & 0 \\ 0 & 1 & 0 \\ 0 & 0 & 1 \\ 0 & 0 & 0\end{matrix} ]$ | $\frac{1}{2} [ \begin{matrix}1 & 0 & 0 \\ 0 & 1 & 0 \\ 1 & 0 & 0 \\ 0 & 0 & 1\end{matrix} ]$ | $\frac{1}{2} [ \begin{matrix}1 & 0 & 0 \\ 0 & 1 & 0 \\ - 1 & 0 & 0 \\ 0 & 0 & 1\end{matrix} ]$ | $\frac{1}{2 \sqrt{3}} [ \begin{matrix}1 & 1 & 1 \\ 1 & - 1 & 1 \\ 1 & 1 & - 1 \\ 1 & - 1 & - 1\end{matrix} ]$ |
| 4-6 | $\frac{1}{2 \sqrt{3}} [ \begin{matrix}1 & 1 & 1 \\ 1 & - 1 & 1 \\ j & j & - j \\ j & - j & - j\end{matrix} ]$ | $\frac{1}{2 \sqrt{3}} [ \begin{matrix}1 & 1 & 1 \\ - 1 & 1 & - 1 \\ 1 & 1 & - 1 \\ - 1 & 1 & 1\end{matrix} ]$ | $\frac{1}{2 \sqrt{3}} [ \begin{matrix}1 & 1 & 1 \\ - 1 & 1 & - 1 \\ j & j & - j \\ - j & j & j\end{matrix} ]$ | — |

TABLE 6
Precoding matrix W for four-layer transmission using four antenna ports with transform
precoding disabled.

| TPMI | W | | | |
|---|---|---|---|---|
| index | (ordered from left to right in increasing order of TPMI index) | | | |
| 0-3 | $\frac{1}{2} [ \begin{matrix}1 & 0 & 0 & 0 \\ 0 & 1 & 0 & 0 \\ 0 & 0 & 1 & 0 \\ 0 & 0 & 0 & 1\end{matrix} ]$ | $\frac{1}{2 \sqrt{2}} [ \begin{matrix}1 & 1 & 0 & 0 \\ 0 & 0 & 1 & 1 \\ 1 & - 1 & 0 & 0 \\ 0 & 0 & 1 & - 1\end{matrix} ]$ | $\frac{1}{2 \sqrt{2}} [ \begin{matrix}1 & 1 & 0 & 0 \\ 0 & 0 & 1 & 1 \\ j & - j & 0 & 0 \\ 0 & 0 & j & - j\end{matrix} ]$ | $\frac{1}{4} [ \begin{matrix}1 & 1 & 1 & 1 \\ 1 & - 1 & 1 & - 1 \\ 1 & 1 & - 1 & - 1 \\ 1 & - 1 & - 1 & 1\end{matrix} ]$ |
| 4 | $\frac{1}{4} [ \begin{matrix}1 & 1 & 1 & 1 \\ 1 & - 1 & 1 & - 1 \\ j & j & - j & - j \\ j & - j & - j & j\end{matrix} ]$ | — | — | — |

The subset of TPMI indices for the three coherence types are summarized in Table 7 and Table 8, where rank=r corresponds to (and is equivalent to) r layers.

TABLE 7
Total power of precoding matrix W for 2 antenna ports

| | |
|---|---|
| Non-Coherent (NC) | Full-Coherent (FC) |
| TPMIs | TPMIs |

| | TPMI | Total | TPMI | Total |
|---|---|---|---|---|
| Rank | indices | power | indices | power |
| 1 | 0-1 | ½ | 2-5 | 1 |
| 2 | 0 | 1 | 1-2 | 1 |

TABLE 8
Total power of precoding matrix W for 4 antenna ports

| | Non-Coherent (NC) TPMIs | | Partial-Coherent (PC) TPMIs | | Full-Coherent (FC) TPMIs | |
|---|---|---|---|---|---|---|
| Rank | TPMI indices | Total power | TPMI indices | Total power | TPMI indices | Total power |
| 1 | 0-3 | ¼ | 4-11 | ½ | 12-27 | 1 |
| 2 | 0-5 | ½ | 6-13 | 1 | 14-21 | 1 |
| 3 | 0 | ¾ | 1-2 | 1 | 3-6 | 1 |
| 4 | 0 | 1 | 1-2 | 1 | 3-4 | 1 |

The corresponding supported codebookSubsets are summarized in Table 9 and Table 10.

TABLE 9
TPMI indices for codebookSubsets for 2 antenna ports

| | Non- | |
|---|---|---|
| Rank | Coherent | fullAndPartialAndNonCoherent |
| 1 | 0-1 | 0-5 |
| 2 | 0 | 0-2 |

TABLE 10
TPMI indices for codebookSubsets for 4 antenna ports

| | Non- | partialAndNonCo- | fullAndPartialAndNonCo- |
|---|---|---|---|
| Rank | Coherent | herent | herent |
| 1 | 0-3 | 0-11 | 0-27 |
| 2 | 0-5 | 0-13 | 0-21 |
| 3 | 0 | 0-2 | 0-6 |
| 4 | 0 | 0-2 | 0-4 |

In up to Rel. 17 NR, for UL transmission, the 3GPP specification supports 1, 2, or 4 SRS antenna ports in one SRS resource. In Rel. 18, the number of SRS antenna ports can be 8, targeting devices such as CPE, FWA, and vehicular UEs. For commercial handheld devices (UEs), for example the smart phones in the current market, are generally restricted by 2Tx chains (or antenna ports). Even though 4 Tx chains (or antenna ports) are supported in Rel.15 NR, 4 Tx chains are not likely to be applied in the commercial handheld UEs in the near future due to various commercial factors, including the PA cost and limited size of commercial cell phones. However, the advanced or next/future generation of smartphones are (or likely to be) capable of supporting 3 Tx chains in one same frequency band. Embodiments of the present disclosure recognize that this can boost the UL throughput significantly.

This disclosure provides embodiments for UL enhancements for UEs with 3 antenna ports. In particular, it provided examples of UL codebook, and SRS resource for codebook-based PUSCH transmission using 3 antenna ports. The scope of the disclosure is not limited to only these embodiments, but includes any extensions or combinations of the embodiments. Besides, example codebooks for 3 antenna ports provided in this disclosure can also be used for DL (e.g. for CSI/precoding matrix indicator (PMI) reporting based on 3 CSI-RS antenna ports at NW/gNB), or sidelink (SL) (e.g. for CSI/PMI reporting based on 3 CSI-RS antenna ports at a SL UE/device). It can also be used to configure/trigger a CSI report for network energy saving (NES) applications wherein the NW/gNB may want to trigger (e.g. dynamically via MAC CE or DCI) a sub-configurations of the CSI report in which the number of CSI-RS ports is less than that at the NW/gNB. For instance, NW/gNB may trigger a CSI report for 3 CSI-RS ports that are a subset of >3 (e.g. 4, or 8) CSI-RS ports.

The present disclosure relates to codebook-based UL transmission for odd number (e.g. 3, 5, . . . ) of antenna ports. The disclosure includes the following:
UL codebook design for odd number of antenna ports that can be grouped into N_{g}∈{1,2,3, . . . } groups
Details on codebook design for 3 antenna ports

In the following, for brevity, both frequency division duplexing (FDD) and time division duplexing (TDD) are regarded as the duplex method for both DL and UL signaling.

Although exemplary descriptions and embodiments to follow expect orthogonal frequency division multiplexing (OFDM) or orthogonal frequency division multiple access (OFDMA), this disclosure can be extended to other OFDM-based transmission waveforms or multiple access schemes such as filtered OFDM (F-OFDM).

This disclosure covers several components which can be used in conjunction or in combination with one another, or can operate as standalone schemes.

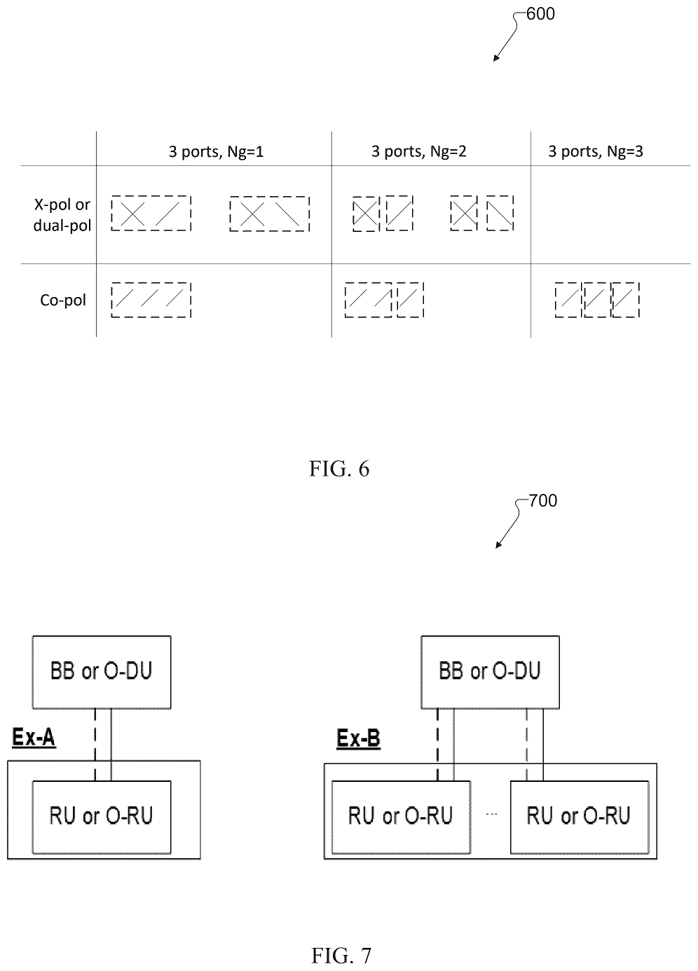

FIG. 6 example antenna port layouts 600 according to embodiments of the present disclosure. For example, port layouts 600 can be implemented in any of the UEs 111-116 of FIG. 1, such as the UE 111. This example is for illustration only and other embodiments can be used without departing from the scope of the present disclosure.

In this disclosure, a UE with odd number of antenna ports is provided. Antenna ports of the UE can belong to a single antenna panel or group (i.e., they are co-located, for example, at one plane, side, or edge of the UE) or multiple antenna panels or groups. For a given antenna panel or group, N₁ and N₂ are the number of antenna ports with the same polarization in the first and second dimensions, respectively. For 2D antenna port layouts, N₁>1, N₂>1, and for 1D antenna port layouts, either N₁>1 and N₂=1 or N₂>1 and N₁=1. In the rest of the disclosure, 1D antenna port layouts with N₁>1 and N₂=1 is provided. The disclosure, however, is applicable to the other 1D port layouts with N₂>1 and N₁=1. Also, in the rest of the disclosure, N₁≥N₂. The disclosure, however, is applicable to the case when N₁<N₂, and the embodiments for N₁>N₂ applies to the case N₁<N₂ by swapping/switching (N₁, N₂) with (N₂, N₁). For a given antenna panel or group, when a (single-polarized) co-polarized antenna port layout, the total number of antenna ports is P=N₁N₂ and when a dual-polarized antenna port layout, the total number of antenna ports is P=2N₁N₂. When the UE has P=3 antenna ports, an illustration of antenna port layouts is shown in Table 11.

Let N_{g} be the number of antenna port groups (panels). For a co-polarized (single polarized) case,
N_{g}=1: one group comprising 3 antenna ports,
N_{g}=2: two groups, one comprising 2 antenna ports, and another comprising 1 antenna port, and
N_{g}=3: three groups, each comprising 1 antenna port.

For a dual-polarized (cross-polarized) case,
N_{g}=1: one group comprising 2 cross-pol antenna ports, and 1 single-pol antenna port.
N_{g}=2: two groups, one comprising 2 cross-pol antenna ports, and another comprising 1 single-pol antenna port.

Let s denotes the number of antenna polarizations (or groups of antenna ports with the same polarization). Then, for co-polarized antenna ports, s=1, and for dual- or cross (X)-polarized antenna ports s=2. In one example, the antenna ports at the UE (e.g., the UE 116) refers to SRS antenna ports (either in one SRS resource or across multiple SRS resources).

The UL codebook W for P antenna ports at the UE is based on pre-coding vectors which are according to one of the three examples in Table 11 depending on whether the antenna ports are co-polarized or a combination of co-polarized and cross-/dual-polarized.
Ex1: corresponds to N_{g}=1 with co-polarized ports.
Ex2: corresponds to N_{g}=2, 1D antenna layout, P=Pₓ+P_{co} with Pₓ cross-pol ports and P_{co} co-polarized ports.
Ex3: corresponds to N_{g}=2, 2D antenna layout, Pₓ=2N_{x,1}N_{x,2} and P_{co}=N_{co,1}N_{co,2} with Pₓ cross-pol ports and P_{co} co-polarized ports.

TABLE 11
Pre-coding vectors

| Ex1: Co-pol | Ex2: Co-pol + Dual-pol (1D) | Ex3: Co-pol + Dual-pol (2D) |
|---|---|---|
| $W = \frac{{w}_{l}}{\sqrt{P}}$ | $W = \frac{1}{\sqrt{P}} [ \begin{matrix}{w}_{cross - pol} \\ {w}_{co - pol}\end{matrix} ] or \frac{1}{\sqrt{P}} [ \begin{matrix}{w}_{co - pol} \\ {w}_{cross - pol}\end{matrix} ]$ | $W = \frac{1}{\sqrt{P}} [ \begin{matrix}{w}_{cross - pol} \\ {w}_{co - pol}\end{matrix} ] or \frac{1}{\sqrt{P}} [ \begin{matrix}{w}_{co - pol} \\ {w}_{cross - pol}\end{matrix} ]$ |
| | ${w}_{cross - pol} = {v}_{{l}_{1} , n} = [ \begin{matrix}{w}_{{l}_{1}} \\ {φ}_{n} {w}_{{l}_{1}}\end{matrix} ]$ | ${w}_{c r o s s - p o l} = {v}_{{l}_{1} , m , n} = [ \begin{matrix}{v}_{{l}_{1} , m} \\ {φ}_{n} {v}_{{l}_{1} , m}\end{matrix} ]$ |
| | w_{co-pol} = wₗ_{₂} | w_{co-pol} = vₗ_{₂}_{,m}_{₂} |

Here, ν_{l,m} is a Kronecker product (└) of vectors wₗ and uₘ of lengths N₁ and N₂, respectively. In one example, wₗ and uₘ are oversampled DFT vectors, i.e.,

$${w}_{l} = [ \begin{matrix}1 & {e}^{j \frac{2 π l}{{O}_{1} {N}_{1}}} & {e}^{j \frac{4 π l}{{O}_{1} {N}_{1}}} & … & {{e}^{j \frac{2 π l ( {N}_{1} - 1 )}{{O}_{1} {N}_{1}}} ]}^{T}\end{matrix}$$

$${u}_{m} = \{ \begin{matrix}[ \begin{matrix}1 & {e}^{j \frac{2 π m}{{O}_{2} {N}_{2}}} & … & {e}^{j \frac{2 π m ( {N}_{2} - 1 )}{{O}_{2} {N}_{2}}} ]\end{matrix} & {N}_{2} > 1 \\ 1 & {N}_{2} = 1\end{matrix}$$

where O₁ and O₂ are oversampling factors in two dimensions, and ν_{l,m} is then given by

$${v}_{l , m} = {w}_{l} ⊗ {u}_{m} = [ \begin{matrix}{u}_{m} & {e}^{j \frac{2 π l}{{O}_{1} {N}_{1}}} {u}_{m} & … & {{e}^{j \frac{2 π l ( {N}_{1} - 1 )}{{O}_{1} {N}_{1}}} {u}_{m} ]}^{T}\end{matrix}$$

In one example, both O₁, O₂∈{1,2,4,8}. In one example, O₁ and O₂ can take the same values as Rel.15 NR Type I codebook (cf. 5.2.2.2.1, TS 38.214), i.e., (O₁, O₂)=(4,4) when N₂>1, and, i.e., (O₁, O₂)=(4,1) when N₂=1. Alternatively, they take different values from the Rel. 15 Type I NR codebook, for example, (O₁, O₂)=(2,2) when N₂>1, and, i.e., (O₁, O₂)=(2,1) when N₂=1. In one example, O₁ and O₂ is configurable (e.g. via higher layer). In one example, (O₁, O₂)=(1,1).

The quantity φₙ is a co-phase for dual-polarized antenna port layouts. In one example, φₙ=e^{jπn/2}, where n∈{0,1,2,3} implying that φₙ belongs to QPSK alphabet {1, j, −1, −j}.

In one example, the values of N₁ and N₂ are configured, e.g. with the higher layer parameter. A few examples of (N₁, N₂) for a given number of antenna ports (P) and antenna layout (co-pol or/and cross-pol) is given in Table 12. The notation N_{a,b} where α∈{co, x} and b∈{1,2} is used to denote a number of a-polarized antenna ports in the b-th dimension, respectively.

TABLE 12
Configurations of (N₁, N₂)

| | | | Co-Pol + |
|---|---|---|---|
| Number of | | | Dual-pol |
| antenna | Co-pol | Dual-pol | {(N_{co, 1}, N_{co, 2}), |
| ports, P | (N_{co, 1}, N_{co, 2}) | (N_{x, 1}, N_{x, 2}) | (N_{x, 1}, N_{x, 2})} |
| 1 | (1, 1) | | |
| 2 | (2, 1), (1, 2) | (1, 1) | |
| 3 | (3, 1), (1, 3) | | {(1, 1), (1, 1)} |
| 4 | (4, 1), (1, 4), | (2, 1) | {(2, 1), (1, 1)} |
| | (2, 2) | | {(1, 2), (1, 1)} |
| 5 | (5, 1), (1, 5) | | {(3, 1), (1, 1)} |
| | | | {(1, 3), (1, 1)} |
| | | | {(1, 1), (2, 1)} |
| 6 | (2, 3), (3, 2), | (3, 1) | {(4, 1), (1, 1)} |
| | (6, 1), (1, 6) | | {(1, 4), (1, 1)} |
| | | | {(2, 2), (1, 1)} |
| | | | {(2, 1), (2, 1)} |
| | | | {(1, 2), (2, 1)} |
| 7 | (7, 1), (1, 7) | | {(5, 1), (1, 1)} |
| | | | {(1, 5), (1, 1)} |
| | | | {(3, 1), (2, 1)} |
| | | | {(1, 3), (2, 1)} |
| | | | {(1, 1), (3, 1)} |

In one example, the values of N₁ and N₂ are fixed for a given number of antenna ports. For example, (N₁,N₂)=(P,1) for co-pol and

$$( \frac{P}{2} , 1 )$$

for dual-pol antenna. In one example only one (N₁, N₂) is supported for each value of P, where the supported (N₁, N₂) is one of pairs in Table 12.

The number of antenna ports is provided to be P=3 in the rest of the disclosure.

In one example, P=3 antenna ports can be divided into N_{g}∈{1,2,3} groups. The value of (N_{co,1}, N_{co,2}) or/and (N_{x,1}, N_{x,2}) for each of the N_{g} groups is shown in Table 13.

TABLE 13

| | Group 1 | | Group 2 | | Group 3 | |
|---|---|---|---|---|---|---|
| N_{g} | (N_{co, 1}, N_{co, 2}) | (N_{x, 1}, N_{x, 2}) | (N_{co, 1}, N_{co, 2}) | (N_{x, 1}, N_{x, 2}) | (N_{co, 1}, N_{co, 2}) | (N_{x, 1}, N_{x, 2}) |
| 1 | (3, 1) | | | | | |
| | (1, 1) | (1, 1) | | | | |
| 2 | (2, 1) | | (1, 1) | | | |
| | | (1, 1) | (1, 1) | | | |
| 3 | (1, 1) | | (1, 1) | | (1, 1) | |

In one example, N_{g}=1 corresponds to a single antenna panel. In one example, N_{g}=1 corresponds to a full coherent (FC) UE or FC antenna layout.

In one example, N_{g}=2 corresponds to two antenna panels. In one example, N_{g}=2 corresponds to a partial coherent (PC) UE or PC antenna layout.

In one example, N_{g}=3 corresponds to three antenna panels. In one example, N_{g}=3 corresponds to a non-coherent (NC) UE or NC antenna layout.

In one example, the 3Tx UL codebook includes all of or a subset of the precoders shown in codebook tables in this disclosure.

In one embodiment, the codebook for 3 antenna ports, as described in previous embodiment (or later embodiments), can also be used/configured (to a UE) for DL (e.g. for CSI/PMI reporting based on 3 CSI-RS antenna ports at NW/gNB (e.g., the network 130/the BS 102)), or sidelink (SL) (e.g. for CSI/PMI reporting based on 3 CSI-RS antenna ports at a SL UE/device). It can also be used to configure/trigger a CSI report for network energy saving (NES) applications wherein the NW/gNB may want to trigger (e.g. dynamically via MAC CE or DCI) a sub-configurations of the CSI report in which the number of CSI-RS ports is less than that at the NW/gNB. For instance, NW/gNB may trigger a CSI report for 3 CSI-RS ports that are a subset of >3 (e.g. 4, or 8) CSI-RS ports.

In one example, the rank 1 TPMI (and precoder) can be configured to a UE for both cases when transform precoding is enabled (DFT-s-OFDM) or disabled (CP-OFDM).

In one example, a PC precoding matrix can be defined as a matrix where each column comprises both zero and non-zero entries, e.g., at least two non-zero and remaining zero elements/entries in each column.

TABLE 14
FC precoders for 2 antenna ports

| | | | | | |
|---|---|---|---|---|---|
| j = 0-3 | 4 rank1 TPMIs 2, 3, 4, 5 | ${P}_{1 , 1} = [ \begin{matrix}1 \\ 1\end{matrix} ]$ | ${P}_{1 , 2} = [ \begin{matrix}1 \\ - 1\end{matrix} ]$ | ${P}_{1 , 3} = [ \begin{matrix}1 \\ j\end{matrix} ]$ | ${P}_{1 , 4} = [ \begin{matrix}1 \\ - j\end{matrix} ]$ |
| j= 0-1 | 2 rank2 TPMIs 1, 2 | ${P}_{2 , 1} = [ \begin{matrix}1 & 1 \\ 1 & - 1\end{matrix} ]$ | ${P}_{2 , 2} = [ \begin{matrix}1 & 1 \\ j & - j\end{matrix} ]$ | | |

TABLE 15
FC precoders for 2 antenna ports

| | | | | | |
|---|---|---|---|---|---|
| j = 0-3 | 4 rank1 TPMIs 2, 3, 4, 5 | ${P}_{1 , 1} = \frac{1}{{t}_{1}} [ \begin{matrix}1 \\ 1\end{matrix} ]$ | ${P}_{1 , 2} = \frac{1}{{t}_{1}} [ \begin{matrix}1 \\ - 1\end{matrix} ]$ | ${P}_{1 , 3} = \frac{1}{{t}_{1}} [ \begin{matrix}1 \\ j\end{matrix} ]$ | ${P}_{1 , 4} = \frac{1}{{t}_{1}} [ \begin{matrix}1 \\ - j\end{matrix} ]$ |
| j = 0-1 | 2 rank2 TPMIs 1, 2 | ${P}_{2 , 1} = \frac{1}{{t}_{2}} [ \begin{matrix}1 & 1 \\ 1 & - 1\end{matrix} ]$ | ${P}_{2 , 2} = \frac{1}{{t}_{2}} [ \begin{matrix}1 & 1 \\ j & - j\end{matrix} ]$ | | |

In one embodiment, the UL codebook for 3 antenna ports includes partial-coherent (PC) precoders or precoding matrices that correspond to N_{g}=2, wherein the 3 antenna ports PC precoders or precoding matrices are based on Rel. 15 2Tx UL FC precoders (rank-1 2Tx TPMI=2,3,4,5 and rank-2 2Tx TPMI=1,2), as shown in Table 14. Note that the scaling factors for rank 1 and 2, respectively, are not shown in Table 14. The notation P₁, (i=0,1,2,3) and P₂,j (i=0,1) respectively denote the 2Tx submatrices used to represent or construct the 3Tx precoder for N_{g}=2. In one example, the notation

$${\overline{W}}_{1 , i} = \frac{1}{{t}_{1}} {P}_{1 , i} and {\overline{W}}_{2 , i} = \frac{1}{{t}_{2}} {P}_{2 , i}$$

can be used to represent the 2 precoders with scaling, as shown in Table 15. In one example, t₁=\sqrt{2}. In one example, t₁=2. In one example, t₂=\sqrt{2}. In one example, t₂=2.

In one example, when the 3 port indices are {1,2,3}, the two groups {G₁, G₂}={(g_{1,1}, g_{1,2}), g₂}={(1,2),3} or {(1,3),2} or {(2,3),1}.

In one example, when the 3 port indices are {0,1,2}, the two groups {G₁, G₂}={(g_{1,1},g_{1,2}),g₂}={(0,1), 2}, or {(0,2), 1} or {(1,2), 0}.

If numbering A is used to construct 3Tx precoders based on 2Tx precoders, then the 2Tx precoders are applied to consecutive 2 out of 3 ports, i.e., (1,2 or 3) or (0,1 or 2). Or, if numbering B is used to construct 3Tx precoders based on 2Tx precoders, then the 2Tx precoders are applied to one of the following port pairs, {(1,3), (2)} or {(0,2), (1)}

In one example, the precoding matrix W=W_{B} for numbering scheme B can be obtained by row permutation (ordering) of the precoding matrix W=W_{A} for numbering scheme A. For example,

$${W}_{B} = {W}_{f ( i )} = {{W}^{′}}_{i} = {W}_{A}$$

where the subscripts i and kᵢ=f (i) denote the row of the respective matrix; f(i) is given by Table 16.

TABLE 16
The port mapping function f(i) for
transmission using 8 antenna ports

| i | f(i): N_{g} = 2 | f(i): N_{g} = 2 | f(i): N_{g} = 2 |
|---|---|---|---|
| 0 | 0 | 0 | 1 |
| 1 | 1 | 2 | 2 |
| 2 | 2 | 1 | 0 |

The row index j∈{0,1, . . . ,2} maps to ports f(j)∈{g_{1,1}, g_{1,2}, g_{2,1}}, respectively, {g_{a,b}} are defined later. In one example, W_{f(j)}=W′ⱼ is referred to as intermediate precoder or precoding matrix. In one example, f(j)=iⱼ. In one example, f(iⱼ)=j. Let eᵢ denote an 3×1 column vector whose i-th entry is 1, and remaining entries are 0. Then

$${e}_{1} = \frac{1}{s} [ \begin{matrix}1 \\ 0 \\ 0\end{matrix} ] , {e}_{2} = \frac{1}{s} [ \begin{matrix}0 \\ 1 \\ 0\end{matrix} ] , {e}_{3} = \frac{1}{s} [ \begin{matrix}0 \\ 0 \\ 1\end{matrix} ] .$$

In one example, s=\sqrt{3}. Let

$$P = [ \begin{matrix}{p}_{1} \\ {p}_{2}\end{matrix} ]$$

is a rank 1 precoding matrix for 2 antenna ports, and M_{3×1}(mᵢⱼ=pⱼ) an 3×1 column vector whose iⱼ entry is mᵢⱼ=pⱼ. Then,

$$[ {e}_{{i}_{1}} {e}_{{i}_{2}} ] P = [ {e}_{{i}_{1}} {e}_{{i}_{2}} ] [ \begin{matrix}{p}_{1} \\ {p}_{2}\end{matrix} ] = [ {p}_{1} {e}_{{i}_{1}} + {p}_{2} {e}_{{i}_{2}} ] = {M}_{3 \times 1} ( ( {m}_{{i}_{1}} , {m}_{{i}_{2}} ) = ( {p}_{1} , {p}_{2} ) )$$

For the group that is not applied any layers, a O_{y×r} zero matrix is included in the corresponding rank r 3Tx precoders. In one example, the 3Tx precoders are scaled (multiplied) by 1/s. In one example, s=\sqrt{3}. In one example, s=2. In one example, s=\sqrt{34} where r is a rank value. In one example, s=\sqrt{K_{NZ}} where K_{NZ} is a number of non-zero entries in the precoder.

In one example, the 3Tx precoders included in the codebook correspond to all of or a subset of those in Table 17 or/and Table 18 or/and Table 19, where the port split (P1,P2) refers to number of ports in two groups (G₁, G₂), and the layer split (L1,L2) refers to number of ports in two groups (G₁, G₂).

TABLE 17

| | Port split: | Layer split: | | |
|---|---|---|---|---|
| Rank | (P1, P2) | (L1, L2) | 3Tx precoders | #precoders |
| 1 | (2, 1) | (1, 0) | Q_{G}_{₁}_{, j} = [e_{g}_{_{1, 1}} e_{g}_{_{1, 2}}]P_{1, j}, and j = | 4 |
| | | | 1, . . . , 4 | |
| | | (0, 1) | Q_{G}_{₂} = [e_{g}_{₂}] | 1 |
| | (1, 2) | (1, 0) | Q_{G}_{₁} = [e_{g}_{₁}] | 1 |
| | | (0, 1) | Q_{G}_{₂}_{, j} = [e_{g}_{_{2, 1}} e_{g}_{_{2, 2}}]P_{1, j}, and j = | 4 |
| | | | 1, . . . , 4 | |
| 2 | (2, 1) | (2, 0) | R_{G}_{₁}_{, j} = [e_{g}_{_{1, 1}} e_{g}_{_{1, 2}}]P_{2, j}, and j = 1, 2 | 2 |
| | | (1, 1) | [Q_{G}_{₁}_{, j}, Q_{G}_{₂}], and j = 1, . . . , 4 | 4 |
| | (1, 2) | (1, 1) | [Q_{G}_{₁}, Q_{G}_{₂}_{, j}], and j = 1, . . . , 4 | 4 |
| | | (0, 2) | R_{G}_{₂}_{, j} = [e_{g}_{_{2, 1}} e_{g}_{_{2, 2}}]P_{2, j}, and j = 1, 2 | 2 |
| 3 | (2, 1) | (2, 1) | [R_{G}_{₁}_{, j}, Q_{G}_{₂}], j = 1, 2 | 2 |
| | (1, 2) | (1, 2) | [Q_{G}_{₁}, R_{G}_{₂}_{, j}], j = 1, 2 | 2 |

TABLE 18

| | Port split: | Layer split: | | |
|---|---|---|---|---|
| Rank | (P1, P2) | (L1, L2) | 3Tx precoders | #precoders |
| 1 | (2, 1) | (1, 0) | Q_{G}_{₁}_{, j} = [e_{g}_{_{1, 1}} e_{g}_{_{1, 2}}]P_{1, j}, and j = | 4 |
| | | | 1, . . . , 4 | |
| | | (0, 1) | Q_{G}_{₂} = [e_{g}_{₂}] | 1 |
| 2 | (2, 1) | (2, 0) | R_{G}_{₁}_{, j} = [e_{g}_{_{1, 1}} e_{g}_{_{1, 2}}]P_{2, j}, and j = 1, 2 | 2 |
| | | (1, 1) | [Q_{G}_{₁}_{, j}, Q_{G}_{₂}], and j = 1, . . . , 4 | 4 |
| 3 | (2, 1) | (2, 1) | [R_{G}_{₁}_{, j}, Q_{G}_{₂}], j = 1, 2 | 2 |

TABLE 19

| | Port split: | Layer split: | | |
|---|---|---|---|---|
| Rank | (P1, P2) | (L1, L2) | 3Tx precoders | #precoders |
| 1 | (1, 2) | (1, 0) | Q_{G}_{₁} = [e_{g}_{₁}] | 1 |
| | | (0, 1) | Q_{G}_{₂}_{, j} = [e_{g}_{_{2, 1}} e_{g}_{_{2, 2}}]P_{1, j}, and j = | 4 |
| | | | 1, . . . , 4 | |
| 2 | (1, 2) | (1, 1) | [Q_{G}_{₁}, Q_{G}_{₂}_{, j}], and j = 1, . . . , 4 | 4 |
| | | (0, 2) | R_{G}_{₂}_{, j} = [e_{g}_{_{2, 1}} e_{g}_{_{2, 2}}]P_{2, j}, and j = 1, 2 | 2 |
| 3 | (1, 2) | (1, 2) | [Q_{G}_{₁}, R_{G}_{₂}_{, j}], j = 1, 2 | 2 |

TABLE 20
rank 1 (1 layer) 3Tx precoding matrix W′ᵢ = W_{A}

| Index j | precoder matrix W′ | | | |
|---|---|---|---|---|
| 0-3 | $\frac{1}{{s}_{1}} [ \begin{matrix}{\overline{W}}_{1 , 0} \\ 0\end{matrix} ] = \frac{1}{{s}_{1}} [ \begin{matrix}1 \\ 1 \\ 0\end{matrix} ]$ | $\frac{1}{{s}_{1}} [ \begin{matrix}{\overline{W}}_{1 , 2} \\ 0\end{matrix} ] = \frac{1}{{s}_{1}} [ \begin{matrix}1 \\ j \\ 0\end{matrix} ]$ | $\frac{1}{{s}_{1}} [ \begin{matrix}{\overline{W}}_{1 , 1} \\ 0\end{matrix} ] = \frac{1}{{s}_{1}} [ \begin{matrix}1 \\ - 1 \\ 0\end{matrix} ]$ | $\frac{1}{{s}_{1}} [ \begin{matrix}{\overline{W}}_{1 , 3} \\ 0\end{matrix} ] = \frac{1}{{s}_{1}} [ \begin{matrix}1 \\ - j \\ 0\end{matrix} ]$ |

TABLE 21
rank 1 (1 layer) 3Tx precoding matrix W′ᵢ = W_{A}

| Index j | precoder matrix W′ | | | |
|---|---|---|---|---|
| 0-3 | $\frac{1}{{s}_{1}} [ \begin{matrix}0 \\ {\overline{W}}_{1 , 0}\end{matrix} ] = \frac{1}{{s}_{1}} [ \begin{matrix}0 \\ 1 \\ 1\end{matrix} ]$ | $\frac{1}{{s}_{1}} [ \begin{matrix}0 \\ {\overline{W}}_{1 , 20}\end{matrix} ] = \frac{1}{{s}_{1}} [ \begin{matrix}0 \\ 1 \\ j\end{matrix} ]$ | $\frac{1}{{s}_{1}} [ \begin{matrix}0 \\ {\overline{W}}_{1 , 1}\end{matrix} ] = \frac{1}{{s}_{1}} [ \begin{matrix}0 \\ 1 \\ - 1\end{matrix} ]$ | $\frac{1}{{s}_{1}} [ \begin{matrix}0 \\ {\overline{W}}_{1 , 3}\end{matrix} ] = \frac{1}{{s}_{1}} [ \begin{matrix}0 \\ 1 \\ - j\end{matrix} ]$ |

TABLE 22
rank 1 (1 layer) 3Tx precoding matrix W′ᵢ = W_{A}

| Index j | precoder matrix W′ | | | |
|---|---|---|---|---|
| 0-3 | $\frac{1}{{s}_{1}} [ \begin{matrix}1 \\ 0 \\ 1\end{matrix} ]$ | $\frac{1}{{s}_{1}} [ \begin{matrix}1 \\ 0 \\ j\end{matrix} ]$ | $\frac{1}{{s}_{1}} [ \begin{matrix}1 \\ 0 \\ - 1\end{matrix} ]$ | $\frac{1}{{s}_{1}} [ \begin{matrix}1 \\ 0 \\ - j\end{matrix} ]$ |

In one embodiment, the rank 1 (1 layer) UL codebook for 3 antenna ports includes PC precoders that correspond to all of or a subset of those in Table 20 or/and Table 21 or/and Table 22. In one example, s₁ \sqrt{3}.

TABLE 23
rank 2 (2 layers) 3Tx precoding matrix W′ᵢ = W_{A}

| Index j | precoder matrix W′ | | | |
|---|---|---|---|---|
| 0-3 | $\frac{1}{{s}_{2}} [ \begin{matrix}{\overline{W}}_{1 , 0} & {0}_{2 \times 1} \\ 0 & 1\end{matrix} ] = \frac{1}{{s}_{2}} [ \begin{matrix}1 & 0 \\ 1 & 0 \\ 0 & 1\end{matrix} ]$ | $\frac{1}{{s}_{2}} [ \begin{matrix}{\overline{W}}_{1 , 2} & {0}_{2 \times 1} \\ 0 & 1\end{matrix} ] = \frac{1}{{s}_{2}} [ \begin{matrix}1 & 0 \\ j & 0 \\ 0 & 1\end{matrix} ]$ | $\frac{1}{{s}_{2}} [ \begin{matrix}{\overline{W}}_{1 , 1} & {0}_{2 \times 1} \\ 0 & 1\end{matrix} ] = \frac{1}{{s}_{2}} [ \begin{matrix}1 & 0 \\ - 1 & 0 \\ 0 & 1\end{matrix} ]$ | $\frac{1}{{s}_{2}} [ \begin{matrix}{\overline{W}}_{1 , 3} & {0}_{2 \times 1} \\ 0 & 1\end{matrix} ] = \frac{1}{{s}_{2}} [ \begin{matrix}1 & 0 \\ - j & 0 \\ 0 & 1\end{matrix} ]$ |

TABLE 24
rank 2 (2 layers) 3Tx precoding matrix W′ᵢ = W_{A}

| Index j | precoder matrix W′ | | | |
|---|---|---|---|---|
| 0-3 | $\frac{1}{{s}_{2}} [ \begin{matrix}0 & 1 \\ {\overline{W}}_{1 , 0} & {0}_{2 ⨯ 1}\end{matrix} ] = \frac{1}{{s}_{2}} [ \begin{matrix}0 & 1 \\ 1 & 0 \\ 1 & 0\end{matrix} ]$ | $\frac{1}{{s}_{2}} [ \begin{matrix}0 & 1 \\ {\overline{W}}_{1 , 2} & {0}_{2 ⨯ 1}\end{matrix} ] = \frac{1}{{s}_{2}} [ \begin{matrix}0 & 1 \\ 1 & 0 \\ j & 0\end{matrix} ]$ | $\frac{1}{{s}_{2}} [ \begin{matrix}0 & 1 \\ {\overline{W}}_{1 , 1} & {0}_{2 ⨯ 1}\end{matrix} ] = \frac{1}{{s}_{2}} [ \begin{matrix}0 & 1 \\ 1 & 0 \\ - 1 & 0\end{matrix} ]$ | $\frac{1}{{s}_{2}} [ \begin{matrix}0 & 1 \\ {\overline{W}}_{1 , 3} & {0}_{2 ⨯ 1}\end{matrix} ] = \frac{1}{{s}_{2}} [ \begin{matrix}0 & 1 \\ 1 & 0 \\ - j & 0\end{matrix} ]$ |

TABLE 25
rank 2 (2 layers) 3Tx precoding matrix W′ᵢ = W_{A}

| Index j | precoder matrix W′ | | | |
|---|---|---|---|---|
| 0-3 | $\frac{1}{{s}_{2}} [ \begin{matrix}1 & 0 \\ 0 & 1 \\ 1 & 0\end{matrix} ]$ | $\frac{1}{{s}_{2}} [ \begin{matrix}1 & 0 \\ 0 & 1 \\ j & 0\end{matrix} ]$ | $\frac{1}{{s}_{2}} [ \begin{matrix}1 & 0 \\ 0 & 1 \\ - 1 & 0\end{matrix} ]$ | $\frac{1}{{s}_{2}} [ \begin{matrix}1 & 0 \\ 0 & 1 \\ - j & 0\end{matrix} ]$ |

In one embodiment, the rank 2 (2 layers) UL codebook for 3 antenna ports includes PC precoding matrices that correspond to all of or a subset of those in Table 23 or/and Table 24 or/and Table 25. In one example, s₂=\sqrt{3}. In one example, s₂=\sqrt{6}.

TABLE 26
rank 3 (3 layers) 3Tx precoding matrix W′ᵢ = W_{A}

| Index j | precoder matrix W′ | |
|---|---|---|
| 0-1 | $\frac{1}{{s}_{3}} [ \begin{matrix}{\overline{W}}_{2 , 0} & {0}_{2 \times 1} \\ {0}_{1 ⨯ 2} & 1\end{matrix} ] = \frac{1}{{s}_{3}} [ \begin{matrix}1 & 1 & 0 \\ 1 & - 1 & 0 \\ 0 & 0 & 1\end{matrix} ]$ | $\frac{1}{{s}_{3}} [ \begin{matrix}{\overline{W}}_{2 , 10} & {0}_{2 \times 1} \\ {0}_{1 ⨯ 2} & 1\end{matrix} ] = \frac{1}{{s}_{3}} [ \begin{matrix}1 & 1 & 0 \\ j & - j & 0 \\ 0 & 0 & 1\end{matrix} ]$ |

TABLE 27
rank 3 (3 layers) 3Tx precoding matrix W′ᵢ = W_{A}

| Index j | precoder matrix W′ | |
|---|---|---|
| 0-1 | $\frac{1}{{s}_{3}} [ \begin{matrix}{0}_{1 ⨯ 2} & 1 \\ {\overline{W}}_{2 , 0} & {0}_{2 ⨯ 1}\end{matrix} ] = \frac{1}{{s}_{3}} [ \begin{matrix}0 & 0 & 1 \\ 1 & 1 & 0 \\ 1 & - 1 & 0\end{matrix} ]$ | $\frac{1}{{s}_{3}} [ \begin{matrix}{0}_{1 \times 2} & 1 \\ {\overline{W}}_{2 , 0} & {0}_{2 \times 1}\end{matrix} ] = \frac{1}{{s}_{3}} [ \begin{matrix}0 & 0 & 1 \\ 1 & 1 & 0 \\ j & - j & 0\end{matrix} ]$ |

TABLE 28
rank 3 (3 layers) 3Tx precoding matrix W′ᵢ = W_{A}

| Index j | precoder matrix W′ | |
|---|---|---|
| 0-1 | $\frac{1}{{s}_{3}} [ \begin{matrix}1 & 1 & 0 \\ 0 & 0 & 1 \\ 1 & - 1 & 0\end{matrix} ]$ | $\frac{1}{{s}_{3}} [ \begin{matrix}1 & 1 & 0 \\ 0 & 0 & 1 \\ j & - j & 0\end{matrix} ]$ |

In one embodiment, the rank 3 (3 layers) UL codebook for 3 antenna ports includes PC precoding matrices that correspond to all of or a subset of those in Table 26 or/and Table 27 or/and Table 28. In one example, s₃=3. In one example, s₃=\sqrt{3}.

TABLE 29
rank 3 (3 layers) 3Tx precoding matrix W′ᵢ = W_{A}

| Index j | precoder matrix W′ | |
|---|---|---|
| 0-1 | $\frac{1}{{s}_{3}} [ \begin{matrix}\frac{1}{x} [ \begin{matrix}1 \\ 1\end{matrix} & \begin{matrix}1 \\ - 1\end{matrix} ] & \begin{matrix}0 \\ 0\end{matrix} \\ 0 & 0 & 1\end{matrix} ]$ | $\frac{1}{{s}_{3}} [ \begin{matrix}\frac{1}{x} [ \begin{matrix}1 \\ j\end{matrix} & \begin{matrix}1 \\ - j\end{matrix} ] & \begin{matrix}0 \\ 0\end{matrix} \\ 0 & 0 & 1\end{matrix} ]$ |

TABLE 30
rank 3 (3 layers) 3Tx precoding matrix W′ᵢ = W_{A}

| Index j | precoder matrix W′ | |
|---|---|---|
| 0-1 | $\frac{1}{{s}_{3}} [ \begin{matrix}0 & 0 & 1 \\ \frac{1}{x} [ \begin{matrix}1 \\ 1\end{matrix} & \begin{matrix}1 \\ - 1\end{matrix} ] & \begin{matrix}0 \\ 0\end{matrix}\end{matrix} ]$ | $\frac{1}{{s}_{3}} [ \begin{matrix}0 & 0 & 1 \\ \frac{1}{x} [ \begin{matrix}1 \\ j\end{matrix} & \begin{matrix}1 \\ - j\end{matrix} ] & \begin{matrix}0 \\ 0\end{matrix}\end{matrix} ]$ |

TABLE 31
rank 3 (3 layers) 3Tx precoding matrix W′ᵢ = W_{A}

| | |
|---|---|
| Index j | precoder matrix W′ |

| | | |
|---|---|---|
| 0-1 | $\frac{1}{{s}_{3}} [ \begin{matrix}\frac{1}{x} & \frac{1}{x} & 0 \\ 0 & 0 & 1 \\ \frac{1}{x} & - \frac{1}{x} & 0\end{matrix} ]$ | $\frac{1}{{s}_{3}} [ \begin{matrix}\frac{1}{x} & \frac{1}{x} & 0 \\ 0 & 0 & 1 \\ \frac{1}{x} j & - \frac{1}{x} j & 0\end{matrix} ]$ |

In one embodiment, the rank 3 (3 layers) UL codebook for 3 antenna ports includes PC precoding matrices that correspond to all of or a subset of those in Table 29 or/and Table 30 or/and Table 31. In one example, s₃=3. In one example, s₃=\sqrt{3}. In one example, x=\sqrt{2}. In one example, x=2. In one example, x=1. In one example, x=\sqrt{2} or 1 subject to UE capability. For instance, the UE (e.g., the UE 116) can report via capability reporting whether it supports x=1 or x=\sqrt{2}. Or, the UE can report via capability reporting whether it supports x=1 or x=\sqrt{2} or both x=1,\sqrt{2}. The value of x can then be fixed or configured (via higher layer) based on or subject to the capability reporting.

In one embodiment, the codebook for 3 antenna ports, as described in previous embodiment (or later embodiments), can also be used/configured (to a UE) for DL (e.g. for CSI/PMI reporting based on 3 CSI-RS antenna ports at NW/gNB), or sidelink (SL) (e.g. for CSI/PMI reporting based on 3 CSI-RS antenna ports at a SL UE/device). It can also be used to configure/trigger a CSI report for network energy saving (NES) applications wherein the NW/gNB may want to trigger (e.g. dynamically via MAC CE or DCI) a sub-configurations of the CSI report in which the number of CSI-RS ports is less than that at the NW/gNB. For instance, NW/gNB may trigger a CSI report for 3 CSI-RS ports that are a subset of >3 (e.g. 4, or 8) CSI-RS ports.

In one embodiment, the UL codebook for 3 antenna ports includes non-coherent (NC) precoders or precoding matrices, in addition to partial-coherent (PC) precoders or precoding matrices, according to one or more embodiments described herein, where a NC precoder or precoding matrix can be defined as a matrix who's each column comprises one non-zero entry and the rest zero entries, e.g., each column is a port selection vector. An example of the NC precoding matrices is shown in Table 32. In one example, s₁=s₂=s₃=s, where s=3 or 2 or \sqrt{3} or \sqrt{K_{NZ}} where K_{NZ} is a number of non-zero entries in the precoder. In one example, s₁=\sqrt{3}. In one example, s₂=\sqrt{6}. In one example, s₃=3.

TABLE 32
NC precoding matrices for 3 antenna ports when codebookSubset = nonCoherent

| Rank | TPMI index i | Number of NC TPMIs | Precoding matrix W′ | | |
|---|---|---|---|---|---|
| 1 | 0-2 | 3 | $\frac{1}{{s}_{1}} [ \begin{matrix}1 \\ 0 \\ 0\end{matrix} ]$ | $\frac{1}{{s}_{1}} [ \begin{matrix}0 \\ 1 \\ 0\end{matrix} ]$ | $\frac{1}{{s}_{1}} [ \begin{matrix}0 \\ 0 \\ 1\end{matrix} ]$ |
| 2 | 0-2 | 3 | $\frac{1}{{s}_{2}} [ \begin{matrix}1 & 0 \\ 0 & 1 \\ 0 & 0\end{matrix} ]$ | $\frac{1}{{s}_{2}} [ \begin{matrix}1 & 0 \\ 0 & 0 \\ 0 & 1\end{matrix} ]$ | $\frac{1}{{s}_{2}} [ \begin{matrix}0 & 0 \\ 1 & 0 \\ 0 & 1\end{matrix} ]$ |
| 3 | 0 | 1 | $\frac{1}{{s}_{3}} [ \begin{matrix}1 & 0 & 0 \\ 0 & 1 & 0 \\ 0 & 0 & 1\end{matrix} ]$ | | |
| Total | | 7 | | | |

In one example, a NC 3Tx precoder is indicated via a TPMI, where for maxRank equals to 1, TPMI field is 2 bits and for maxRank equals to 2 or 3, TPMI field is 3 bits.

TABLE 32.5

| maxRank | From Table 16 | Payload (number of bits) |
|---|---|---|
| 1 | 1 layer, TPMI 0-2 | 2 |
| 2 | 1 layer, TPMI 0-2 | 3 |
| | 2 layer, TPMI 0-2 | |
| 3 | 1 layer, TPMI 0-2 | 3 |
| | 2 layer, TPMI 0-2 | |
| | 3 layer, TPMI 0 | |

In one example, a NC 3Tx precoder is indicated via a 3-bit bitmap b₀b₁b₂ where a bit bᵢ is associated with a port i. In one example, when bᵢ=1, the corresponding port i is selected, i.e., non-zero (e.g. value 1), and when bᵢ=0, the corresponding port i is not selected, i.e., zero (e.g. value 0). In one example, when bᵢ=0, the corresponding port i is selected, i.e., non-zero (e.g. value 1), and when bᵢ=1, the corresponding port i is not selected, i.e., zero (e.g. value 0).

In one embodiment, the codebook for 3 antenna ports, as described in previous embodiment (or later embodiments), can also be used/configured (to a UE) for DL (e.g. for CSI/PMI reporting based on 3 CSI-RS antenna ports at NW/gNB), or sidelink (SL) (e.g. for CSI/PMI reporting based on 3 CSI-RS antenna ports at a SL UE/device). It can also be used to configure/trigger a CSI report for network energy saving (NES) applications wherein the NW/gNB may want to trigger (e.g. dynamically via MAC CE or DCI) a sub-configurations of the CSI report in which the number of CSI-RS ports is less than that at the NW/gNB. For instance, NW/gNB (e.g., the network 130/the BS 102 may trigger a CSI report for 3 CSI-RS ports that are a subset of >3 (e.g. 4, or 8) CSI-RS ports.

In one example, the UE codebook for N_{g}=1 can be referred to as or configured as full-Coherent (FC). In one example, the UE codebook for N_{g}=2 can be referred to as or configured as partial-Coherent (PC). In one example, the UE codebook for N_{g}=3 can be referred to as or configured as non-Coherent (NC). In one example, the UE codebook including both N_{g}=(n₁, n₂)=(1,2) precoders can be referred to as or configured as fullAndPartial-Coherent (FC-PC). In one example, the UE codebook including both N_{g}=(n₁, n₂)=(1,3) precoders can be referred to as or configured asfullAndNon-Coherent (FC-NC). In one example, the UE codebook including both N_{g}=(n₁, n₂)=(2,3) precoders can be referred to as or configured as partialAndNon-Coherent (PC-NC). In one example, the UE codebook including both N_{g}=(n₁, n₂,n₃)=(1,2,3) precoders can be referred to as or configured as fullAndPartialAndNon-Coherent (FC-PC-NC).

When configured, A or/and B can be used interchangeably, where A or/and B is according to one of the following.

$${N}_{g} = 1 or / and full - Coherent ( FC )$$

$${N}_{g} = 2 or / and partial - Coherent ( PC )$$

$${N}_{g} = 3 or / and non - Coherent ( NFC )$$

$${N}_{g} = ( {n}_{1} , {n}_{2} ) = ( 1 , 2 ) or / and fullAndPartial - Coherent ( FC - PC )$$

$${N}_{g} = ( {n}_{1} , {n}_{2} ) = ( 1 , 3 ) or / and fullAndNon - Coherent ( FC - NC )$$

$${N}_{g} = ( {n}_{1} , {n}_{2} ) = ( 2 , 3 ) or / and partialAndNon - Coherent ( PC - NC )$$

$${N}_{g} = ( {n}_{1} , {n}_{2} , {n}_{3} ) = ( 1 , 2 , 3 ) or / and fullAndPartialAndNon - Coherent ( FC - PC - NC )$$

In one embodiment, a UE is configured with a codebook subset (e.g. via higher layer parameter such as codebookSubset) of an UL codebook for 3 antenna ports, where codebookSubset=nonCoherent or nonAndPartialCoherent. When codebookSubset=nonCoherent, the configured UL codebook includes a codebook subset comprising/including NC precoders or precoding matrices. When codebookSubset=nonAndPartialCoherent, the configured UL codebook includes a codebook subset comprising/including both NC and PC precoders or precoding matrices. The NC precoders or precoding matrices are as in Table 32. The PC precoders or precoding matrices are according to one of the three examples (Ex1, Ex2, Ex3) in Table 8. Note in Ex3, there is no rank 3 PC precoding matrix. Four examples of codebookSubset=partialAndNonCoherent are according to Table 10.

TABLE 33
Two examples of PC TPMIs for 3 antenna ports

| | Partial-Coherent (PC) TPMIs | | | | | |
|---|---|---|---|---|---|---|
| | Ex1 | | Ex2 | | Ex3 | |
| | TPMI | Number of PC | TPMI | Number of PC | TPMI | Number of PC |
| Rank | index i | TPMIs | index i | TPMIs | index i | TPMIs |
| 1 | 3-6 | 4 | 3-6 | 4 | 3-6 | 4 |
| 2 | 3-6 | 4 | 3-6 | 4 | 3-6 | 4 |
| 3 | 1-2 | 2 | 1 | 1 | | |
| Total | | 10 | | 9 | | 8 |

TABLE 34
TPMI indices for 3 antenna ports when
codebookSubset = partialAndNonCoherent

TPMI index i

| Rank | ExA | ExB | ExC | ExD |
|---|---|---|---|---|
| 1 | 0-6 | 0-6 | 0-6 | 0-6 |
| 2 | 0-6 | 0-6 | 0-6 | 0-6 |
| 3 | 0-2 | 0-1 | 1-2 | 0 |
| Total | 17 | 16 | 16 | 15 |

In one example, the corresponding NC and PC precoding matrices include all of or a subset of those in (a) Table 35 or/and Table 36 or/and Table 37 for single-layer, (b) Table 38 or/and Table 39 or/and Table 40 for two-layers, and (c) Table 41 or/and Table 42 or/and Table 43 for three-layers, or Table 44 or/and Table 45 or/and Table 46 for three-layers, or Table 53 for three-layers, wherein:
In Table 35, TPMI index i=3,4,5,6 corresponds to Index j=0, 1,2,3 of Table 20
In Table 36, TPMI index i=3,4,5,6 corresponds to Index j=0, 1,2,3 of Table 21
In Table 37, TPMI index i=3,4,5,6 corresponds to Index j=0, 1,2,3 of Table 22
In Table 38, TPMI index i=3,4,5,6 corresponds to Index j=0,1,2,3 of Table 23
In Table 39, TPMI index i=3,4,5,6 corresponds to Index j=0,1,2,3 of Table 24
In Table 40, TPMI index i=3,4,5,6 corresponds to Index j=0,1,2,3 of Table 25
In Table 41, TPMI index i=1,2 corresponds to Index j=0,1 of Table 26
In Table 42, TPMI index i=1,2 corresponds to Index j=0,1 of Table 27
In Table 43, TPMI index i=1,2 corresponds to Index j=0,1 of Table 28
In Table 44, TPMI index i=1,2 corresponds to Index j=0,1 of Table 29
In Table 45, TPMI index i=1,2 corresponds to Index j=0,1 of Table 30
In Table 46, TPMI index i=1,2 corresponds to Index j=0,1 of Table 31
In Table 47, TPMI index i=1 corresponds to Index j=0 of Table 26
In Table 48, TPMI index i=1 corresponds to Index j=0 of Table 27
In Table 49, TPMI index i=1 corresponds to Index j=0 of Table 28
In Table 50, TPMI index i=1 corresponds to Index j=0 of Table 29
In Table 51, TPMI index i=1 corresponds to Index j=0 of Table 30
In Table 52, TPMI index i=1 corresponds to Index j=0 of Table 31

In one example, rank 3 TPMI=1-2 in ExA and ExC correspond to one of Table 41 through Table 46. In one example, rank 3 TPMI=1 in ExB corresponds to one of Table 47 through Table 52.

TABLE 35
Precoding matrix for single-layer transmission using three antenna ports

| | Precoding matrix W' | | | | | | |
|---|---|---|---|---|---|---|---|
| TPMI index i | (ordered from left to right in increasing order of TPMI index) | | | | | | |
| 0-6 | $\frac{1}{{s}_{1}} [ \begin{matrix}1 \\ 0 \\ 0\end{matrix} ]$ | $\frac{1}{{s}_{1}} [ \begin{matrix}0 \\ 1 \\ 0\end{matrix} ]$ | $\frac{1}{{s}_{1}} [ \begin{matrix}0 \\ 0 \\ 1\end{matrix} ]$ | $\frac{1}{{s}_{1}} [ \begin{matrix}1 \\ 1 \\ 0\end{matrix} ]$ | $\frac{1}{{s}_{1}} [ \begin{matrix}1 \\ j \\ 0\end{matrix} ]$ | $\frac{1}{{s}_{1}} [ \begin{matrix}1 \\ - 1 \\ 0\end{matrix} ]$ | $\frac{1}{{s}_{1}} [ \begin{matrix}1 \\ - j \\ 0\end{matrix} ]$ |

TABLE 36
Precoding matrix for single-layer transmission using three antenna ports

| | Precoding matrix W' | | | | | | |
|---|---|---|---|---|---|---|---|
| TPMI index i | (ordered from left to right in increasing order of TPMI index) | | | | | | |
| 0-6 | $\frac{1}{{s}_{1}} [ \begin{matrix}1 \\ 0 \\ 0\end{matrix} ]$ | $\frac{1}{{s}_{1}} [ \begin{matrix}0 \\ 1 \\ 0\end{matrix} ]$ | $\frac{1}{{s}_{1}} [ \begin{matrix}0 \\ 0 \\ 1\end{matrix} ]$ | $\frac{1}{{s}_{1}} [ \begin{matrix}0 \\ 1 \\ 1\end{matrix} ]$ | $\frac{1}{{s}_{1}} [ \begin{matrix}0 \\ 1 \\ j\end{matrix} ]$ | $\frac{1}{{s}_{1}} [ \begin{matrix}0 \\ 1 \\ - 1\end{matrix} ]$ | $\frac{1}{{s}_{1}} [ \begin{matrix}0 \\ 1 \\ - j\end{matrix} ]$ |

TABLE 37
Precoding matrix for single-layer transmission using three antenna ports

| | Precoding matrix W′ | | | | | | |
|---|---|---|---|---|---|---|---|
| TPMI index i | (ordered from left to right in increasing order of TPMI index) | | | | | | |
| 0-6 | $\frac{1}{{s}_{1}} [ \begin{matrix}1 \\ 0 \\ 0\end{matrix} ]$ | $\frac{1}{{s}_{1}} [ \begin{matrix}0 \\ 1 \\ 0\end{matrix} ]$ | $\frac{1}{{s}_{1}} [ \begin{matrix}0 \\ 0 \\ 1\end{matrix} ]$ | $\frac{1}{{s}_{1}} [ \begin{matrix}1 \\ 0 \\ 1\end{matrix} ]$ | $\frac{1}{{s}_{1}} [ \begin{matrix}1 \\ 0 \\ j\end{matrix} ]$ | $\frac{1}{{s}_{1}} [ \begin{matrix}1 \\ 0 \\ - 1\end{matrix} ]$ | $\frac{1}{{s}_{1}} [ \begin{matrix}1 \\ 0 \\ - j\end{matrix} ]$ |

TABLE 38
Precoding matrix for two-layer transmission using three antenna ports

| TPMI | Precoding matrix W′ | | | | | | |
|---|---|---|---|---|---|---|---|
| index i | (ordered from left to right in increasing order of TPMI index) | | | | | | |
| 0-6 | $\frac{1}{{s}_{2}} [ \begin{matrix}1 & 0 \\ 0 & 1 \\ 0 & 0\end{matrix} ]$ | $\frac{1}{{s}_{2}} [ \begin{matrix}1 & 0 \\ 0 & 0 \\ 0 & 1\end{matrix} ]$ | $\frac{1}{{s}_{2}} [ \begin{matrix}0 & 0 \\ 1 & 0 \\ 0 & 1\end{matrix} ]$ | $\frac{1}{{s}_{2}} [ \begin{matrix}1 & 0 \\ 1 & 0 \\ 0 & 1\end{matrix} ]$ | $\frac{1}{{s}_{2}} [ \begin{matrix}1 & 0 \\ j & 0 \\ 0 & 1\end{matrix} ]$ | $\frac{1}{{s}_{2}} [ \begin{matrix}1 & 0 \\ - 1 & 0 \\ 0 & 1\end{matrix} ]$ | $\frac{1}{{s}_{2}} [ \begin{matrix}1 & 0 \\ - j & 0 \\ 0 & 1\end{matrix} ]$ |

TABLE 39
Precoding matrix for two-layer transmission using three antenna ports

| TPMI | Precoding matrix W′ | | | | | | |
|---|---|---|---|---|---|---|---|
| index i | (ordered from left to right in increasing order of TPMI index) | | | | | | |
| 0-6 | $\frac{1}{{s}_{2}} [ \begin{matrix}1 & 0 \\ 0 & 1 \\ 0 & 0\end{matrix} ]$ | $\frac{1}{{s}_{2}} [ \begin{matrix}1 & 0 \\ 0 & 0 \\ 0 & 1\end{matrix} ]$ | $\frac{1}{{s}_{2}} [ \begin{matrix}0 & 0 \\ 1 & 0 \\ 0 & 1\end{matrix} ]$ | $\frac{1}{{s}_{2}} [ \begin{matrix}0 & 1 \\ 1 & 0 \\ 1 & 0\end{matrix} ]$ | $\frac{1}{{s}_{2}} [ \begin{matrix}0 & 1 \\ 1 & 0 \\ j & 0\end{matrix} ]$ | $\frac{1}{{s}_{2}} [ \begin{matrix}0 & 1 \\ 1 & 0 \\ - 1 & 0\end{matrix} ]$ | $\frac{1}{{s}_{2}} [ \begin{matrix}0 & 1 \\ 1 & 0 \\ - j & 0\end{matrix} ]$ |

TABLE 40
Precoding matrix for two-layer transmission using three antenna ports

| TPMI | Precoding matrix W′ | | | | | | |
|---|---|---|---|---|---|---|---|
| index i | (ordered from left to right in increasing order of TPMI index) | | | | | | |
| 0-6 | $\frac{1}{{s}_{2}} [ \begin{matrix}1 & 0 \\ 0 & 1 \\ 0 & 0\end{matrix} ]$ | $\frac{1}{{s}_{2}} [ \begin{matrix}1 & 0 \\ 0 & 0 \\ 0 & 1\end{matrix} ]$ | $\frac{1}{{s}_{2}} [ \begin{matrix}0 & 0 \\ 1 & 0 \\ 0 & 1\end{matrix} ]$ | $\frac{1}{{s}_{2}} [ \begin{matrix}1 & 0 \\ 0 & 1 \\ 1 & 0\end{matrix} ]$ | $\frac{1}{{s}_{2}} [ \begin{matrix}1 & 0 \\ 0 & 1 \\ j & 0\end{matrix} ]$ | $\frac{1}{{s}_{2}} [ \begin{matrix}1 & 0 \\ 0 & 1 \\ - 1 & 0\end{matrix} ]$ | $\frac{1}{{s}_{2}} [ \begin{matrix}1 & 0 \\ 0 & 1 \\ - j & 0\end{matrix} ]$ |

TABLE 41
Precoding matrix for three-layer transmission using three antenna ports

| TPMI | Precoding matrix W′ | | |
|---|---|---|---|
| index i | (ordered from left to right in increasing order of TPMI index) | | |
| 0-2 | $\frac{1}{{s}_{3}} [ \begin{matrix}1 & 0 & 0 \\ 0 & 1 & 0 \\ 0 & 0 & 1\end{matrix} ]$ | $\frac{1}{{s}_{3}} [ \begin{matrix}1 & 1 & 0 \\ 1 & - 1 & 0 \\ 0 & 0 & 1\end{matrix} ]$ | $\frac{1}{{s}_{3}} [ \begin{matrix}1 & 1 & 0 \\ j & - j & 0 \\ 0 & 0 & 1\end{matrix} ]$ |

TABLE 42
Precoding matrix for three-layer transmission using three antenna ports

| TPMI | Precoding matrix W′ | | |
|---|---|---|---|
| index i | (ordered from left to right in increasing order of TPMI index) | | |
| 0-2 | $\frac{1}{{s}_{3}} [ \begin{matrix}1 & 0 & 0 \\ 0 & 1 & 0 \\ 0 & 0 & 1\end{matrix} ]$ | $\frac{1}{{s}_{3}} [ \begin{matrix}0 & 0 & 1 \\ 1 & 1 & 0 \\ 1 & - 1 & 0\end{matrix} ]$ | $\frac{1}{{s}_{3}} [ \begin{matrix}0 & 0 & 1 \\ 1 & 1 & 0 \\ j & - j & 0\end{matrix} ]$ |

TABLE 43
Precoding matrix for three-layer transmission using three antenna ports

| TPMI | Precoding matrix W′ | | |
|---|---|---|---|
| index i | (ordered from left to right in increasing order of TPMI index) | | |
| 0-2 | $\frac{1}{{s}_{3}} [ \begin{matrix}1 & 0 & 0 \\ 0 & 1 & 0 \\ 0 & 0 & 1\end{matrix} ]$ | $\frac{1}{{s}_{3}} [ \begin{matrix}1 & 1 & 0 \\ 0 & 0 & 1 \\ 1 & - 1 & 0\end{matrix} ]$ | $\frac{1}{{s}_{3}} [ \begin{matrix}1 & 1 & 0 \\ 0 & 0 & 1 \\ j & - j & 0\end{matrix} ]$ |

TABLE 44
Precoding matrix for three-layer transmission using three antenna ports

| TPMI | Precoding matrix W′ | | |
|---|---|---|---|
| index i | (ordered from left to right in increasing order of TPMI index) | | |
| 0-2 | $\frac{1}{{s}_{3}} [ \begin{matrix}1 & 0 & 0 \\ 0 & 1 & 0 \\ 0 & 0 & 1\end{matrix} ]$ | $\frac{1}{{s}_{3}} [ \begin{matrix}\frac{1}{x} & [ 1 & 1 ] & 0 \\ & [ 1 & - 1 ] & 0 \\ & 0 & 0 & 1\end{matrix} ]$ | $\frac{1}{{s}_{3}} [ \begin{matrix}\frac{1}{x} & [ 1 & 1 ] & 0 \\ & [ j & - j ] & 0 \\ & 0 & 0 & 1\end{matrix} ]$ |

TABLE 45
Precoding matrix for three-layer transmission using three antenna ports

| TPMI | Precoding matrix W′ | | |
|---|---|---|---|
| index i | (ordered from left to right in increasing order of TPMI index) | | |
| 0-2 | $\frac{1}{{s}_{3}} [ \begin{matrix}1 & 0 & 0 \\ 0 & 1 & 0 \\ 0 & 0 & 1\end{matrix} ]$ | $\frac{1}{{s}_{3}} [ \begin{matrix} & 0 & 0 & 1 \\ \frac{1}{x} & [ 1 & 1 ] & 0 \\ & [ 1 & - 1 ] & 0\end{matrix} ]$ | $\frac{1}{{s}_{3}} [ \begin{matrix} & 0 & 0 & 1 \\ \frac{1}{x} & [ 1 & 1 ] & 0 \\ & [ j & - j ] & 0\end{matrix} ]$ |

TABLE 46
Precoding matrix for three-layer transmission using three antenna ports

| TPMI | Precoding matrix W′ | | |
|---|---|---|---|
| index i | (ordered from left to right in increasing order of TPMI index) | | |
| 0-2 | $\frac{1}{{s}_{3}} [ \begin{matrix}1 & 0 & 0 \\ 0 & 1 & 0 \\ 0 & 0 & 1\end{matrix} ]$ | $\frac{1}{{s}_{3}} [ \begin{matrix}\frac{1}{x} & \frac{1}{x} & 0 \\ 0 & 0 & 1 \\ \frac{1}{x} & - \frac{1}{x} & 0\end{matrix} ]$ | $\frac{1}{{s}_{3}} [ \begin{matrix}\frac{1}{x} & \frac{1}{x} & 0 \\ 0 & 0 & 1 \\ \frac{1}{x} j & - \frac{1}{x} j & 0\end{matrix} ]$ |

TABLE 47
Precoding matrix for three-layer transmission using three antenna ports

| TPMI | Precoding matrix W′ | |
|---|---|---|
| index i | (ordered from left to right in increasing order of TPMI index) | |
| 0-1 | $\frac{1}{{s}_{3}} [ \begin{matrix}1 & 0 & 0 \\ 0 & 1 & 0 \\ 0 & 0 & 1\end{matrix} ]$ | $\frac{1}{{s}_{3}} [ \begin{matrix}1 & 1 & 0 \\ 1 & - 1 & 0 \\ 0 & 0 & 1\end{matrix} ]$ |

TABLE 48
Precoding matrix for three-layer transmission using three antenna ports

| TPMI | Precoding matrix W′ | |
|---|---|---|
| index i | (ordered from left to right in increasing order of TPMI index) | |
| 0-1 | $\frac{1}{{s}_{3}} [ \begin{matrix}1 & 0 & 0 \\ 0 & 1 & 0 \\ 0 & 0 & 1\end{matrix} ]$ | $\frac{1}{{s}_{3}} [ \begin{matrix}0 & 0 & 1 \\ 1 & 1 & 0 \\ 1 & - 1 & 0\end{matrix} ]$ |

TABLE 49
Precoding matrix for three-layer transmission using three antenna ports

| TPMI | Precoding matrix W′ | |
|---|---|---|
| index i | (ordered from left to right in increasing order of TPMI index) | |
| 0-1 | $\frac{1}{{s}_{3}} [ \begin{matrix}1 & 0 & 0 \\ 0 & 1 & 0 \\ 0 & 0 & 1\end{matrix} ]$ | $\frac{1}{{s}_{3}} [ \begin{matrix}1 & 1 & 0 \\ 0 & 0 & 1 \\ 1 & - 1 & 0\end{matrix} ]$ |

TABLE 50
Precoding matrix for three-layer transmission using three antenna ports

| TPMI | Precoding matrix W′ | |
|---|---|---|
| index i | (ordered from left to right in increasing order of TPMI index) | |
| 0-1 | $\frac{1}{{s}_{3}} [ \begin{matrix}1 & 0 & 0 \\ 0 & 1 & 0 \\ 0 & 0 & 1\end{matrix} ]$ | $\frac{1}{{s}_{3}} [ \begin{matrix}\frac{1}{x} & [ 1 & 1 ] & 0 \\ & [ 1 & - 1 ] & 0 \\ & 0 & 0 & 1\end{matrix} ]$ |

TABLE 51
Precoding matrix for three-layer transmission using three antenna ports

| TPMI | Precoding matrix W′ | |
|---|---|---|
| index i | (ordered from left to right in increasing order of TPMI index) | |
| 0-1 | $\frac{1}{{s}_{3}} [ \begin{matrix}1 & 0 & 0 \\ 0 & 1 & 0 \\ 0 & 0 & 1\end{matrix} ]$ | $\frac{1}{{s}_{3}} [ \begin{matrix} & 0 & 0 & 1 \\ & [ 1 & 1 ] & 0 \\ \frac{1}{x} & [ 1 & - 1 ] & 0\end{matrix} ]$ |

TABLE 52
Precoding matrix for three-layer transmission using three antenna ports

| TPMI | Precoding matrix W′ | |
|---|---|---|
| index i | (ordered from left to right in increasing order of TPMI index) | |
| 0-1 | $\frac{1}{{s}_{3}} [ \begin{matrix}1 & 0 & 0 \\ 0 & 1 & 0 \\ 0 & 0 & 1\end{matrix} ]$ | $\frac{1}{{s}_{3}} [ \begin{matrix}\frac{1}{x} & \frac{1}{x} & 0 \\ 0 & 0 & 1 \\ \frac{1}{x} & - \frac{1}{x} & 0\end{matrix} ]$ |

TABLE 53
Precoding matrix for three-layer transmission using three antenna ports

| TPMI index i | Precoding matrix W′ |
|---|---|
| 0 | $\frac{1}{{s}_{3}} [ \begin{matrix}1 & 0 & 0 \\ 0 & 1 & 0 \\ 0 & 0 & 1\end{matrix} ]$ |

In one example, a 3Tx precoder or precoding matrix is indicated via a TPMI field/index (I), whose payload (number of bits) depends on maxRank (which can be higher layer configured), as shown in Table 54, where X=2 for ExA and ExC, X=1 for ExB, and X=0 for ExD.

TABLE 54
TPMI payload, when codebookSubset = partialAndNonCoherent

| | | | | Payload |
|---|---|---|---|---|
| | | | Number of | (number |
| maxRank | From Table 35 | Index | TPMIs | of bits) |
| 1 | 1 layer, TPMI | 0-6 | 7 | 3 |
| | 0-6 | | | |
| 2 | 1 layer, TPMI | 0-6 | 14 | 4 |
| | 0-6 | | | |
| | 2 layer, TPMI | 7-13 | | |
| | 0-6 | | | |
| 3 | 1 layer, TPMI | 0-6 | 15 + X | 4 (when |
| | 0-6 | | | X = 0, 1) |
| | 2 layer, TPMI | 7-13 | | 5 (when |
| | 0-6 | | | X >= 2) |
| | 3 layer, TPMI | 14-(14 + X) | | |
| | 0-X | | | |

In one embodiment, a UE (e.g., the UE 116) can be configured (e.g. via higher layer) with an UL codebook for 3 antenna ports, including all of or a subset of 3Tx precoders described herein, according to at least one of the following examples.
In one example, the configured UL codebook for 3 antenna ports corresponds to only one N_{g} value.
   In one example, the one N_{g} value is fixed to N_{g}=1.
   In one example, the one N_{g} value is fixed to N_{g}=2.
   In one example, the one N_{g} value is fixed to N_{g}=3.
   In one example, the one N_{g} value is N_{g}=n, where n is configured (e.g. via higher layer). This configuration can be subject to a UE capability reporting. Hence, the configured n value belongs to a set of one or multiple values that the UE can support. The UE can be allowed to report one or more than one values of N_{g} (or n) via UE capability reporting.
In one example, the configured UL codebook for 3 antenna ports can correspond to two N_{g} values.
   In one example, the two N_{g} values are fixed to N_{g}=1,2.
   In one example, the two N_{g} values are fixed to N_{g}=1,3.
   In one example, the two N_{g} values are fixed to N_{g}=2,3.
   In one example, the two N_{g} values are (n₁, n₂), where (n₁, n₂) is configured (e.g. via higher layer). This configuration can be subject to a UE capability reporting. Hence, the configured (n₁, n₂) values belong to a set of multiple values that the UE can support. The UE can be allowed to report one or more than one values of N_{g} (or n) via UE capability reporting. The UE can report a set of values that the UE can support, and (n₁, n₂) can be any two values from the set. Or, the UE can report a set of values for (n₁, n₂).
In one example, the configured UL codebook for 3 antenna ports can correspond to one or two N_{g} values.
   In one example, when the one N_{g} value, the codebook is according to one of the examples described herein.
   In one example, when the two N_{g} values, the codebook is according to one of the examples described herein.
In one example, the configured UL codebook for 3 antenna ports can correspond to three N_{g} values.
   In one example, the three N_{g} values are fixed to N_{g}=1,2,3.
In one example, the configured UL codebook for 3 antenna ports can correspond to one or three N_{g} values.
   In one example, when the one N_{g} value, the codebook is according to one of the examples described herein.
   In one example, when the three N_{g} values, the codebook is according to one of the examples described herein.
In one example, the configured UL codebook for 3 antenna ports can correspond to two or three N_{g} values.
   In one example, when the two N_{g} values, the codebook is according to one of the examples described herein.
   In one example, when the three N_{g} values, the codebook is according to one of the examples described herein.
In one example, the configured UL codebook for 3 antenna ports can correspond to one, two, or three N_{g} values.
   In one example, when the one N_{g} value, the codebook is according to one of the examples described herein.
   In one example, when the two N_{g} values, the codebook is according to one of the examples described herein.
   In one example, when the three N_{g} values, the codebook is according to one of the examples described herein.

In one embodiment, the codebook for 3 antenna ports, as described in previous embodiment (or later embodiments), can also be used/configured (to a UE) for DL (e.g. for CSI/PMI reporting based on 3 CSI-RS antenna ports at NW/gNB), or sidelink (SL) (e.g. for CSI/PMI reporting based on 3 CSI-RS antenna ports at a SL UE/device). It can also be used to configure/trigger a CSI report for network energy saving (NES) applications wherein the NW/gNB may want to trigger (e.g. dynamically via MAC CE or DCI) a sub-configurations of the CSI report in which the number of CSI-RS ports is less than that at the NW/gNB. For instance, NW/gNB (e.g., the network 130/the BS 102) may trigger a CSI report for 3 CSI-RS ports that are a subset of >3 (e.g. 4, or 8) CSI-RS ports.

In one embodiment, the UL codebook includes FC precoders that are based on 4Tx precoders (Rel.15 UL 4Tx FC precoders, or Rel.15 DL Type I single panel codebook, 5.2.2.2.1, 38.214). For instance, one out of four rows of the 4Tx precoders can be muted (disabled, dropped, or removed) and the remaining 3 rows can be mapped to the three ports (rows) of the 3Tx precoders. Note that this can result in a non-constant modulus 3Tx precoders since the power of one port or layer can be different from the remaining two ports. In one example, the muted port is the fourth of the four ports. In one example, for rank>1, to achieve orthogonality across layers (columns of precoding matrices), at least one entry of 2^{nd} or/and 3^{rd} columns can be set to 0.

In one example, a rank 1 precoder is given by

$$\frac{1}{{s}_{1}} {p}_{1 , i} ,$$

where s₁ is a scaling factor. An example of one-layer (rank 1) FC precoders are shown in Table 55. The codebook includes all of or a subset of the precoders shown in the table.

TABLE 55
Example of one-layer FC precoders

| TPMI | Intermediate precoder matrix W′ | | | | | | | |
|---|---|---|---|---|---|---|---|---|
| index i | p_{1,0} | p_{1,1} | p_{1,2} | p_{1,3} | p_{1,4} | p_{1,5} | p_{1,6} | p_{1,7} |
| 0-7 | $[ \begin{matrix}1 \\ 1 \\ 1\end{matrix} ]$ | $[ \begin{matrix}1 \\ 1 \\ j\end{matrix} ]$ | $[ \begin{matrix}1 \\ 1 \\ - 1\end{matrix} ]$ | $[ \begin{matrix}1 \\ 1 \\ - j\end{matrix} ]$ | $[ \begin{matrix}1 \\ j \\ 1\end{matrix} ]$ | $[ \begin{matrix}1 \\ j \\ j\end{matrix} ]$ | $[ \begin{matrix}1 \\ j \\ - 1\end{matrix} ]$ | $[ \begin{matrix}1 \\ j \\ - j\end{matrix} ]$ |
| TPMI | | | | | | | | |
| index i | p_{1,8} | p_{1,9,} | p_{1,10} | p_{1,11} | p_{1,12} | p_{1,13} | p_{1,14} | p_{1,15} |
| 8-15 | $[ \begin{matrix}1 \\ - 1 \\ 1\end{matrix} ]$ | $[ \begin{matrix}1 \\ - 1 \\ j\end{matrix} ]$ | $[ \begin{matrix}1 \\ - 1 \\ - 1\end{matrix} ]$ | $[ \begin{matrix}1 \\ - 1 \\ - j\end{matrix} ]$ | $[ \begin{matrix}1 \\ - j \\ 1\end{matrix} ]$ | $[ \begin{matrix}1 \\ - j \\ j\end{matrix} ]$ | $[ \begin{matrix}1 \\ - j \\ - 1\end{matrix} ]$ | $[ \begin{matrix}1 \\ - j \\ - j\end{matrix} ]$ |

In one example, a rank 2 precoder is given by

$$\frac{1}{{s}_{2}} {p}_{2 , i} ,$$

where s₂ is a scaling factor. An example of two-layer (rank 2) FC precoders are shown in Table 56. The codebook includes all of or a subset of the precoders shown in the table.

TABLE 56
Example of two-layer FC precoders

| TPMI | Intermediate precoder matrix W′ | | | |
|---|---|---|---|---|
| index i | p_{2,0} | p_{2,1} | p_{2,2} | p_{2,3} |
| 0-3 | $[ \begin{matrix}1 & 1 \\ 1 & 0 \\ 1 & - 1\end{matrix} ]$ | $[ \begin{matrix}1 & 1 \\ 1 & 0 \\ j & - j\end{matrix} ]$ | $[ \begin{matrix}1 & 1 \\ j & 0 \\ 1 & - 1\end{matrix} ]$ | $[ \begin{matrix}1 & 1 \\ j & 0 \\ j & - j\end{matrix} ]$ |
| TPMI index i | p_{2,4} | p_{2,5} | p_{2,6} | p_{2,7} |
| 4-7 | $[ \begin{matrix}1 & 1 \\ - 1 & 0 \\ 1 & - 1\end{matrix} ]$ | $[ \begin{matrix}1 & 1 \\ - 1 & 0 \\ j & - j\end{matrix} ]$ | $[ \begin{matrix}1 & 1 \\ - j & 0 \\ 1 & - 1\end{matrix} ]$ | $[ \begin{matrix}1 & 1 \\ - j & 0 \\ j & - j\end{matrix} ]$ |

In one example, a rank 3 precoder is given by

$$\frac{1}{{s}_{3}} {p}_{3 , i} ,$$

where s₃ is a scaling factor. An example of three-layer (rank 3) FC precoders are shown in Table 57. The codebook includes all of or a subset of the precoders shown in the table.

TABLE 57
Example of three-layer FC precoders

| TPMI | Intermediate precoder matrix W′ | | | |
|---|---|---|---|---|
| index i | p_{3,0} | p_{3,1} | p_{3,2} | p_{3,3} |
| 0 - 3 | $[ \begin{matrix}1 & 1 & 0 \\ 1 & - 1 & 0 \\ 1 & 0 & - 1\end{matrix} ]$ | $[ \begin{matrix}1 & 1 & 0 \\ 1 & - 1 & 0 \\ j & 0 & - j\end{matrix} ]$ | $[ \begin{matrix}1 & 1 & 0 \\ - 1 & 1 & 0 \\ 1 & 0 & - 1\end{matrix} ]$ | $[ \begin{matrix}1 & 1 & 0 \\ - 1 & 1 & 0 \\ j & 0 & - j\end{matrix} ]$ |

In one embodiment, the codebook for 3 antenna ports, as described in previous embodiment (or later embodiments), can also be used/configured (to a UE) for DL (e.g. for CSI/PMI reporting based on 3 CSI-RS antenna ports at NW/gNB), or sidelink (SL) (e.g. for CSI/PMI reporting based on 3 CSI-RS antenna ports at a SL UE/device). It can also be used to configure/trigger a CSI report for network energy saving (NES) applications wherein the NW/gNB may want to trigger (e.g. dynamically via MAC CE or DCI) a sub-configuration of the CSI report in which the number of CSI-RS ports is less than that at the NW/gNB. For instance, NW/gNB may trigger a CSI report for 3 CSI-RS ports that are a subset of >3 (e.g. 4, or 8) CSI-RS ports.

There are two types of frequency range (FR) defined in 3GPP 5G NR specifications. The sub-6 GHz range is called frequency range 1 (FR1) and millimeter wave range is called frequency range 2 (FR2). An example of the frequency range for FR1 and FR2 is shown below Table 58. Whenever the FR2 is referred, both FR2-1 and FR2-2 frequency sub-ranges shall be provided, unless otherwise stated.

TABLE 58
Definition of frequency ranges

| | Frequency range | | |
|---|---|---|---|
| | designation | | Corresponding frequency range |
| FR1 | | | 410 MHz-7125 MHz |
| | FR2 | FR2-1 | 24250 MHz-52600 MHz |
| | | FR2-2 | 52600 MHz-71000 MHz |

In next generation cellular standards (e.g. 6G), in addition to FR1 and FR2, new carrier frequency bands can be provided, e.g. terahertz (>100 GHz) and FR3 or upper mid-band (7-24 GHz). The number of antenna ports that can be supported for these new bands is likely to be different from FR1 and FR2. In particular, for 7-15 GHz band, the max number of antenna ports is likely to be more than FR1, due to smaller antenna form factors, and feasibility of fully digital beamforming (as in FR1) at these frequencies. For instance, the number of CSI-RS antenna ports can grow up to 128. Besides, the NW deployment/topology at these frequencies is also expected to be denser/distributed, for example, antenna ports distributed at multiple (potentially non-co-located, hence geographically separated) TRPs or O-RUs within a cellular region can be the main scenario of interest, due to which the number of CSI-RS antenna ports for MIMO can be even larger (e.g. up to 256).

A (spatial or digital) precoding/beamforming can be used across these large number of antenna ports in order to achieve MIMO gains. Depending on the carrier frequency, and the feasibility of RF/HW-related components, the (spatial) precoding/beamforming can be fully digital or hybrid analog-digital. In fully digital beamforming, there can be one-to-one mapping between an antenna port and an antenna element, or a ‘static/fixed’ virtualization of multiple antenna elements to one antenna port can be used. Each antenna port can be digitally controlled. Hence, a spatial multiplexing across antenna ports is provided.

The 3GPP specification (such as 4G LTE and 5G NR) supports up to 32 CSI-RS antenna ports which enable an eNB (or gNB) to be equipped with a large number of antenna elements (such as 64 or 128). In this case, a plurality of antenna elements is mapped onto one CSI-RS port. For next generation cellular systems such as 6G, the maximum number of CSI-RS ports can either remain the same or increase (e.g. 128 or 256 ports in upper mid band, 7-24 GHz). For UL transmission, the 3GPP specification supports 1, 2, 4, or 8 SRS antenna ports in one SRS resource, where each SRS antenna port can be mapped to one or multiple antenna elements at the UE.

Likewise, for a cellular system operating in low carrier frequency in general, a sub-1 GHz frequency range (e.g. less than 1 GHz) as an example, supporting large number of CSI-RS antenna ports (e.g. 32) or many antenna elements at a single location or remote radio head (RRH) or TRP is challenging due to a larger antenna form factor size needed taking in to account carrier frequency wavelength than a system operating at a higher frequency such as 2 GHz or 4 GHz. One plausible way to operate a system with large number of CSI-RS antenna ports is to distribute the physical antenna ports to different panels/RRHs/TRPs, which can be non-collocated. The multiple sites or panels/RRHs/TRPs can still be connected to a single (common) base unit forming a single antenna system, hence the signal transmitted/received via multiple distributed RRHs/TRPs can still be processed at a centralized location.

As described herein, for low (FR1), high (FR2 and beyond), or mid (6-15 GHz) band, the NW topology/architecture is likely to be more and more distributed in future due to reasons explained herein (e.g. use cases, HW requirements, antenna form factors, mobility etc.). In this disclosure, such a distributed system is referred to as a DMIMO or multiple TRP (mTRP) system (multiple antenna port groups, which can be non-co-located). The transmission in such a system can be coherent joint transmission (CJT), i.e., a layer can be transmitted across/using multiple TRPs, or non-coherent joint transmission (NCJT). Due to distributed nature of operation, the groups of antenna ports (or TRPs) need to be calibrated/synchronized by compensating for the non-idealities such as time/frequency/phase offsets non-ideal backhaul across TRPs, due to HW impairments, different delay profiles, and Doppler profile (in high-speed scenarios) associated with different TRPs.

In one example, a TRP or RRH can be functionally equivalent to (hence can be replaced with) or is interchangeable with one of more of the following: an antenna, or an antenna group (multiple antennae), an antenna port, an antenna port group (multiple ports), a CSI-RS resource, multiple CSI-RS resources, a CSI-RS resource set, multiple CSI-RS resource sets, an antenna panel, multiple antenna panels, a Tx-Rx entity, a (analog) beam, a (analog) beam group, a cell, a cell group.

FIG. 7 illustrates example RAN configurations 700 according to embodiments of the present disclosure. For example, RAN configurations 700 can be implemented by the BS 102 of FIG. 1. This example is for illustration only and other embodiments can be used without departing from the scope of the present disclosure.

In an O-RAN NW architecture, a TRP can be functionally equivalent to (hence can be replaced with) or is interchangeable with one of more of the following:
One RU or O-RU: a logical node that includes a subset of the eNB/gNB functions (e.g. as listed in clause 4.2 split option 7-2x)
More than one RUs or O-RUs
One or more than one RUs or O-RUs

Two examples are shown in FIG. 7.

The following are defined in [REF11 and REF12].

| | |
|---|---|
| O-CU | O-RAN Central Unit - a logical node hosting PDCP, |
| | RRC, SDAP and other control functions |
| O-DU | O-RAN Distributed Unit: a logical node hosting RLC/ |
| | MAC/High-PHY layers based on a lower layer |
| | functional split. O-DU in addition hosts an M-Plane |
| | instance. |
| O-RU | O-RAN Radio Unit: a logical node hosting Low-PHY layer |
| | and RF processing based on a lower layer functional |
| | split. This is similar to 3GPP's “TRP” or “RRH” but |
| | more specific in including the Low-PHY layer (FFT/ |
| | iFFT, PRACH extraction). O-RU in addition hosts |
| | M-Plane instance. |

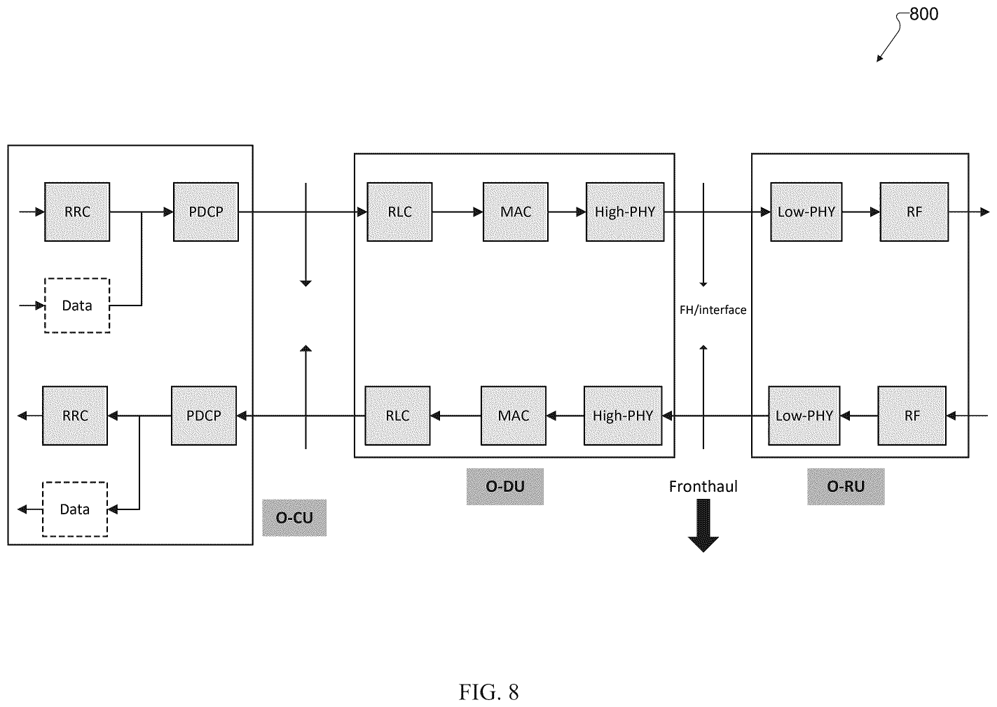

FIG. 8 illustrates example functional split points/options 800 according to embodiments of the present disclosure. For example, functional split points/options 800 may be implemented by the BS 102 of FIG. 1. This example is for illustration only and other embodiments can be used without departing from the scope of the present disclosure.

In next-gen MIMO systems (e.g. 6G), NW architecture as perceived in O-RAN needs to be taken into account as well. The functionality split among O-RAN entities for DL and UL operations, such as O-RU, O-DU, and O-CU (as described herein). An example is shown in FIG. 8. In particular, the PHY functionality split between O-DU and O-RU includes at least the following aspects.
(B1) PHY processing:
   bit-level processing,
   symbol-level processing
(B2) Scheduling (residing in MAC): single user (SU)-MIMO/multi user (MU)-MIMO scheduling across different O-RUs or/and allocated frequency-domain resources (e.g. physical resource blocks (PRBs), precoding resource block groups (PRGs), SBs)
   Utilizing uplink control information (UCI) carrying CSI
   If DL/UL reciprocity is feasible, also utilizing SRS-based channel measurement
(B3) Precoder calculation at a gNB (NW side) for DL-SCH transmission:
   For SU-MIMO, precoder can simply follow the PMI (calculated expecting SU-MIMO hypothesis) reported by the UE, or, if DL/UL reciprocity is feasible, be calculated from the eigenvector(s) of the measured DL channels.
   For MU-MIMO, precoder needs to be calculated based on additional orthogonalization (e.g. zero-forcing beamforming (ZFBF), signal-to-leakage-and-noise-ratio (SLNR)) among PMIs, or, if DL/UL reciprocity is feasible, the eigenvectors of the measured channels of the co-scheduled UEs

While the O-RAN Alliance is intended for 5G NR, it is expected that its framework will continue, or at most refined, for 6G. The O-RAN Alliance specifies 3 levels of functional splits—namely CU, DU, and RU—to facilitate multi-vendor inter-operability within a NW. The manner in which PHY-layer functions are split between DU and RU(s) imposes serious impact on the feasibility, performance, and complexity of different MIMO schemes—mainly due to the latency and quantization loss incurred by the O-RAN-standardized RU-DU interface.

The present disclosure relates generally to wireless communication systems and, more specifically, to UL transmission based on a codebook.

In 5G NR, for codebook-based transmission, the precoding matrix W for 4 antenna ports is given Table 59-Table 62.

TABLE 59
Precoding matrix W for single-layer transmission using four antenna ports

| TPMI | W | | | | | | | |
|---|---|---|---|---|---|---|---|---|
| index | (ordered from left to right in increasing order of TPMI index) | | | | | | | |
| 0-7 | $\frac{1}{2} [ \begin{matrix}1 \\ 0 \\ 0 \\ 0\end{matrix} ]$ | $\frac{1}{2} [ \begin{matrix}0 \\ 1 \\ 0 \\ 0\end{matrix} ]$ | $\frac{1}{2} [ \begin{matrix}0 \\ 0 \\ 1 \\ 0\end{matrix} ]$ | $\frac{1}{2} [ \begin{matrix}0 \\ 0 \\ 0 \\ 1\end{matrix} ]$ | $\frac{1}{2} [ \begin{matrix}1 \\ 0 \\ 1 \\ 0\end{matrix} ]$ | $\frac{1}{2} [ \begin{matrix}1 \\ 0 \\ - 1 \\ 0\end{matrix} ]$ | $\frac{1}{2} [ \begin{matrix}1 \\ 0 \\ j \\ 0\end{matrix} ]$ | $\frac{1}{2} [ \begin{matrix}1 \\ 0 \\ - j \\ 0\end{matrix} ]$ |
| 8-15 | $\frac{1}{2} [ \begin{matrix}0 \\ 1 \\ 0 \\ 1\end{matrix} ]$ | $\frac{1}{2} [ \begin{matrix}0 \\ 1 \\ 0 \\ - 1\end{matrix} ]$ | $\frac{1}{2} [ \begin{matrix}0 \\ 1 \\ 0 \\ j\end{matrix} ]$ | $\frac{1}{2} [ \begin{matrix}0 \\ 1 \\ 0 \\ - j\end{matrix} ]$ | $\frac{1}{2} [ \begin{matrix}1 \\ 1 \\ 1 \\ 1\end{matrix} ]$ | $\frac{1}{2} [ \begin{matrix}1 \\ 1 \\ j \\ j\end{matrix} ]$ | $\frac{1}{2} [ \begin{matrix}1 \\ 1 \\ - 1 \\ - 1\end{matrix} ]$ | $\frac{1}{2} [ \begin{matrix}1 \\ 1 \\ - j \\ - j\end{matrix} ]$ |
| 16-23 | $\frac{1}{2} [ \begin{matrix}1 \\ j \\ 1 \\ j\end{matrix} ]$ | $\frac{1}{2} [ \begin{matrix}1 \\ j \\ j \\ - 1\end{matrix} ]$ | $\frac{1}{2} [ \begin{matrix}1 \\ j \\ - 1 \\ - j\end{matrix} ]$ | $\frac{1}{2} [ \begin{matrix}1 \\ j \\ - j \\ 1\end{matrix} ]$ | $\frac{1}{2} [ \begin{matrix}1 \\ - 1 \\ 1 \\ - 1\end{matrix} ]$ | $\frac{1}{2} [ \begin{matrix}1 \\ - 1 \\ j \\ - j\end{matrix} ]$ | $\frac{1}{2} [ \begin{matrix}1 \\ - 1 \\ - 1 \\ 1\end{matrix} ]$ | $\frac{1}{2} [ \begin{matrix}1 \\ - 1 \\ - j \\ j\end{matrix} ]$ |
| 24-27 | $\frac{1}{2} [ \begin{matrix}1 \\ - j \\ 1 \\ - j\end{matrix} ]$ | $\frac{1}{2} [ \begin{matrix}1 \\ - j \\ j \\ 1\end{matrix} ]$ | $\frac{1}{2} [ \begin{matrix}1 \\ - j \\ - 1 \\ j\end{matrix} ]$ | $\frac{1}{2} [ \begin{matrix}1 \\ - j \\ - j \\ - 1\end{matrix} ]$ | — | — | — | — |

TABLE 60
Precoding matrix W for two-layer transmission using four antenna ports

| TPMI | W | | | |
|---|---|---|---|---|
| index | (ordered from left to right in increasing order of TPMI index) | | | |
| 0-3 | $\frac{1}{2} [ \begin{matrix}1 & 0 \\ 0 & 1 \\ 0 & 0 \\ 0 & 0\end{matrix} ]$ | $\frac{1}{2} [ \begin{matrix}1 & 0 \\ 0 & 0 \\ 0 & 1 \\ 0 & 0\end{matrix} ]$ | $\frac{1}{2} [ \begin{matrix}1 & 0 \\ 0 & 0 \\ 0 & 0 \\ 0 & 1\end{matrix} ]$ | $\frac{1}{2} [ \begin{matrix}0 & 0 \\ 1 & 0 \\ 0 & 1 \\ 0 & 0\end{matrix} ]$ |
| 4-7 | $\frac{1}{2} [ \begin{matrix}0 & 0 \\ 1 & 0 \\ 0 & 0 \\ 0 & 1\end{matrix} ]$ | $\frac{1}{2} [ \begin{matrix}0 & 0 \\ 0 & 0 \\ 1 & 0 \\ 0 & 1\end{matrix} ]$ | $\frac{1}{2} [ \begin{matrix}1 & 0 \\ 0 & 1 \\ 1 & 0 \\ 0 & - j\end{matrix} ]$ | $\frac{1}{2} [ \begin{matrix}1 & 0 \\ 0 & 1 \\ 1 & 0 \\ 0 & j\end{matrix} ]$ |
| 8-11 | $\frac{1}{2} [ \begin{matrix}1 & 0 \\ 0 & 1 \\ - j & 0 \\ 0 & 1\end{matrix} ]$ | $\frac{1}{2} [ \begin{matrix}1 & 0 \\ 0 & 1 \\ - j & 0 \\ 0 & - 1\end{matrix} ]$ | $\frac{1}{2} [ \begin{matrix}1 & 0 \\ 0 & 1 \\ - 1 & 0 \\ 0 & - j\end{matrix} ]$ | $\frac{1}{2} [ \begin{matrix}1 & 0 \\ 0 & 1 \\ - 1 & 0 \\ 0 & j\end{matrix} ]$ |
| 12-15 | $\frac{1}{2} [ \begin{matrix}1 & 0 \\ 0 & 1 \\ j & 0 \\ 0 & 1\end{matrix} ]$ | $\frac{1}{2} [ \begin{matrix}1 & 0 \\ 0 & 1 \\ j & 0 \\ 0 & - 1\end{matrix} ]$ | $\frac{1}{2 \sqrt{2}} [ \begin{matrix}1 & 1 \\ 1 & 1 \\ 1 & - 1 \\ 1 & - 1\end{matrix} ]$ | $\frac{1}{2 \sqrt{2}} [ \begin{matrix}1 & 1 \\ 1 & 1 \\ j & - j \\ j & - j\end{matrix} ]$ |
| 16-19 | $\frac{1}{2 \sqrt{2}} [ \begin{matrix}1 & 1 \\ j & j \\ 1 & - 1 \\ j & - j\end{matrix} ]$ | $\frac{1}{2 \sqrt{2}} [ \begin{matrix}1 & 1 \\ j & j \\ j & - j \\ - 1 & 1\end{matrix} ]$ | $\frac{1}{2 \sqrt{2}} [ \begin{matrix}1 & 1 \\ - 1 & - 1 \\ 1 & - 1 \\ - 1 & 1\end{matrix} ]$ | $\frac{1}{2 \sqrt{2}} [ \begin{matrix}1 & 1 \\ - 1 & - 1 \\ j & - j \\ - j & j\end{matrix} ]$ |
| 20-21 | $\frac{1}{2 \sqrt{2}} [ \begin{matrix}1 & 1 \\ - j & - j \\ 1 & - 1 \\ - j & j\end{matrix} ]$ | $\frac{1}{2 \sqrt{2}} [ \begin{matrix}1 & 1 \\ - j & - j \\ j & - j \\ 1 & - 1\end{matrix} ]$ | — | — |

TABLE 61
Precoding matrix W for three-layer transmission using four antenna ports

| TPMI | W | | | |
|---|---|---|---|---|
| index | (ordered from left to right in increasing order of TPMI index) | | | |
| 0-3 | $\frac{1}{2} [ \begin{matrix}1 & 0 & 0 \\ 0 & 1 & 0 \\ 0 & 0 & 1 \\ 0 & 0 & 0\end{matrix} ]$ | $\frac{1}{2} [ \begin{matrix}1 & 0 & 0 \\ 0 & 1 & 0 \\ 1 & 0 & 0 \\ 0 & 0 & 1\end{matrix} ]$ | $\frac{1}{2} [ \begin{matrix}1 & 0 & 0 \\ 0 & 1 & 0 \\ - 1 & 0 & 0 \\ 0 & 0 & 1\end{matrix} ]$ | $\frac{1}{2 \sqrt{3}} [ \begin{matrix}1 & 1 & 1 \\ 1 & - 1 & 1 \\ 1 & 1 & - 1 \\ 1 & - 1 & - 1\end{matrix} ]$ |
| 4-6 | $\frac{1}{2 \sqrt{3}} [ \begin{matrix}1 & 1 & 1 \\ 1 & - 1 & 1 \\ j & j & - j \\ j & - j & - j\end{matrix} ]$ | $\frac{1}{2 \sqrt{3}} [ \begin{matrix}1 & 1 & 1 \\ - 1 & 1 & - 1 \\ 1 & 1 & - 1 \\ - 1 & 1 & 1\end{matrix} ]$ | $\frac{1}{2 \sqrt{3}} [ \begin{matrix}1 & 1 & 1 \\ - 1 & 1 & - 1 \\ j & j & - j \\ - j & j & j\end{matrix} ]$ | — |

TABLE 62
Precoding matrix W for four-layer transmission using four antenna ports

| TPMI | W | | | |
|---|---|---|---|---|
| index | (ordered from left to right in increasing order of TPMI index) | | | |
| 0-3 | $\frac{1}{2} [ \begin{matrix}1 & 0 & 0 & 0 \\ 0 & 1 & 0 & 0 \\ 0 & 0 & 1 & 0 \\ 0 & 0 & 0 & 1\end{matrix} ]$ | $\frac{1}{2 \sqrt{2}} [ \begin{matrix}1 & 1 & 0 & 0 \\ 0 & 0 & 1 & 1 \\ 1 & - 1 & 0 & 0 \\ 0 & 0 & 1 & - 1\end{matrix} ]$ | $\frac{1}{2 \sqrt{2}} [ \begin{matrix}1 & 1 & 0 & 0 \\ 0 & 0 & 1 & 1 \\ j & - j & 0 & 0 \\ 0 & 0 & j & - j\end{matrix} ]$ | $\frac{1}{4} [ \begin{matrix}1 & 1 & 1 & 1 \\ 1 & - 1 & 1 & - 1 \\ 1 & 1 & - 1 & - 1 \\ 1 & - 1 & - 1 & 1\end{matrix} ]$ |
| 4 | $\frac{1}{4} [ \begin{matrix}1 & 1 & 1 & 1 \\ 1 & - 1 & 1 & - 1 \\ j & j & - j & - j \\ j & - j & - j & j\end{matrix} ]$ | — | — | — |

In codebook-based transmission, an UL grant includes a single transmit PMI (TPMI) field which indicates the single precoding vector or matrix (from a predefined codebook) a UE shall use for the scheduled UL transmission. When multiple PRBs are allocated to the UE, a single precoding vector/matrix indicated by the TPMI field implies that wideband UL precoding is utilized. In UL codebook, pre-coders with antenna selection (aka non-coherent precoders) have been supported in order to keep peak-to-average power ratio (PAPR) low and cubic-metric (CM) for rank>1 small. Antenna selection offers performance improvement in some scenarios. Besides, for 4 and 8 antenna ports, partial-coherent precoders based on selection of a subset of ports (2 or 4 ports) are also supported. In the rest of the disclosure, the term ‘coherence’ implies all or a subset of antenna ports that can be used to transmit a layer coherently. In particular,
the term ‘full-coherence’ (FC) implies antenna ports that can be used to transmit a layer coherently.
the term ‘partial-coherence’ (PC) implies a subset (at least two but less than all) of antenna ports that can be used to transmit a layer coherently.
the term ‘non-coherence’ (NC) implies only one antenna port that can be used to transmit a layer.

In 4G LTE, the HH codebook for 4 antenna ports is based on the quantity

$${W}_{n}^{\{ s \}}$$

denoting the matrix defined by the columns given by the set {S} from the expression

$${W}_{n} = I - 2 {u}_{n} {u}_{n}^{H} / {u}_{n}^{H} {u}_{n}$$

where l is the 4×4 identity matrix and the vector uₙ is given by Table 63.

TABLE 63
Householder codebook

| Codebook | | Number of layers υ | | | |
|---|---|---|---|---|---|
| index | uₙ | 1 | 2 | 3 | 4 |
| 0 | u₀ = [1 −1 −1 −1]^{T} | ${W}_{0}^{\{ 1 \}}$ | ${W}_{0}^{\{ 14 \}} / \sqrt{2}$ | ${W}_{0}^{\{ 124 \}} / \sqrt{3}$ | ${W}_{0}^{\{ 1234 \}} / 2$ |
| 1 | u₁ = [1 −j 1 j]^{T} | ${W}_{1}^{\{ 1 \}}$ | ${W}_{1}^{\{ 12 \}} / \sqrt{2}$ | ${W}_{1}^{\{ 123 \}} / \sqrt{3}$ | ${W}_{1}^{\{ 1234 \}} / 2$ |
| 2 | u₂ = [1 1 −1 1]^{T} | ${W}_{2}^{\{ 1 \}}$ | ${W}_{2}^{\{ 12 \}} / \sqrt{2}$ | ${W}_{2}^{\{ 123 \}} / \sqrt{3}$ | ${W}_{2}^{\{ 1234 \}} / 2$ |
| 3 | u₃ = [1 j 1 −j]^{T} | ${W}_{3}^{\{ 1 \}}$ | ${W}_{3}^{\{ 12 \}} / \sqrt{2}$ | ${W}_{3}^{\{ 123 \}} / \sqrt{3}$ | ${W}_{3}^{\{ 3214 \}} / 2$ |
| 4 | u₄ = [1 (−1 − j)/\sqrt{2} −j (1− j)/\sqrt{2}]^{T} | ${W}_{4}^{\{ 1 \}}$ | ${W}_{4}^{\{ 14 \}} / \sqrt{2}$ | ${W}_{4}^{\{ 124 \}} / \sqrt{3}$ | ${W}_{4}^{\{ 1234 \}} / 2$ |
| 5 | u₅ = [1 (1− j)/\sqrt{2} j (−1 − j)/\sqrt{2}]^{T} | ${W}_{5}^{\{ 1 \}}$ | ${W}_{5}^{\{ 14 \}} / \sqrt{2}$ | ${W}_{5}^{\{ 124 \}} / \sqrt{3}$ | ${W}_{5}^{\{ 1234 \}} / 2$ |
| 6 | u₆ = [1 (1+ j)/\sqrt{2} −j (−1 + j)/\sqrt{2}]^{T} | ${W}_{6}^{\{ 1 \}}$ | ${W}_{6}^{\{ 13 \}} / \sqrt{2}$ | ${W}_{6}^{\{ 134 \}} / \sqrt{3}$ | ${W}_{6}^{\{ 1324 \}} / 2$ |
| 7 | u₇ = [1 (−1 + j)/\sqrt{2} j (1 + j)/\sqrt{2}]^{T} | ${W}_{7}^{\{ 1 \}}$ | ${W}_{7}^{\{ 13 \}} / \sqrt{2}$ | ${W}_{7}^{\{ 134 \}} / \sqrt{3}$ | ${W}_{7}^{\{ 1324 \}} / \sqrt{2}$ |
| 8 | u₈ = [1 −1 1 1]^{T} | ${W}_{8}^{\{ 1 \}}$ | ${W}_{8}^{\{ 12 \}} / \sqrt{2}$ | ${W}_{8}^{\{ 124 \}} / \sqrt{3}$ | ${W}_{8}^{\{ 1234 \}} / \sqrt{2}$ |
| 9 | u₉ = [1 −j −1 −j]^{T} | ${W}_{9}^{\{ 1 \}}$ | ${W}_{9}^{\{ 14 \}} / \sqrt{2}$ | ${W}_{9}^{\{ 134 \}} / \sqrt{3}$ | ${W}_{9}^{\{ 1234 \}} / \sqrt{2}$ |
| 10 | u₁₀ = [1 1 1 −1]^{T} | ${W}_{10}^{\{ 1 \}}$ | ${W}_{10}^{\{ 13 \}} / \sqrt{2}$ | ${W}_{10}^{\{ 123 \}} / \sqrt{3}$ | ${W}_{10}^{\{ 1324 \}} / \sqrt{2}$ |
| 11 | u₁₁ = [1 j −1 j]^{T} | ${W}_{11}^{\{ 1 \}}$ | ${W}_{11}^{\{ 13 \}} / \sqrt{2}$ | ${W}_{11}^{\{ 134 \}} / \sqrt{3}$ | ${W}_{11}^{\{ 1324 \}} / 2$ |
| 12 | u₁₂ = [1 −1 −1 1]^{T} | ${W}_{12}^{\{ 1 \}}$ | ${W}_{12}^{\{ 12 \}} / \sqrt{2}$ | ${W}_{12}^{\{ 123 \}} / \sqrt{3}$ | ${W}_{12}^{\{ 1234 \}} / 2$ |
| 13 | u₁₃ = [1 −1 1 −1]^{T} | ${W}_{13}^{\{ 1 \}}$ | ${W}_{13}^{\{ 13 \}} / \sqrt{2}$ | ${W}_{13}^{\{ 123 \}} / \sqrt{3}$ | ${W}_{13}^{\{ 1324 \}} / 2$ |
| 14 | u₁₄ = [1 1 −1 −1]^{T} | ${W}_{14}^{\{ 1 \}}$ | ${W}_{14}^{\{ 13 \}} / \sqrt{2}$ | ${W}_{14}^{\{ 123 \}} / \sqrt{3}$ | ${W}_{14}^{\{ 3214 \}} / 2$ |
| 15 | u₁₅ = [1 1 1 1]^{T} | ${W}_{15}^{\{ 1 \}}$ | ${W}_{15}^{\{ 12 \}} / \sqrt{2}$ | ${W}_{15}^{\{ 123 \}} / \sqrt{3}$ | ${W}_{15}^{\{ 1234 \}} / 2$ |

Taking into account different antenna geometries/structures, form factors, and device types, a robust codebook design framework is provided. Embodiments of the present disclosure recognizes that the codebook framework that can be based on an ‘unstructured basis’ (as opposed to the structured DFT basis in LTE/NRcodebooks) is needed. Here, the term ‘basis’ refers to a set of vectors, each length P, that can represent eigenmodes of the channel measured via P ports, regardless of or agnostic to any assumptions on antenna structure. One such framework can be based on a Householder (HH) transform. This is the focus of this disclosure.

The present disclosure relates to a robust codebook design based on a transform, e.g. Householder (HH).
A framework of a robust HH codebook design depending on antenna structure
Several examples, especially for UL
Signaling

In the following, for brevity, both FDD and TDD are regarded as the duplex method for both DL and UL signaling.

Although exemplary descriptions and embodiments to follow expect orthogonal frequency division multiplexing (OFDM) or orthogonal frequency division multiple access (OFDMA), this disclosure can be extended to other OFDM-based transmission waveforms or multiple access schemes such as filtered OFDM (F-OFDM).

This disclosure covers several components which can be used in conjunction or in combination with one another, or can operate as standalone schemes.

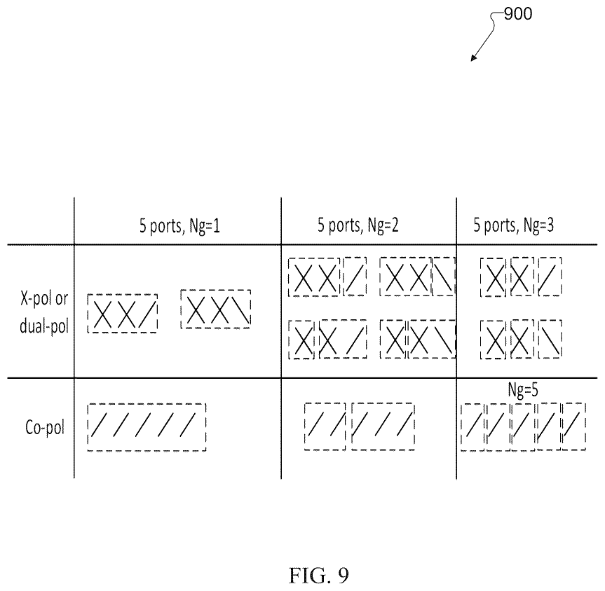

FIG. 9 illustrates example antenna port layouts 900 according to embodiments of the present disclosure. For example, antenna port layouts 900 can be implemented in any of the UEs 111-116 of FIG. 1, such as the UE 112. This example is for illustration only and other embodiments can be used without departing from the scope of the present disclosure.

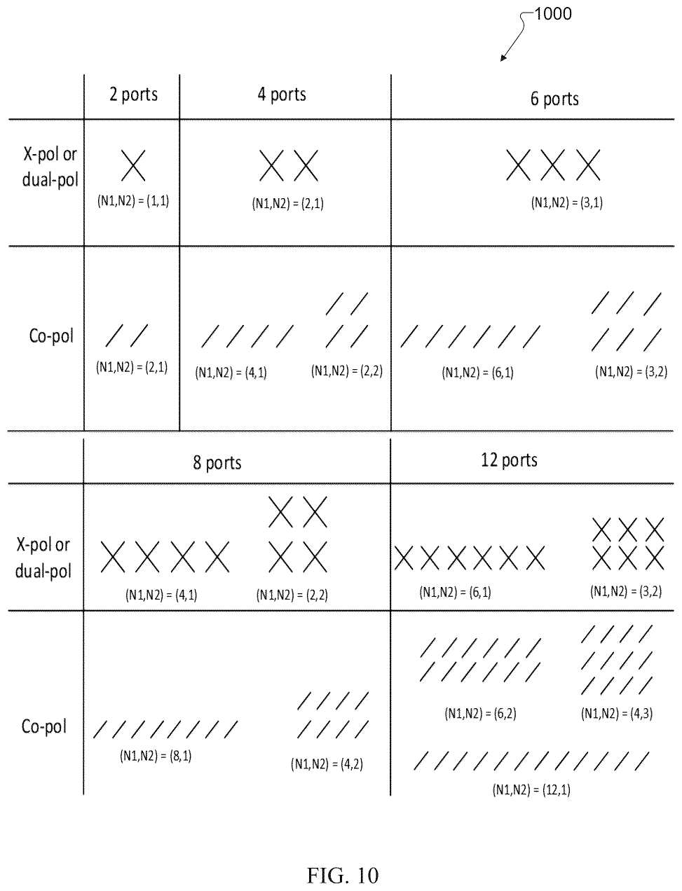

FIG. 10 illustrates example antenna port layouts 1000 according to embodiments of the present disclosure. For example, antenna port layouts 1000 can be implemented in the UE 116 of FIG. 3. This example is for illustration only and other embodiments can be used without departing from the scope of the present disclosure.

Antenna ports of a device (e.g. UE or gNB) can belong to a single antenna panel or group (i.e., they are co-located, for example, at one plane, side, or edge of the device) or multiple antenna panels or groups. For a given antenna panel or group, N₁ and N₂ are the number of antenna ports with the same polarization in the first and second dimensions, respectively. For 2D antenna port layouts, N₁>1, N₂>1, and for 1D antenna port layouts, either N₁>1 and N₂=1 or N₂>1 and N₁=1. In the rest of the disclosure, 1D antenna port layouts with N₁>1 and N₂=1 is provided. The disclosure, however, is applicable to the other 1D port layouts with N₂>1 and N₁=1. Also, in the rest of the disclosure, N₁>N₂. The disclosure, however, is applicable to the case when N₁<N₂, and the embodiments for N₁>N₂ applies to the case N₁<N₂ by swapping/switching (N₁, N₂) with (N₂, N₁). For a given antenna panel or group, when a (single-polarized) co-polarized antenna port layout, the total number of antenna ports is P=N₁N₂ and when a dual-polarized antenna port layout, the total number of antenna ports is P=2N₁N₂. When P=3 or 5 antenna ports, an illustration of antenna port layouts is shown in FIG. 6 and FIG. 9. An illustration of antenna port layouts for {2, 4, 6, 8, 12} antenna ports is shown in FIG. 10.

When the device is a UE, the codebook can be used for TPMI-based precoding of UL transmission. When the device is a gNB (e.g., the BS 102), the codebook can be used for PMI-based precoding of DL transmission.

Let N_{g} be the number of antenna port groups (panels). For a co-polarized (single polarized) case,
N_{g}=1: one group comprising antenna ports,
N_{g}=2: two groups, one comprising P₁ antenna ports, and another comprising P₂=P−P₁ antenna ports, and
N_{g}=P: P groups, each comprising 1 antenna port.

For a dual-polarized (cross-polarized) case,
N_{g}=1: one group comprising

$$X = ⌊ \frac{P}{2} ⌋$$

cross-pol antenna ports, and P−X single-pol antenna port(s).
N_{g}=2: two groups, one comprising

$${P}_{1} = a ⌊ \frac{P}{2} ⌋$$

cross-pol antenna ports where α∈{1,2, . . . } and another comprising P₂=P−P₁ single-pol antenna port.

Let s denotes the number of antenna polarizations (or groups of antenna ports with the same polarization). Then, for co-polarized antenna ports, s=1, and for dual- or cross (X)-polarized antenna ports s=2. So, the total number of antenna ports P=sN₁N₂. In one example, the antenna ports at the UE (e.g., the UE 116) refers to SRS antenna ports (either in one SRS resource or across multiple SRS resources).

The codebook W for P antenna ports at the device is based on pre-coding vectors which are according to one of the three examples in Table 64 depending on whether the antenna ports are co-polarized or a combination of co-polarized and cross-/dual-polarized.
Ex1A: corresponds to N_{g}=1 with co-polarized ports.
Ex1B: corresponds to N_{g}=1 with dual-polarized ports.
Ex2: corresponds to N_{g}=2, 1D antenna layout, P=Pₓ+Pₑ, with Pₓ cross-pol ports and Pₑ, co-polarized ports.
Ex3: corresponds to N_{g}=2, 2D antenna layout, Pₓ=2N_{x,1}N_{x,2} and P_{co}=N_{co,1}N_{co,2} with Pₓ cross-pol ports and P_{co} co-polarized ports.

TABLE 64
Pre-coding vectors

| | | P is odd | |
|---|---|---|---|
| Ex1A: | | Ex2: Co-pol + | Ex3: Co-pol + |
| Co-pol | Ex1B: Dual-pol | Dual-pol (1D) | Dual-pol (2D) |
| $W = \frac{{w}_{l}}{\sqrt{P}}$ | $W = \frac{1}{\sqrt{P}} {w}_{cross - pol}$ | $W = \frac{1}{\sqrt{P}} [ \begin{matrix}{w}_{cross - pol} \\ {w}_{co - pol}\end{matrix} ] or$ | $W = \frac{1}{\sqrt{P}} [ \begin{matrix}{w}_{cross - pol} \\ {w}_{co - pol}\end{matrix} ] or$ |
| | ${w}_{cross - pol} = {v}_{l , n} = [ \begin{matrix}{w}_{l} \\ {φ}_{n} {w}_{l}\end{matrix} ] or$ | $\frac{1}{\sqrt{P}} [ \begin{matrix}{w}_{co - pol} \\ {w}_{cross - pol}\end{matrix} ]$ | $\frac{1}{\sqrt{P}} [ \begin{matrix}{w}_{co - pol} \\ {w}_{cross - pol}\end{matrix} ]$ |
| | ${w}_{cross - pol} = {v}_{l , m , n} = [ \begin{matrix}{v}_{l , m} \\ {φ}_{n} {v}_{l , m}\end{matrix} ]$ | ${w}_{cross - pol} = {v}_{{l}_{1} , n} = [ \begin{matrix}{w}_{{l}_{1}} \\ {φ}_{n} {w}_{{l}_{1}}\end{matrix} ]$ | ${w}_{cross - pol} = {v}_{{l}_{1} , m , n} = [ \begin{matrix}{v}_{{l}_{1} , m} \\ {φ}_{n} {v}_{{l}_{1} , m}\end{matrix} ]$ |
| | | w_{co-pol} = wₗ_{₂} | w_{co-pol} = νₗ_{₂}_{,m}_{₂} |

Here, ν_{l,m} is a Kronecker product (└) of vectors wₗ and uₘ of lengths N₁ and N₂, respectively. In one example, wₗ and Urn, are oversampled DFT vectors, i.e.,

$$\begin{matrix}{w}_{l} = [ \begin{matrix}1 & {e}^{j \frac{2 π l}{{O}_{1} {N}_{1}}} & {e}^{j \frac{4 π l}{{O}_{1} {N}_{1}}} & … & {{e}^{j \frac{2 π l ( {N}_{1} - 1 )}{{O}_{1} {N}_{1}}} ]}^{T}\end{matrix} \\ {u}_{m} = \{ \begin{matrix}[ \begin{matrix}1 & {e}^{j \frac{2 π m}{{O}_{2} {N}_{2}}} & … & {e}^{j \frac{2 π m ( {N}_{2} - 1 )}{{O}_{2} {N}_{2}}}\end{matrix} ] & {N}_{2} > 1 \\ 1 & {N}_{2} = 1\end{matrix}\end{matrix}$$

where O₁ and O₂ are oversampling factors in two dimensions, and ν_{l,m} is then given by

$${v}_{l , m} = {w}_{l} ⊗ {u}_{m} = [ \begin{matrix}{u}_{m} & {e}^{j \frac{2 π l}{{O}_{1} {N}_{1}}} {u}_{m} & … & {{e}^{j \frac{2 π l ( {N}_{1} - 1 )}{{O}_{1} {N}_{1}}} {u}_{m} ]}^{T}\end{matrix}$$

In one example, both O₁, O₂∈{1,2,4,8}. In one example, O₁ and O₂ can take the same values as Rel.15 NR Type I codebook (cf. 5.2.2.2.1, [REF 16]), i.e., (O₁, O₂)=(4,4) when N₂>1, and, i.e., (O₁, O₂)=(4,1) when N₂=1. Alternatively, they take different values from the Rel. 15 Type I NR codebook, for example, (O₁, O₂)=(2,2) when N₂>1, and, i.e., (O₁, O₂)=(2,1) when N₂=1. In one example, O₁ and O₂ is configurable (e.g. via higher layer). In one example, (O₁, O₂)=(1,1).

The quantity φₙ is a co-phase for dual-polarized antenna port layouts. In one example, φₙ=e^{jπn/2}, where n∈{0,1,2,3} implying that φₙ belongs to QPSK alphabet {1,j, −1, −j}. In one example, φₙ e^{j2πn/Z}, where n∈{0,1,2, . . . Z−1} implying that φₙ belongs to Z-PSK alphabet. In one example, Z belong to a set including {2,4,8,16}.

In one example, the values of N₁ and N₂ are configured, e.g. with the higher layer parameter. A few examples of (N₁, N₂) for a given number of antenna ports (P) and antenna layout (co-pol or/and cross-pol) is given in Table 65. The notation N_{a,b} where α∈{co, x} and b∈{1,2} is used to denote a number of a-polarized antenna ports in the b-th dimension, respectively.

TABLE 65
Configurations of (N₁, N₂)

| Number of | | | Co-Pol + Dual-pol |
|---|---|---|---|
| antenna | Co-pol | Dual-pol | {(N_{co, 1}, N_{co, 2}), |
| ports, P | (N_{co, 1}, N_{co, 2}) | (N_{x, 1}, N_{x, 2}) | (N_{x, 1}, N_{x, 2})} |
| 1 | (1, 1) | | |
| 2 | (2, 1), (1, 2) | (1, 1) | |
| 3 | (3, 1), (1, 3) | | {(1, 1), (1, 1)} |
| 4 | (4, 1), (1, 4), | (2, 1) | {(2, 1), (1, 1)} |
| | (2, 2) | | {(1, 2), (1, 1)} |
| 5 | (5, 1), (1, 5) | | {(3, 1), (1, 1)} |
| | | | {(1, 3), (1, 1)} |
| | | | {(1, 1), (2, 1)} |
| 6 | (2, 3), (3, 2), | (3, 1) | {(4, 1), (1, 1)} |
| | (6, 1), (1, 6) | | {(1, 4), (1, 1)} |
| | | | {(2, 2), (1, 1)} |
| | | | {(2, 1), (2, 1)} |
| | | | {(1, 2), (2, 1)} |
| 7 | (7, 1), (1, 7) | | {(5, 1), (1, 1)} |
| | | | {(1, 5), (1, 1)} |
| | | | {(3, 1), (2, 1)} |
| | | | {(1, 3), (2, 1)} |
| | | | {(1, 1), (3, 1)} |
| 8 | (8, 1), (1, 8), | (2, 2), (4, 1) | |
| | (4, 2), (2, 4) | | |
| 12 | (3, 2), (6, 1) | (4, 3), (6, 2), | |
| | | (12, 1) | |
| 16 | (4, 2), (8, 1) | (8, 2), (4, 4), | |
| | | (16, 1) | |

In one example, the values of N₁ and N₂ are fixed for a given number of antenna ports. For example, (N₁, N₂)=(P, 1) for co-pol and

$$( \frac{P}{2} , 1 )$$

for dual-pol antenna. In one example, only one (N₁, N₂) is supported for each value of P, where the supported (N₁, N₂) is one of pairs in Table 65.

In one example, P antenna ports can be divided into N_{g}∈{1,2, . . . } groups. In one example, each group corresponds to an antenna panel.

In one example, N_{g}=1 corresponds to a single antenna panel. In one example, N_{g}=1 corresponds to a full coherent (FC) UE or FC antenna layout.

In one example, when number of ports in a group is more than one and N_{g}>1, then ports within each group are coherent, whereas ports across two groups are non-coherent (NC). Such antenna port layout can be referred to as a partial coherent (PC) UE or PC antenna layout.

In one example, N_{g}=P corresponds to a non-coherent (NC) UE or NC antenna layout.

In one embodiment, the codebook for P antenna ports, as described in this disclosure, can also be used/configured (to a UE) for DL (e.g. for CSI/PMI reporting based on P CSI-RS antenna ports at NW/gNB), or sidelink (SL) (e.g. for CSI/PMI reporting based on P CSI-RS antenna ports at a SL UE/device). It can also be used to configure/trigger a CSI report for network energy saving (NES) applications wherein the NW/gNB may want to trigger (e.g. dynamically via MAC CE or DCI) a sub-configuration of the CSI report in which the number of CSI-RS ports is less than that at the NW/gNB. For instance, NW/gNB may trigger a CSI report for P CSI-RS ports that are a subset of >P CSI-RS ports.

In one example, the rank 1 TPMI (and precoder) can be configured to a UE for both cases when transform precoding is enabled (DFT-s-OFDM) or disabled (CP-OFDM).

Let N_{UL} be the number of antenna ports (or number of Tx RF chains associated with UL transmission) at the UE. Let N_{DL} be the number of antenna ports at the gNB (NW). Let H be the DL channel matrix of size N_{UL}=N_{DL} that can be estimated based on a DL RS (e.g. CSI-RS) measurement. When the DL and UL channels are reciprocal (e.g. TDD), then the UL channel matrix can be estimated (based on the DL RS measurement) as H* and has size N_{DL}×N_{UL}. For brevity of notation, the subband (SB) index f or subcarrier index k or polarization index p is not included as suffix or prefix on H. However, in general, H=H^{(I)}, where (I) belongs to {(f, r, p), (f, r), (f, p), (f)} to represent one of four types herein of channel notations herein. In case of SB comprising of multiple subcarriers, Hₖ^{(I)} can be used to denote the channel for subcarrier k in SB f.

Let H^{(f,r,p)} be the channel associated with the f-th SB, r-th antenna at the UE, and p-th polarization at the gNB. Note that H^{(f,r,p)} is a vector of size

$$\frac{{N}_{D L}}{2}$$

when p∈{0,1} (i.e. dual-polarized antenna ports at the gNB).

Let H^{(f,r)} be the channel associated with the f-th SB, r-th antenna at the UE, and antenna ports at the gNB. Note that H^{(f,r)} is a vector of size N_{DL}.

Let H^{(f,p)} be the channel associated with the f-th SB, antenna ports at the UE, and p-th polarization at the gNB. Note that H^{(f,p)} is a matrix of size

$${N}_{U L} \times \frac{{N}_{D L}}{2}$$

when p∈{0,1}.

Let HM be the channel associated with the f-th SB, antenna ports at the UE, and antenna ports at the gNB.

The superscript ( )^{H} denotes conjugate transpose, and the superscript ( )^{T} denotes transpose.

For DL channel H, the following is defined:
DEF0: the DL channel is represented using singular value decomposition (SVD) as

$$H \approx {\sum }_{l = 1}^{L} {λ}_{l} {v}_{l} {u}_{l}^{H}$$

where λₗ is a singular value (a non-negative number), νₗ is a left singular vector of length N_{UL} and uₗ is a right singular vector of length N_{DL}. Note that L singular vector pairs (uₗ, νₗ) is provided.
DEF1: Left (UL) covariance matrix is represented as E_{UL}=HH^{H}. For multiple subcarriers,

$${E}_{U L} = \frac{1}{\vert f \vert} {\sum }_{k ∈ f} ( ( {H}_{k} ) {( {H}_{k} )}^{H} ) .$$

DEF2: Right (DL) covariance matrix is represented as E_{DL}=H^{H}H. For multiple subcarriers,

$${E}_{D L} = \frac{1}{\vert f \vert} {\sum }_{k ∈ f} ( {( {H}_{k} )}^{H} ( {H}_{k} ) ) .$$

DEF3: Left (UL) eigenvectors νₗ are derived using Eigen value decomposition (EVD) of the covariance matrix E_{UL} as

$${E}_{U L} = {\sum }_{l = 1}^{{L}_{U L}} {λ}_{U L , l} {v}_{l} {v}_{l}^{H} ,$$

where λ_{UL,l} is an eigenvalue (a non-negative number).
DEF4: Right (DL) eigenvectors u₁ are derived using EVD of the covariance matrix E_{DL} as

$${E}_{D L} = {\sum }_{l = 1}^{{L}_{D L}} {λ}_{D L , l} {u}_{l} {u}_{l}^{H} ,$$

where λ_{DL,l} is an eigenvalue (a non-negative number).

Note L_{UL}=L_{DL}=ν is the rank of the DL or UL covariance matrix and

$${λ}_{U L , l} = {λ}_{D L , l} = {λ}_{l}^{2}$$

is an eigenvalue or \sqrt{λ_{UL,l}}=\sqrt{λ_{DL,l}}=λₗ is a corresponding singular value.

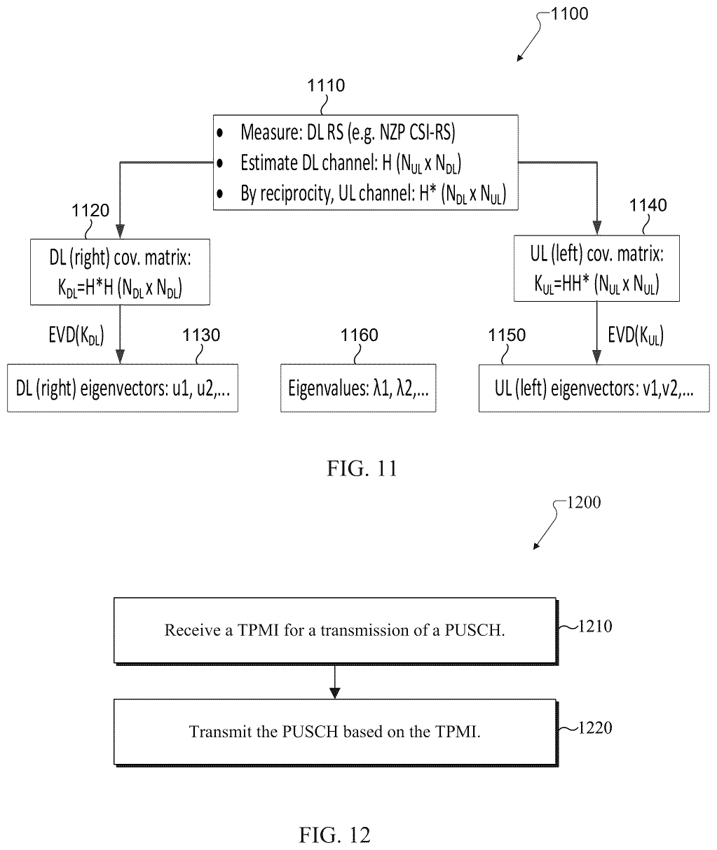

FIG. 11 illustrates a flowdiagram of an example procedure 1100 for measuring/estimating UL/DL channel(s) according to embodiments of the present disclosure. For example, procedure 1100 can be performed by any of the UEs 111-116 of FIG. 1, such as the UE 116. This example is for illustration only and other embodiments can be used without departing from the scope of the present disclosure.

The procedure begins in 1110, a UE measures the DL RS, estimates the DL channel H (N_{UL}×N_{DL}), and by reciprocity estimates the UL channel H*(N_{UL}×N_{DL}). In 1120, the UE determines DL (right) cov. Matrix: K_{DL}=H*H(N_{DL}×N_{DL}). In 1130, the UE determines DL (right) eigenvectors u₁, u₂, . . . . In 1140, the UE determines UL (left) cov. Matrix: K_{UL}=HH*(N_{UL}×N_{UL}). In 1150, the UE determines UL (left) eigenvectors ν₁, ν₂, . . . . In 1160, the UE determines Eigenvalues λ₁, Δ₂, . . . .

In one embodiment, as shown in FIG. 11, a UE is configured to receive a DL RS (e.g. NZP CSI-RS) for measurement, and in response, in, the UE measures the DL RS, estimates the DL channel H based on the measurement, and assuming DL and UL channel reciprocity estimates UL channel as H^{H} (Hermitian or conjugate transpose of matrix H). As described herein, based on the DL channel H, the UE can also determine the following:
DL (right or transmit) eigenvectors u₁, u₂, . . .
UL (left or receive) eigenvectors ν₁, ν₂, . . .
Eigenvalues λ₁, λ₂, . . .

Based on DL and UL channel reciprocity, based on the UL channel H^{H}, the UE can also determine the following:
DL (left or receive) eigenvectors u₁, u₂, . . .
UL (right or transmit) eigenvectors ν₁, ν₂, . . .
Eigenvalues λ₁, λ₂, . . .

Since right or transmit eigenvectors can be used to pre-code,
for DL precoding, eigenvectors u₁, u₂, . . . can be used, and
for UL precoding, eigenvectors ν₁, ν₂, . . . can be used.

Note that the strength or quality of a l-th DL or UL layer can be determined based on the corresponding value λₗ.

In one embodiment, the codebook for P antenna ports includes precoders or precoding matrices constructed based on a HH transform, where the HH transform is defined as

$${W}_{n} = I - 2 \frac{{u}_{n} {u}_{n}^{H}}{{u}_{n}^{H} {u}_{n}} = I - 2 \frac{{u}_{n} {u}_{n}^{H}}{{‖ {u}_{n} ‖}^{2}}$$

Where l is an n×n identity matrix and uₙ is a length n column vector, and n≤P. The size of the codebook depends on number of candidates for the vector uₙ.

In one example, the vector uₙ is a DFT vector.

In one example, uₙ is an eigenvector (or quantized eigenvector). When H is a measured channel (CSI-RS measurement for DL channel or SRS measurement for UL channel), a covariance matrix K of the channel H can be given by K=H^{H}H (expecting single measurement), or

$${\sum }_{s = 1}^{S} {H}_{s}^{H} {H}_{s}$$

(expecting S measurements and Hₛ is the measured channel at s-th subcarrier). The eigenvalue decomposition (EVD) of K=UκU^{H} when UU^{H}=U^{H}U=l and U comprises column vectors z₁, . . . z_{P}. When Γ=diag(−1,1, . . . ,1),

$$U Γ {U}^{H} = ( {\sum }_{i = 2}^{P} {z}_{i} {z}_{i}^{H} ) - {z}_{1} {z}_{1}^{H} = U {U}^{H} - 2 {z}_{1} {z}_{1}^{H} = I - 2 {z}_{1} {z}_{1}^{H} .$$

When uₙ=z₁ (first eigenvector),

$$U Γ {U}^{H} = I - 2 {z}_{1} {z}_{1}^{H} = {W}_{n} .$$

The columns of Wₙ are orthogonal and can be used to construct the codebook for P antenna ports. The matrix Wₙ is a reflection matrix, i.e.,

$${W}_{n} = {W}_{n}^{- 1} = {W}_{n}^{T} .$$

In one example, when the first eigenvector z₁ is available at the device (e.g. via PMI for DL or TPMI for UL, or via higher layer RRC), the device can perform the HH transform to obtain Wₙ, and then determine the codebook based on Wₙ.

In one example, the first eigenvector z₁ is determined by the UE (e.g. based on CSI-RS measurement), and the HH transform based on zᵢ determines the codebook.
In one example, the UE reports the eigenvector z₁ (or quantized z₁) to the gNB (e.g. as part of a CSI report).
In one example, the UE reports a rank value r (e.g. RI) and the eigenvector z₁ (or quantized z₁) to the gNB (e.g. as part of a CSI report).
In one example, the rank r precoding matrix is determined based on the columns of Wₙ (determined based on z). For example, r columns of Wₙ are selected to form the precoding matrix

$${W}^{( r )} = \frac{1}{\sqrt{r P}} [ {w}^{( {i}_{1} )} , … , {w}^{( {i}_{r} )} ]$$

where i₁, . . . iᵣ with iₖ∈{1, . . . , P} are indices of column vectors comprising Wₙ.
In one example, the column indices are fixed for each rank value, e.g. iₖ=k.
In one example, the column indices are configured, e.g. via higher layer RRC or/and DCI.
In one example, the column indices are reported by the UE, e.g. as part of the CSI report.

In one example, z₁=[t₁, . . . , tₚ]^{T}, where tᵢ is i-th element of z₁, is quantized and reported according to one of the following examples.
In one example, for each i, tᵢ is quantized as p(tᵢ)q(tᵢ)=p(tᵢ)e^{jφ(t}^{ᵢ₎}, p(tᵢ) is the quantized amplitude of tᵢ, and q(tᵢ)=e^{jφ(t}^{ᵢ₎} is the quantized phase of tᵢ. The p(tᵢ) and q(tᵢ) are reported via one joint or two separate indicators (e.g. as part of PMI of TPMI).
In one example, z₁=x₁\tilde{z}₁, x₁∈{t₁, . . . , tₚ} is the strongest (max amplitude) element of z₁, and \tilde{z}₁ is a vector after normalization (division) of z₁ by x₁, and therefore has 1 as the strongest (max amplitude) element. The index of the strongest (max amplitude) element, denoted as α₁, can be fixed (e.g. 1), configured (e.g. via RRC), or reported by the UE (e.g. as part of PMI of TPMI). Here α₁∈{1, . . . , P}. For each i≠α₁, the normalized element \tilde{t}ᵢ is quantized and reported as explained in previous example.
In one example, for each i, tᵢ or \tilde{t}ᵢ is quantized using a complex scalar codebook. The scalar codebook can be fixed (e.g. in specification) or configured (e.g. via RRC or broadcast message) or downloadable (e.g. a learning-based codebook).
In one example, z₁ or \tilde{z}₁ is quantized using a complex vector codebook. The vector codebook can be fixed (e.g. in specification) or configured (e.g. via RRC or broadcast message) or downloadable (e.g. a learning-based codebook).

In one example, z₁=z_{1,R}+jz_{1,l}, where z_{1,R} and z_{1,l} are real and imaginary parts of z₁, i.e., z_{1,R}=[t_{1,R}, t_{P,R}]^{T} and z_{1,l}=[t_{1,l}, . . . , t_{p,l}]. z₁ is quantized and reported according to one of the following examples.
In one example, for each i, t_{i,R} and t_{i,l} are quantized as p_{R}(t_{i,R}) and pₗ(t_{i,l}). The p_{R}(t_{i,R}) and pₗ(t_{i,l}) are reported via one joint or two separate indicators (e.g. as part of PMI of TPMI). In one example, the codebook to quantize t_{i,R} and t_{i,l} are the same, i.e., p_{R} (·)=pₗ(·).
In one example, z₁=x₁\tilde{z}₁, x₁∈{t₁, . . . , tₚ} is the strongest (max amplitude) element of z₁, and \tilde{z}₁ is a vector after normalization (division) of z₁ by x₁, and therefore has 1 as the strongest (max amplitude) element. The index of the strongest (max amplitude) element, denoted as α₁, can be fixed (e.g. 1), configured (e.g. via RRC), or reported by the UE (e.g. as part of PMI of TPMI). Here α₁∈{1, . . . , P}. For each i≠α₁, the normalized element \tilde{t}ᵢ is quantized and reported as explained in previous example.
In one example, z_{1,R} or/and z_{1,l} are quantized using a common vector codebook or two respective vector codebooks. The vector codebook(s) can be fixed (e.g. in specification) or configured (e.g. via RRC or broadcast message) or downloadable (e.g. a learning-based codebook).

In one example, the first eigenvector z₁ is determined by the NW (e.g. based on SRS measurement), and the HH transform based on z₁ determines the codebook.
In one example, the UE is provided (by the NW) with the eigenvector z₁.
   In one example, the UE is configured to receive z₁ via RRC or/and MAC CE or/and DCI.
   In one example, the UE is configured to receive z₁ via RRC.
      In one example, the configuration is UE-specific, i.e., separate per UE. The configuration can be via a RRC message or IE such as a CSI report configuration, or PDSCH-Config, or PUSCH-Config, or a codebook config, or a aperiodic trigger state definition, or a transmission configuration indication (TCI) state definition.
      In one example, the configuration is UEgroup-specific, i.e., separate per UE group.
      In one example, the configuration is via a CellConfig, i.e. hence cell-specific (separate per cell) but UE-common (the same for UEs connected to the cell).
      In one example, the configuration is via a CellGroupConfig, i.e. hence cellgroup-specific (separate per cell group) but UE-common (the same for UEs connected to the cell group).
   In one example, the UE is configured to receive z₁ via a DCI. For example, a field in a DCI can be used. The field can be an existing field (e.g. CSI request field) or a new field in UL-DCI that triggers an aperiodic CSI report or aperiodic RS transmission/reception or an UL-grant. Or, the field can be an existing field (e.g. TCI state indication) or a new field in DL-DCI (that schedules an DL transmission). In one example, the DCI can be UE-specific (per UE) or UEgroup-specific (specific per UE group) or UEgroup-common (common per UE group).
   In one example, the UE is configured to receive z₁ via broadcast channel. For example, it can be via SIB1.
In one example, the UE is provided (by the NW) with the eigenvector z₁ and at least one rank value r (e.g. allowed rank or RI values). The rank r precoding matrix can be determined based on the columns of Wₙ (determined based on z₁). For example, r columns of Wₙ are selected to form the precoding matrix

$${W}^{( r )} = \frac{1}{\sqrt{r P}} [ {w}^{( {i}_{1} )} , … , {w}^{( {i}_{r} )} ]$$

where i₁, . . . iᵣ with iₖ∈{1, . . . , P} are indices of column vectors comprising Wₙ.
In one example, the column indices are fixed for each rank value, e.g. iₖ=k.
In one example, the column indices are configured, e.g. via higher layer RRC or/and DCI.
In one example, the column indices are reported by the UE, e.g. as part of the CSI report.

In one example, z₁=[t₁, . . . , tₚ]^{T}, where tⱼ is i-th element of z₁, is quantized and then indicated to the UE according to one or more examples described herein.

In one example, z₁=z_{1,R}+jz_{1,l} where z_{1,R} and z_{1,i} are real and imaginary parts of z₁, i.e., z_{1,R}=[t_{1,R}, t_{p,R}] and z_{1,i}=[t_{1,l}, . . . , t_{P,l}]^{T}. z₁ is quantized and reported according to one or more examples described herein.

In one example, uₙ is based on an eigenvector (or quantized eigenvector), e.g. z₁ from one or more examples described herein, such that the eigenvector is a column of Wₙ. For example, when

$${u}_{n} = \frac{{z}_{1} - {e}_{1}}{‖ {z}_{1} - {e}_{1} ‖}$$

and e₁=[1,0, . . . ,0]^{T},

$$I - 2 {u}_{n} {u}_{n}^{H} = {W}_{n}$$

such that the first column of Wₙ is z₁. The rest of the columns of Wₙ comprise a basis or subspace spanned by z₂, . . . , z_{P}, hence is orthogonal to z₁. When ∥z₁∥≠1, then

$${u}_{n} = \frac{{z}_{1} - ‖ {z}_{1} ‖ {e}_{1}}{‖ {z}_{1} - ‖ {z}_{1} ‖ {e}_{1} ‖} = \frac{\frac{{z}_{1}}{‖ {z}_{1} ‖} - {e}_{1}}{‖ \frac{{z}_{1}}{‖ {z}_{1} ‖} - {e}_{1} ‖} .$$

The columns of Wₙ are orthogonal and can be used to construct the codebook for P antenna ports. The matrix Wₙ is a reflection matrix, i.e., Wₙ=Wₙ⁻¹=Wₙ^{T}.

In one example, when the first eigenvector z₁ is available at the device (e.g. via PMI for DL or TPMI for UL, or via higher layer RRC), the device can perform the HH transform to obtain

$${W}_{n} = I - 2 {u}_{n} {u}_{n}^{H} with {u}_{n} = \frac{{z}_{1} - {e}_{1}}{‖ {z}_{1} - {e}_{1} ‖}$$

as explained herein, and then determine the codebook based on Wₙ.

In one example, the first eigenvector z₁ is determined by the UE (e.g. based on CSI-RS measurement), and reported according to one or more examples described herein.

In one example, the first eigenvector z₁ is determined by the NW (e.g. based on SRS measurement), and provided to the UE according to one or more examples described herein.

In one example, uₙ is based on a vector y such that the vector y is a column of

$${W}_{n} = I - 2 {u}_{n} {u}_{n}^{H} .$$

Note that one or more examples described herein corresponds to y=z₁.

In one example, when y is available at the device (e.g. via PMI for DL or TPMI for UL, or via higher layer RRC), the device can perform the HH transform to obtain

$${W}_{n} = I - 2 {u}_{n} {u}_{n}^{H} with {u}_{n} = y$$

as explained herein, and then determine the codebook based on Wₙ.

In one example, y is determined by the UE (e.g. based on CSI-RS measurement), and reported according to one or more examples described herein (by replacing z₁ with y).

In one example, y is determined by the NW (e.g. based on SRS measurement), and provided to the UE (e.g., the UE 116) according to one or more examples described herein (by replacing z₁ with y).

In one example, uₙ is based on a vector

$$p = \frac{A y + b}{‖ Ay + b ‖} or \frac{f ( y )}{‖ f ( y ) ‖}$$

such that y is a column of

$${W}_{n} = I - 2 {u}_{n} {u}_{n}^{H} ,$$

where A is a matrix or a scalar value, b is a vector, and f(·) is a function of y.

In one example, when y is available at the device (e.g. via PMI for DL or TPMI for UL, or via higher layer RRC), the device can perform the HH transform to obtain

$${W}_{n} = I - 2 {u}_{n} {u}_{n}^{H} with {u}_{n} = y$$

as explained herein, and then determine the codebook based on Wₙ.

In one example, y is determined by the UE (e.g. based on CSI-RS measurement), and reported according to one or more examples described herein (by replacing z₁ with y).

In one example, y is determined by the NW (e.g. based on SRS measurement), and provided to the UE according to one or more examples described herein (by replacing z₁ with y).

In one example, Wₙ in one or more examples described herein serves as a basis (or a set of vectors) and a precoder for a layer is based on selection of a vector from this basis.

In one example, when P antenna ports form one port group (PG) for CSI purpose, the rank r precoding matrix is determined based on the columns of Wₙ (determined based on z₁). For example, r columns of Wₙ are selected to form the precoding matrix

$${W}^{( r )} = \frac{1}{\sqrt{rP}} [ {w}^{( {i}_{1} )} , ... , {w}^{( {i}_{r} )} ]$$

where i₁, . . . iᵣ with iₖ∈{1, . . . , P} are indices of column vectors comprising Wₙ.
In one example, the column indices are fixed for each rank value, e.g. iₖ=k.
In one example, the column indices are configured, e.g. via higher layer RRC or/and DCI.
In one example, the column indices are reported by the UE, e.g. as part of the CSI report.

In one example, P antenna ports form N_{g}>1 PGs for CSI purpose, i.e. P=P₁+ . . . +P_{N}_{_{g}}. In one example, N_{g}=2 and two PGs correspond to two antenna polarizations in case of a dual-polarized antenna port layout. In one example,

$${P}_{k} = \frac{P}{{N}_{g}}$$

for PGs k=1, . . . , N_{g}. In one example, Pₖ∈{1,2,3,4,6,8,12,16,24,32,48,64,96,128,256}. In one example, N_{g} is fixed (e.g. 2 or 3 or 4). In one example, N_{g} is configurable from a set of values including {2,4} or {2,4,8}, {2,3,4}, or {2,3,4,8}.
In one example, the precoding matrix corresponds to a non-coherent joint transmission (NCJT) hypothesis across PGs, i.e., a layer can be transmitted from one PG only. A PG can transmit one or more layers, but two PGs can't be combined coherently to transmitted one layer.
   In one example, Wₙ is common (the same) for PGs.
   In one example, Wₙ is common (the same) for PGs with the same value of Pₖ.
   In one example, regardless of the value of Pₖ, Wₙ, is separate (independent) for each PGs.
In one example, the precoding matrix corresponds to a coherent JT (CJT) hypothesis across PGs, i.e., a layer can be transmitted by coherent combination of multiple PGs.
   In one example, Wₙ is common (the same) for CJT hypotheses across PGs.
   In one example, Wₙ is common (the same) for PGs (in a CJT set) with the same CJT hypothesis or/and total number of antenna ports in the CJT set.
   In one example, regardless of the CJT set or hypothesis, W is separate (independent) for each CJT set or hypothesis or/and total number of antenna ports in the CJT set.

Let a rank r precoding matrix

$${W}^{( r )} = \frac{1}{\sqrt{r}} [ {w}^{( {i}_{1} )} , ... , {w}^{( {i}_{r} )} ] .$$

For a CJT set with L>1 PGs with indices k₁ . . . k_{L}∈{1, . . . , N_{g}}, a precoder wⁱ^{ᵣ}) for layer iᵣ with

$${P}_{CJT} = {\sum }_{j = 1}^{L} {p}_{{k}_{j}}$$

non-zero ports is given by
In one example,

$${w}^{( {i}_{r} )} = {\frac{1}{\sqrt{{P}_{CJT}}} [ \begin{matrix}{w}^{( {i}_{r} , {k}_{1} )} & ... & {w}^{( {i}_{r} , {k}_{L} )}\end{matrix} ]}^{T}$$

where w⁽ⁱ^{ᵣ}^{,k}^{ⱼ₎} is a part of the precoder associated with a PG with index kⱼ.
In one example,

$${w}^{( {i}_{r} )} = {\frac{1}{\sqrt{{P}_{CJT}}} [ \begin{matrix}{c}_{{k}_{1}} {w}^{( {i}_{r} , {k}_{1} )} & ... & {c}_{{k}_{L}} {w}^{( {i}_{r} , {k}_{L} )}\end{matrix} ]}^{T}$$

where w⁽ⁱ^{ᵣ}^{,k}^{ⱼ₎} is a part of the precoder associated with a PG with index kⱼ and cₖ_{ⱼ} is a corresponding coefficient.
In one example, cₖ_{_{j*}} is fixed (e.g. to 1) for a reference PG with index k_{j*}.
In one example, cₖ_{ⱼ} is a phase value.
In one example, cₖ_{ⱼ} is an amplitude scaling.
In one example, cₖ_{ⱼ} is a complex number with an amplitude and a phase value.

In one example, Wₙ in one or more examples described herein serves as a basis (or a set of vectors) and a precoder for a layer is based on a weighted combination/sum of L>1 vectors from this basis.

In one example, when P antenna ports form one port group (PG) for CSI purpose, the rank r precoding matrix is determined based on the columns of Wₙ (determined based on z₁). For example, columns of Wₙ are combined to form the precoding matrix

$${W}^{( r )} = \frac{1}{\sqrt{r}} [ {v}^{( {i}_{1} )} , ... , {v}^{( {i}_{r} )} ] where {v}^{( {i}_{k} )} = \frac{1}{η} {\sum }_{p = 1}^{L} {α}_{p} {w}^{( {t}_{p} )} ,$$

αₚ is a combining coefficient, and with tₚ∈{1, . . . , P} are L indices of column vectors w^{(t}^{ₚ₎} comprising Wₙ, and

$$η = \sqrt{{\sum }_{p = 1}^{L} {p ( {α}_{p} )}^{2}}$$

with p(αₚ) is an amplitude of αₚ.
In one example, the value L or/and column indices tₚ are fixed for each rank value, e.g. L=2.
In one example, the value L or/and column indices tₚ are configured, e.g. via higher layer RRC or/and DCI.
In one example, the value L or/and column indices tₚ are reported by the UE, e.g. as part of the CSI report.

In one example, P antenna ports form N_{g}>1 PGs for CSI purpose, i.e. P=P₁+ . . . +P_{N}_{_{g}}. In one example, N_{g}=2 and two PGs correspond to two antenna polarizations in case of a dual-polarized antenna port layout. In one example,

$${P}_{k} = \frac{P}{{N}_{g}}$$

for PGs k=1, . . . , N_{y}. In one example, Pₖ∈{1,2,3,4,6,8,12,16,24,32,48,64,96,128,256}. In one example, N_{g} is fixed (e.g. 2 or 3 or 4). In one example, N_{g} is configurable from a set of values including {2,4} or {2,4,8}, {2,3,4}, or {2,3,4,8}.
In one example, the precoding matrix corresponds to a non-coherent joint transmission (NCJT) hypothesis across PGs, i.e., a layer can be transmitted from one PG only by linearly combining columns of Wₙ associated with the one PG, as described in one or more examples herein. The rest of details are the same as (or a straightforward extension of) one or more examples described herein.
In one example, the precoding matrix corresponds to a coherent JT (CJT) hypothesis across PGs, i.e., a layer can be transmitted by coherent combination of multiple PGs and by linearly combining columns of Wₙ (as described in one or more examples herein) associated with multiple PGs. The rest of details are the same as (or a straightforward extension of) one or more examples described herein.

In one example, a set Γ comprising K vectors as candidates for uₙ is used to construct Wₙ according to one or more examples described herein where K≥1.

In one example, for each site or cell, there is one set Γ. This set can be common (one set) across multiple sites/cells or a group of cells/sites or PGs. Or, this set can be specific (independent) for each site or cell. Also, the set can be for DL only or UL only for both DL and UL. Likewise, the set can be the same across multiple CCs (in a CA scenario), or specific (independent) per CC.

In one example, the set Γ can be UE-common (the same for UEs) in a cell. In one example, the set Γ can be indicated to a UE via a UE-group-common configuration or indication or via a broadcast message.

In one example, the set Γ can be UE-specific (independent per UE) in a cell. In one example, the set Γ can be indicated to a UE via a UE-specific configuration or indication.

In one example, when the codebook is for UL transmission, the TPMI/TRI indication to a UE can be according to one of the following examples.
In one example, when K=1, there is no need for precoder (TPMI) indication, only TRI indication suffices.
In one example, when K=1, there is a precoder (TPMI) indication, in addition to the TRI.
In one example, when K>1, there is a TPMI/TRI indication.

In one example, the set Γ is downloadable from entity A to entity B.
In one example, the download is via DL channel (e.g. from NW to UE).
In one example, the download is via UL channel (e.g. from UE to NW).
In one example, the download is via a sidelink channel (e.g. from device A to device B).
In one example, the download is via a fronthaul interface (e.g. common public radio interface (CPRI) or enhanced CPRI (eCPRI)), from O-RU to O-DU or vice versa, or from O-CU to O-CU or vice versa.

In one example, the set Γ is learning-based, e.g. based on an AI/ML algorithm. This set can be trained/learnt at an entity/location (e.g. UE or NW or an OTT server) based on a dataset provided to the location from UE or/and NW or/and other entity. The training can be an offline training performed once at the entity. There may be an update of the set, but the update need not be too frequent or dynamic (e.g. can be semi-static or slower than semi-static). Or, the training/update can be performed online via L1/L2/L3 signaling between NW and UE, e.g. via measurement and reporting/indication using DCI/UCI or/and UL/DL MACE CE or/and RRC.
In one example, the set Γ determines a one-sided model, either UE-side or NW side, e.g. an auto-encoder. The auto-decoder at the other end/side can perform an inverse operation (or transform) based on the same set Γ to reconstruct/retrieve the CSI.
In one example, the set Γ determines one-side of a two-sided model with a UE-side and a NW side.
In one example, the set Γ determines both sides of a two-sided model with a UE-side and a NW side.

In one example, the set Γ has at least one of the following restrictions/constraints.
In one example, the set comprises vectors with constant-modulus (CM) entries. For example, the amplitude of each entry of vectors is the same

$$( e . g . 1 or \frac{1}{\sqrt{P}} ) .$$

In this case, the vectors essentially comprise phase values.
In one example, the set includes vectors with one or more zero entries (corresponding antenna ports are turned off). The number of zero or/and non-zero entries of a vector can be fixed or configured or reported by the UE or indicated/configured to the UE.
In one example, the set includes vectors with non-zero entries or/and or both zero and non-zero entries.

In one example, in frequency domain (across PRBs in a frequency band), the set Γ has at least one of the following granularities.
In one example, the set Γ is WB, i.e., one set for the frequency band.
In one example, the set Γ is SB, i.e., one set for each SB in the frequency band.
In one example, the codebook based on the set Γ is WB, i.e., one codebook for the frequency band.
In one example, the codebook based on the set Γ is SB, i.e., one codebook for each SB in the frequency band. The codebook for a SB can be based on one common set Γ for SBs or one specific set Γ for the SB.

In one example, uₙ=[u_{n,0}, . . . , u_{n,P-1}]^{T} where u_{n,p}∈S comprising M values. A number of candidate vectors is M^{p}. In one example, there is a fixed entry, e.g. value 1, in uₙ. For instance, uₙ=[1,u_{n,1}, . . . , u_{n,P-1}]^{T}. A number of candidate vectors in this case is M^{P-1}.

In one example, S has M-PSK entries.
M=2^{m} where m=1 for BPSK, m=2 for QPSK, m=3 for 8PSK, m=4 for 16PSK, and so on.
M≠2^{m}∈{3,5,6,7, . . . }

In one example, P=2 antenna ports, uₙ=[u_{n,0}, u_{n,1}]^{T} and

$${u}_{n , i} ∈ S = \{ {e}^{j \frac{2 π k}{M}} : k = 0 , 1 , ... , M - 1 \}$$

M=2, u_{n,i}∈{1, −1}, and

$${u}_{n} = {[ {u}_{n , 0} , {u}_{n , 1} ]}^{T} ∈ \{ [ \begin{matrix}1 \\ 1\end{matrix} ] , [ \begin{matrix}1 \\ - 1\end{matrix} ] , [ \begin{matrix}- 1 \\ 1\end{matrix} ] , [ \begin{matrix}- 1 \\ - 1\end{matrix} ] \} or \{ [ \begin{matrix}1 \\ 1\end{matrix} ] , [ \begin{matrix}1 \\ - 1\end{matrix} ] \} .$$

M=4, u_{n,i}∈{1, j, −1, −j}, and uₙ=[u_{n,0}, u_{n,1}]^{T}∈S₁ or S₂.
M=3,

$${u}_{n , i} ∈ \{ 1 , {e}^{j \frac{2 π}{3}} , {e}^{j \frac{4 π}{3}} \} ,$$

and uₙ=[u_{n,0}, u_{n,1}]^{T}∈S₁ or S₂.

In one example, u=[u_{n,0}, . . . , u_{n,P-1}]^{T} and

$${u}_{n , i} ∈ S = \{ {e}^{j \frac{2 π k}{M}} : k = 0 , 1 , ... , M - 1 \} .$$

When M=2, u_{n,i}∈{1, −1}.
When M=4, u_{n,i}∈{1,j, −1, −j}.
When M=3,

$${u}_{n , i} ∈ \{ 1 , {e}^{j \frac{2 π}{3}} , {e}^{j \frac{4 π}{3}} \} .$$

When M=8,

$${u}_{n , i} ∈ \{ 1 , \frac{( 1 + j )}{\sqrt{2}} , j , \frac{( - 1 + j )}{\sqrt{2}} , - 1 \frac{- ( 1 + j )}{\sqrt{2}} , - j , \frac{( 1 - j )}{\sqrt{2}} \} .$$

In one example, S is a size M alphabet set for entries of uₙ.
In one example, the set is a union of two M₁-PSK and M₂-PSK alphabets, where M₁ and M₂ have no common factors. For example, (2,3), (3,4), (3,5), (2,5), (5,6), (3,8), (5,8), (7,8).

In one embodiment, the codebook for P antenna ports includes precoders or precoding matrices constructed based on an extension of the HH transform using two vectors (uₙ, νₙ).
In one example,

$${W}_{n} = I - 2 {u}_{1} {u}_{1}^{H} and {v}_{2} = \frac{{W}_{n} {u}_{2}}{‖ {W}_{n} {u}_{2} ‖} .$$

In one example,

$${W}_{n} = I - 2 {v}_{2} {v}_{1}^{H} .$$

In one example,

$${W}_{n} = I - k ( {v}_{1} {v}_{2}^{H} + {v}_{2} {v}_{1}^{H} )$$

where k is a constant.
In one example,

$${Z}_{n} = {I}_{n} - \frac{2 {u}_{n} {u}_{n}^{H}}{{u}_{n}^{H} {u}_{n}} - \frac{B {v}_{n} {v}_{n}^{H}}{{v}_{n}^{H} {v}_{n}} = {W}_{n} - \frac{B {v}_{n} {v}_{n}^{H}}{{v}_{n}^{H} {v}_{n}} .$$

In one embodiment, the codebook for P antenna ports includes precoders or precoding matrices constructed based on an extension of the HH transform using two vectors (uₙ, νₘ), where

$${W}_{n , m} = {I}_{n , m} - \frac{A {u}_{n} {v}_{m}^{H}}{\sqrt{( {u}_{n}^{H} {u}_{n} ) ( {v}_{m}^{H} {v}_{m} )}} .$$

In one example, n is an index in 1^{st} dimension (e.g. SD), and m is an (unun)(Mvm) index in 2^{nd} dimension (e.g. FD).

In one embodiment, the codebook for P antenna ports includes precoders or precoding matrices constructed based on an extension of the HH transform using (uₙ, νₘ), where

$${W}_{n , m} = {I}_{n , m} - \frac{A {u}_{n} {v}_{m}^{H}}{{v}_{m}^{H} {u}_{n}}$$

when uₙ and νₘ have the same length.

In one embodiment, the codebook for P antenna ports includes precoders or precoding matrices constructed based on an extension of the HH transform using an elementary matrix

$${W}_{n , m} = {I}_{n , m} - ζ {u}_{n} {v}_{m}^{H}$$

when uₙ and νₘ have the same length and (is scalar.

In one embodiment, the codebook for P antenna ports includes precoders or precoding matrices constructed based on an extension of the HH transform using Wₙ=lₙ−Vₙ where Vₙ is rank-1 matrix.

In one embodiment, the codebook for P antenna ports includes precoders or precoding matrices constructed based on an extension of the HH transform using Wₙ=lₙ−2P where P is a projector matrix.

In one embodiment, the codebook for P antenna ports includes precoders or precoding matrices constructed based on an extension of the HH transform using

$${W}_{n} = {I}_{n} - \frac{2 {V}_{n} {V}_{n}^{H}}{Tr ( {V}_{n}^{H} {V}_{n} )}$$

where Vₙ is a size n×m matrix where m>1.

In one example, the codebook for N_{g}=1 can be referred to as or configured as full-Coherent (FC). In one example, the codebook for 2≤N_{g}<P can be referred to as or configured as partial-Coherent (PC). In one example, the codebook for N_{g}=P can be referred to as or configured as non-Coherent (NC). In one example, the codebook including both N_{g}=(n₁, n₂)=(1, k), 2≤k<P precoders can be referred to as or configured as fullAndPartial-Coherent (FC-PC). In one example, the codebook including both N_{g}=(n₁, n₂)=(1, P) precoders can be referred to as or configured as fullAndNon-Coherent (FC-NC). In one example, the codebook including both N_{g}=(n₁, n₂)=(k, P), 2≤k≤P precoders can be referred to as or configured as partialAndNon-Coherent (PC-NC). In one example, the UE codebook including both N_{g}=(n₁, n₂, n₃)=(1, k, P) precoders can be referred to as or configured as fullAndPartialAndNon-Coherent (FC-PC-NC).

When configured, A or/and B can be used interchangeably, where A or/and B is according to one of the following.
N_{g}=1 or/and full-Coherent (FC)
N_{g}=k or/and partial-Coherent (PC)
N_{g}=P or/and non-Coherent (NFC)
N_{g}=(n₁, n₂)=(1, k) or/and fullAndPartial-Coherent (FC-PC)
N_{g}=(n₁, n₂)=(1, P) or/and fullAndNon-Coherent (FC-NC)
N_{g}=(n₁, n₂)=(k, P) or/and partialAndNon-Coherent (PC-NC)
N_{g}=(n₁, n₂, n₃)=(1, k, P) or/and fullAndPartialAndNon-Coherent (FC-PC-NC).

In one embodiment, a UE can be configured (e.g. via higher layer) with a codebook (e.g. UL TPMI codebook or DL PMI codebook) for P antenna ports, including all of or a subset of precoders described herein, according to at least one of the following examples.
In one example, the configured codebook for P antenna ports corresponds to only one N_{g} value.
   In one example, the one N_{g} value is fixed to N_{g}=1.
   In one example, the one N_{g} value is fixed to N_{g}=k.
   In one example, the one N_{g} value is fixed to N_{g}=P.
   In one example, the one N_{g} value is N_{g}=n, where n is configured (e.g. via higher layer). This configuration can be subject to a UE capability reporting. Hence, the configured n value belongs to a set of one or multiple values that the UE can support. The UE can be allowed to report one or more than one values of N_{g} (or n) via UE capability reporting.
In one example, the configured codebook for P antenna ports can correspond to two N_{g} values.
   In one example, the two N_{g} values are fixed to N_{g}=1, k.
   In one example, the two N_{g} values are fixed to N_{g}=1, P.
   In one example, the two N_{g} values are fixed to N_{g}=k, P.
   In one example, the two N_{g} values are (n₁, n₂), where (n₁, n₂) is configured (e.g. via higher layer). This configuration can be subject to a UE capability reporting. Hence, the configured (n₁, n₂) values belong to a set of multiple values that the UE can support. The UE can be allowed to report one or more than one values of N_{g}(or n) via UE capability reporting. The UE can report a set of values that the UE can support, and (n₁, n₂) can be any two values from the set. Or, the UE (e.g., the UE 116) can report a set of values for (n₁, n₂).
In one example, the configured codebook for P antenna ports can correspond to one or two N_{g} values.
   In one example, when the one N_{g} value, the codebook is according to one or more examples described herein.
   In one example, when the two N_{g} values, the codebook is according to one or more examples described herein.
In one example, the configured UL codebook for P antenna ports can correspond to three N_{g} values.
   In one example, the three N_{g} values are fixed to N_{g}=1, k, P.
In one example, the configured codebook for P antenna ports can correspond to one or three N_{g} values.
   In one example, when the one N_{g} value, the codebook is according to one or more examples described herein.
   In one example, when the three N_{g} values, the codebook is according to one or more examples described herein.
In one example, the configured codebook for P antenna ports can correspond to two or three N_{g} values.
   In one example, when the two N_{g} values, the codebook is according to one or more examples described herein.
   In one example, when the three N_{g} values, the codebook is according to one or more examples described herein.
In one example, the configured codebook for P antenna ports can correspond to one, two, or three N_{g} values.
   In one example, when the one N_{g} value, the codebook is according to one or more examples described herein.
   In one example, when the two N_{g} values, the codebook is according to one or more examples described herein.
   In one example, when the three N_{g} values, the codebook is according to one or more examples described herein.

In one embodiment, the codebook for P antenna ports, as described in previous embodiment (or later embodiments), can also be used/configured (to a UE) for DL (e.g. for CSI/PMI reporting based on P CSI-RS antenna ports at NW/gNB), or sidelink (SL) (e.g. for CSI/PMI reporting based on P CSI-RS antenna ports at a SL UE/device). It can also be used to configure/trigger a CSI report for network energy saving (NES) applications wherein the NW/gNB (e.g., the network 130/the BS 102) may want to trigger (e.g. dynamically via MAC CE or DCI) a sub-configuration of the CSI report in which the number of CSI-RS ports is less than that at the NW/gNB. For instance, NW/gNB may trigger a CSI report for P CSI-RS ports that are a subset of >P CSI-RS ports.

FIG. 12 illustrates an example method 1200 performed by a UE in a wireless communication system according to embodiments of the present disclosure. The method 1200 of FIG. 12 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 1200 is for illustration only and other embodiments can be used without departing from the scope of the present disclosure.

The method 1200 begins with the UE receiving a TPMI for a transmission of a PUSCH (1210). The UE then transmits the PUSCH based on the TPMI (1220). For example, in 1220, the TPMI indicates a precoding matrix from a codebook for P antenna ports. The codebook includes precoding matrices constructed based on at least one column of a matrix

$${W}_{n} = I - 2 {u}_{n} {u}_{n}^{H} ,$$

where l is an identity matrix, uₙ is a n×1 vector, n≤P, and uₙ^{H} is a Hermitian transpose of the vector uₙ.

In various embodiments, uₙ is a DFT vector. In various embodiments, uₙ is an eigenvector associated with a channel matrix. In various embodiments, uₙ is based on a vector

$$\frac{A y + b}{‖ Ay + b ‖}$$

such that y is a column of the matrix Wₙ, where A is a matrix or a scalar value, and b is a vector. In some examples,

$$A = \frac{1}{‖ {z}_{1} ‖}$$

b=−e₁, implying

$${u}_{n} = \frac{\frac{{z}_{1}}{‖ {z}_{1} ‖} - {e}_{1}}{‖ \frac{{z}_{1}}{‖ {z}_{1} ‖} - {e}_{1} ‖}$$

such that a first column of Wₙ is

$$\frac{{z}_{1}}{‖ {z}_{1} ‖} .$$

In various embodiments, when the precoding matrix indicated by the TPMI has a rank=,r, the at least one column of the matrix Wₙ corresponds to r columns and the precoding matrix is determined based on selecting r columns of the matrix Wₙ and is expressed as

$${W}^{( r )} = \frac{1}{\sqrt{r P}} [ {w}^{( {i}_{1} )} , … , {w}^{( {i}_{r} )} ] ,$$

where, for k=1, . . . , r, iₖ∈{1, . . . , P} is an index of a k-th column vector w⁽ⁱ^{ₖ₎} of the selected r columns comprising the matrix Wₙ.

In various embodiments, the at least one column of the matrix Wₙ corresponds to L columns, where L>1, and each column of the precoding matrix indicated by the TPMI is based on a weighted sum of the L columns of the matrix Wₙ. The precoding matrix is expressed as

$${W}^{( r )} = \frac{1}{\sqrt{r}} [ {v}^{( {i}_{1} )} , … , {v}^{( {i}_{r} )} ] where {v}^{( {i}_{k} )} = \frac{1}{η} {\sum }_{p = 1}^{L} {α}_{p} {w}^{( {t}_{p} )} ,$$

αₚ is a combining coefficient, tₚ∈{1, . . . , P} are L indices of column vectors w^{(t}^{ₚ₎} comprising Wₙ and

$$η = \sqrt{{\sum }_{p = 1}^{L} {p ( {α}_{p} )}^{2}}$$

with p(αₚ) is an amplitude of αₚ.

In various embodiments, a set Γ comprising K vectors as candidates for uₙ is used to construct Wₙ, where the set Γ is downloadable or learnt via an AI/ML technique.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE), the UE comprising:
a processor; and
a transceiver operably connected to the processor, the transceiver configured to:
receive a transmit precoding matrix indicator (TPMI) for a transmission of a physical uplink shared channel (PUSCH); and
transmit the PUSCH based on the TPMI,
wherein the TPMI indicates a precoding matrix from a codebook for P antenna ports, and
wherein the codebook includes precoding matrices constructed based on at least one column of a matrix
$${W}_{n} = I - 2 {u}_{n} {u}_{n}^{H} ,$$
where l is an identity matrix, uₙ is a n×1 vector, n≤P, and
$${u}_{n}^{H}$$
is a Hermitian transpose of the vector uₙ.

2. The UE of claim 1, wherein uₙ is a discrete Fourier transform (DFT) vector.

3. The UE of claim 1, wherein uₙ is an eigenvector associated with a channel matrix.

4. The UE of claim 1, wherein uₙ is based on a vector
$$\frac{Ay + b}{‖ Ay + b ‖}$$
such that y is a column of the matrix Wₙ, where A is a matrix or a scalar value, and b is a vector.

5. The UE of claim 4, wherein
$$A = \frac{1}{‖ {z}_{1} ‖}$$
and b=−e₁, implying
$${u}_{n} = \frac{\frac{{z}_{1}}{‖ {z}_{1} ‖} - {e}_{1}}{‖ \frac{{z}_{1}}{‖ {z}_{1} ‖} - {e}_{1} ‖}$$
such that a first column of Wₙ is
$$\frac{{z}_{1}}{‖ {z}_{1} ‖} .$$

6. The UE of claim 1, wherein:
when the precoding matrix indicated by the TPMI has a rank=r, the at least one column of the matrix Wₙ corresponds to r columns, and
the precoding matrix is determined based on selecting r columns of the matrix Wₙ and is expressed as
$${W}^{( r )} = \frac{1}{\sqrt{r P}} [ {w}^{( {i}_{1} )} , … , {w}^{( {i}_{r} )} ] ,$$
where, for k=1, . . . , r, iₖ∈{1, . . . , P} is an index of a k-th column vector W⁽ⁱ^{ₖ₎} of the selected r columns comprising the matrix Wₙ.

7. The UE of claim 1, wherein:
the at least one column of the matrix Wₙ corresponds to L columns, where L>1,
each column of the precoding matrix indicated by the TPMI is based on a weighted sum of the L columns of the matrix Wₙ, and
the precoding matrix is expressed as
$${W}^{( r )} = \frac{1}{\sqrt{r}} [ {v}^{( {i}_{1} )} , … , {v}^{( {i}_{r} )} ] where {v}^{( {i}_{k} )} = \frac{1}{η} {\sum }_{p = 1}^{L} {α}_{p} {w}^{( {t}_{p} )} ,$$
αₚ is a combining coefficient, tₚ∈{1, . . . , P} are L indices of column vectors w^{(t}^{ₚ₎} comprising Wₙ, and
$$η = \sqrt{{\sum }_{p = 1}^{L} {p ( {α}_{p} )}^{2}}$$
with p(αₚ) is an amplitude of αₚ.

8. The UE of claim 1, wherein a set Γ comprising K vectors as candidates for uₙ is used to construct Wₙ, where the set Γ is downloadable or learnt via an artificial intelligence/machine learning (AI/ML) technique.

9. A base station (BS), the BS comprising:
a processor; and
a transceiver operably connected to the processor, the transceiver configured to:
transmit a transmit precoding matrix indicator (TPMI) for a physical uplink shared channel (PUSCH); and
receive the PUSCH based on the TPMI,
wherein the TPMI indicates a precoding matrix from a codebook for P antenna ports, and
wherein the codebook includes precoding matrices constructed based on at least one column of a matrix
$${W}_{n} = I - 2 {u}_{n} {u}_{n}^{H} ,$$
where l is an identity matrix, uₙ is a n×1 vector, n≤P, and
$${u}_{n}^{H}$$
is a Hermitian transpose of the vector uₙ.

10. The BS of claim 9, wherein uₙ is a discrete Fourier transform (DFT) vector.

11. The BS of claim 9, wherein uₙ is an eigenvector associated with a channel matrix.

12. The BS of claim 9, wherein uₙ is based on a vector
$$\frac{Ay + b}{‖ Ay + b ‖}$$
such that y is a column of the matrix Wₙ, where A is a matrix or a scalar value, and b is a vector.

13. The BS of claim 12, wherein
$$A = \frac{1}{‖ {z}_{1} ‖}$$
and b=−e₁, implying
$${u}_{n} = \frac{\frac{{z}_{1}}{‖ {z}_{1} ‖} - {e}_{1}}{‖ \frac{{z}_{1}}{‖ {z}_{1} ‖} - {e}_{1} ‖}$$
such that a first column of Wₙ is
$$\frac{{z}_{1}}{‖ {z}_{1} ‖} .$$

14. The BS of claim 9, wherein:
when the precoding matrix indicated by the TPMI has a rank=r, the at least one column of the matrix Wₙ, corresponds to r columns, and
the precoding matrix is determined based on selecting r columns of the matrix Wₙ, and is expressed as
$${W}^{( r )} = \frac{1}{\sqrt{rP}} [ {w}^{( {i}_{1} )} , ... , {w}^{( {i}_{r} )} ] ,$$
where, for k=1, . . . , r, iₖ∈{1, . . . , P} is an index of a k-th column vector w⁽ⁱ^{ₖ₎} of the selected r columns comprising the matrix Wₙ.

15. The BS of claim 9, wherein:
the at least one column of the matrix Wₙ corresponds to L columns, where L>1,
each column of the precoding matrix indicated by the TPMI is based on a weighted sum of the L columns of the matrix Wₙ, and
the precoding matrix is expressed as
$${W}^{( r )} = \frac{1}{\sqrt{r}} [ {v}^{( {i}_{1} )} , ... , {v}^{( {i}_{r} )} ] where {v}^{( {i}_{k} )} = \frac{1}{η} {\sum }_{p = 1}^{L} {α}_{p} {w}^{( {t}_{p} )} ,$$
αₚ is a combining coefficient, tₚ∈{1, . . . , P} are L indices of column vectors w^{(t}^{ₚ₎} comprising Wₙ, and
$$η = \sqrt{{\sum }_{p = 1}^{L} {p ( {α}_{p} )}^{2}}$$
with p(αₚ) is an amplitude of αₚ.

16. The BS of claim 9, wherein a set Γ comprising K vectors as candidates for uₙ is used to construct Wₙ, where the set Γ is downloadable or learnt via an artificial intelligence/machine learning (AI/ML) technique.

17. A method performed by a user equipment (UE), the method comprising
receiving a transmit precoding matrix indicator (TPMI) for a transmission of a physical uplink shared channel (PUSCH); and
transmitting the PUSCH based on the TPMI,
wherein the TPMI indicates a precoding matrix from a codebook for P antenna ports, and
wherein the codebook includes precoding matrices constructed based on at least one column of a matrix
$${W}_{n} = I - 2 {u}_{n} {u}_{n}^{H} ,$$
where l is an identity matrix, uₙ is a n×1 vector, n≤P, and
$${u}_{n}^{H}$$
is a Hermitian transpose of the vector uₙ.

18. The method of claim 17, wherein uₙ is based on a vector
$$\frac{Ay + b}{‖ Ay + b ‖}$$
such that y is a column of the matrix Wₙ, where A is a matrix or a scalar value, and b is a vector.

19. The method of claim 18, wherein
$$A = \frac{1}{‖ {z}_{1} ‖}$$
and b=−e₁, implying
$${u}_{n} = \frac{\frac{{z}_{1}}{‖ {z}_{1} ‖} - {e}_{1}}{‖ \frac{{z}_{1}}{‖ {z}_{1} ‖} - {e}_{1} ‖}$$
such that a first column of Wₙ is
$$\frac{{z}_{1}}{‖ {z}_{1} ‖} .$$

20. The method of claim 17, wherein:
when the precoding matrix indicated by the TPMI has a rank=r, the at least one column of the matrix Wₙ corresponds to r columns, and
the precoding matrix is determined based on selecting r columns of the matrix Wₙ and is expressed as
$${W}^{( r )} = \frac{1}{\sqrt{rP}} [ {w}^{( {i}_{1} )} , ... , {w}^{( {i}_{r} )} ] ,$$
where, for k=1, . . . , r, iₖ∈{1, . . . , P} is an index of a k-th column vector w⁽ⁱ^{ₖ₎} of the selected r columns comprising the matrix Wₙ.
